(19) United States
(12) Patent Application Publication
(10) Pub. No.: US 2025/0119281 A1
(43) Pub. Date: Apr. 10, 2025

(54) SCALABLE MULTI-PARTY NETWORKS FOR HIGH-RATE ENTANGLEMENT DISTRIBUTION AND QUANTUM COMMUNICATIONS

(71) Applicant: The Regents of the University of California, Oakland, CA (US)

(72) Inventors: Chee Wei Wong, Los Angeles, CA (US); Murat Sarihan, Los Angeles, CA (US); Xiang Cheng, Los Angeles, CA (US); Kai-Chi Chang, Los Angeles, CA (US)

(21) Appl. No.: 18/778,632

(22) Filed: Jul. 19, 2024

Related U.S. Application Data
(60) Provisional application No. 63/528,029, filed on Jul. 20, 2023.

(51) Int. Cl. H04L 9/08

(52) U.S. Cl. CPC H04L 9/0858; H04L 9/0827

(57) ABSTRACT

In some embodiments, a system for quantum key distribution, includes a plurality of n devices pairwise connected by an optical network, where n is an integer greater than or equal to 2. The optical network comprises a set of n(n−1) channels. The system employs wavelength-multiplexing, wavelength-demultiplexing, and time-multiplexing to provide a secure quantum key between two devices.

### CROSS REFERENCE TO RELATED APPLICATION

This application claims the benefit of U.S. Provisional Application, No. 63/528,029 filed Jul. 20, 2023, which is hereby incorporated by reference in its entirety.

### GOVERNMENT SUPPORT CLAUSE

This invention was made with government support under W911NF-21-2-0214 awarded by the Army Research Laboratory—Army Research Office, and 1741707, and 2137984 awarded by the National Science Foundation. The government has certain rights in the invention.

### BACKGROUND

There has been tremendous interest in building fully-secure networks. Such networks are crucial to distribute and share entanglement among multiple parties, which can be used to generate secure quantum keys, achieve quantum teleportation of information, and connect distant quantum computers to increase the computational volume with distributed quantum computing. However, most of these examples are suffering from rate limitations due to the usage of qubits carrying binary information, low source and detector efficiencies, and cost and material issues since each end-to-end link requires its own equipment. Furthermore, the lack of a true quantum repeater and fiber-link losses limits the range of quantum communications.

### BRIEF SUMMARY

In some embodiments, a system for quantum key distribution, includes a plurality of n devices pairwise connected by an optical network, where n is an integer greater than or equal to 2, The optical network comprises a set of n(n−1) channels. The system can include a photon source configured to generate a photon. The system can include a nonlinear medium configured to receive the photon upon being illuminated by the photon source and to generate an entangled photon pair comprising a signal photon and an idler photon. The system can include a demultiplexer configured to: (a) wavelength-demultiplex the signal photon into a first plurality of n(n−1)/2 signals, each signal of the first plurality having a unique wavelength band, and (b) wavelength-demultiplex the idler photon into a second plurality of n(n−1)/2 signals. Each signal of the second plurality can have a unique wavelength band. The signals of the first plurality and the signals of the second plurality can be in a one-to-one correspondence based on entanglement (“entanglement relationship”), thereby forming n(n−1)/2 pairs of corresponding signals. A plurality of n(n−1) channels can be configured to receive the first plurality of signals and the second plurality of signals, one signal per channel, A delay module can be configured to introduce a unique delay between the signals of each pair of the corresponding signals. For each of the plurality of devices, a multiplexer can be configured to receive a unique combination of (n−1) signals from the plurality of n(n−1) channels and output a wavelength-multiplexed device signal comprising (n−1) component signals. For each of the plurality of devices, a time of arrival photon detector can be configured to receive the device signal and record a time of arrival of each of the (n−1) component signals. A computing node can comprise a computer readable storage medium comprising program instructions embodied therewith. The program instructions can be executable by a processor of the computing node to cause the processor to perform a method of converting each of the times of arrival of the (n−1) component signal into a quantum key. The method can comprise for each of the plurality of the devices, recording the time of arrival of each of the (n−1) component signals, for each two devices, based on the times of arrival of each of the (n−1) component signals and the unique delay between the corresponding signals of each pair, identifying the signals of the first and the second pluralities that are in the entanglement relationship, and for each two devices, based on the times of arrival of the component signals identified as corresponding to the signals in the entanglement relationship, generating the quantum key.

In some embodiments, a method for quantum key distribution includes providing a plurality of n devices pairwise connected by an optical network, wherein n is an integer greater than or equal to 2. The optical network can comprise a set of n(n−1) channels. The method can include generating, by a photon source, a photon. The method can include receiving the photon upon being illuminated by the photon source at a nonlinear medium. The method can include generating, by the nonlinear medium, an entangled photon pair comprising a signal photon and an idler photon. The method can include wavelength-demultiplexing the signal photon into a first plurality of n(n−1)/2 signals, each signal of the first plurality having a unique wavelength band. The method can include wavelength-demultiplexing the idler photon into a second plurality of n(n−1)/2 signals, each signal of the second plurality having a unique wavelength band. The signals of the first plurality and the signals of the second plurality can be in a one-to-one correspondence based on entanglement (“entanglement relationship”), thereby forming n(n−1)/2 pairs of corresponding signals. The method can include receiving the first plurality of signals and the second plurality of signals at a plurality of n(n−1) channels, one signal per channel. The method can include introducing a unique delay between the signals of each pair of the corresponding signals. The method can include, for each of the plurality of devices, multiplexing a unique combination of (n−1) signals from the plurality of n(n−1) channels to a wavelength-multiplexed device signal comprising (n−1) component signals. The method can include, for each of the plurality of devices, receiving the device signal and recording a time of arrival of each of the (n−1) component signals. The method can include, for each of the plurality of the devices, recording the time of arrival of each of the (n−1) component signals. The method can include, for each two devices, based on the times of arrival of each of the (n−1) component signals and the unique delay between the corresponding signals of each pair, identifying the signals of the first and the second pluralities that are in the entanglement relationship. The method can include, for each two devices, based on the times of arrival of the component signals identified as corresponding to the signals in the entanglement relationship, generating the quantum key.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIGS. 1A-C are diagrams illustrating schematic views of an system implementing an optical network topology according to embodiments of the present disclosure,

FIG. 2A is a diagram of the network topology according to embodiments of the present disclosure.

FIG. 2B is a graph illustrating recorded timestamps between devices Alice and Bob according to embodiments of the present disclosure.

FIG. 3 is a graph illustrating a four-user wavelength-multiplexed network according to embodiments of the present disclosure.

FIG. 4A is a two-dimensional graph illustrating key rate and photon information efficiency (PIE) for each pair of devices according to alternative systems,

FIG. 4B is a two-dimensional graph illustrating photon information efficiency for all links with different numbers of encoded bits N from 2 to 10 bits at the source distance according to embodiments of the present disclosure.

FIG. 4C is a two-dimensional graph illustrating a secure key rate for all links with different numbers of encoded bits N from 2 to 10 bits after at the source distance according to embodiments of the present disclosure.

FIG. 4D is a two-dimensional graph illustrating a change in quantum bit error rate with different numbers of encoded bits at the source distance according to embodiments of the present disclosure.

FIG. 4E is a two-dimensional graph illustrating finite key adjusted photon information efficiency for all links, with different numbers of sample sizes for each recording, at the source distance according to embodiments of the present disclosure,

FIG. 5A is a flowchart of a high-dimensional arrival-time-bin encoding protocol according to embodiments of the present disclosure.

FIG. 5B a diagram illustrating simultaneous generation of raw keys among users according to embodiments of the present disclosure.

FIGS. 6A-B is a graph illustrating the temporal cross-correlation for each channel pair assigned to users according to embodiments of the present disclosure.

FIG. 6C is a graph illustrating the quantum symbol error rate for each user pair versus a different number of encoded bits according to embodiments of the present disclosure.

FIG. 7A-D are graphs illustrating the results of simultaneously recorded timestamps at the system according to embodiments of the present disclosure.

FIG. 8 is a diagram illustrating the QBER for each link for the optimal modulation parameters at 0 km and 21 km distances according to embodiments of the present disclosure.

FIG. 9 are graphs illustrating the second-order correlation measurements for Alice and Charlie in time-time (TT), time-frequency (TF), frequency-time (FT), and frequency-frequency (FF) bases according to embodiments of the present disclosure.

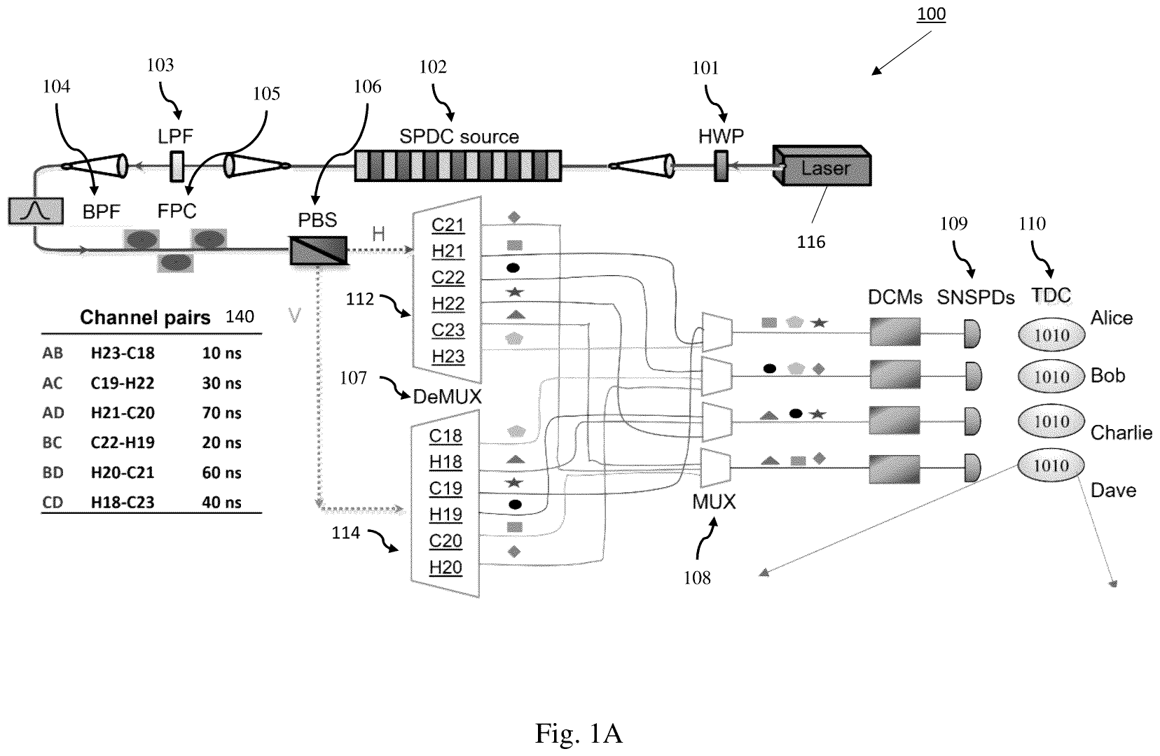

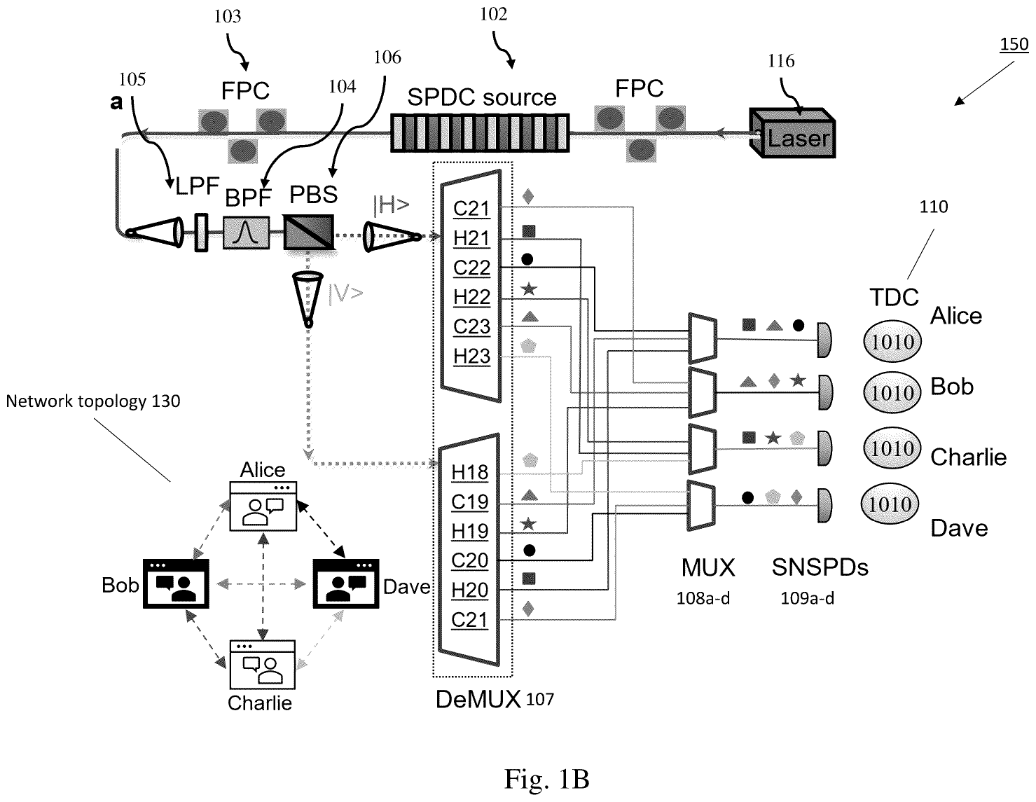

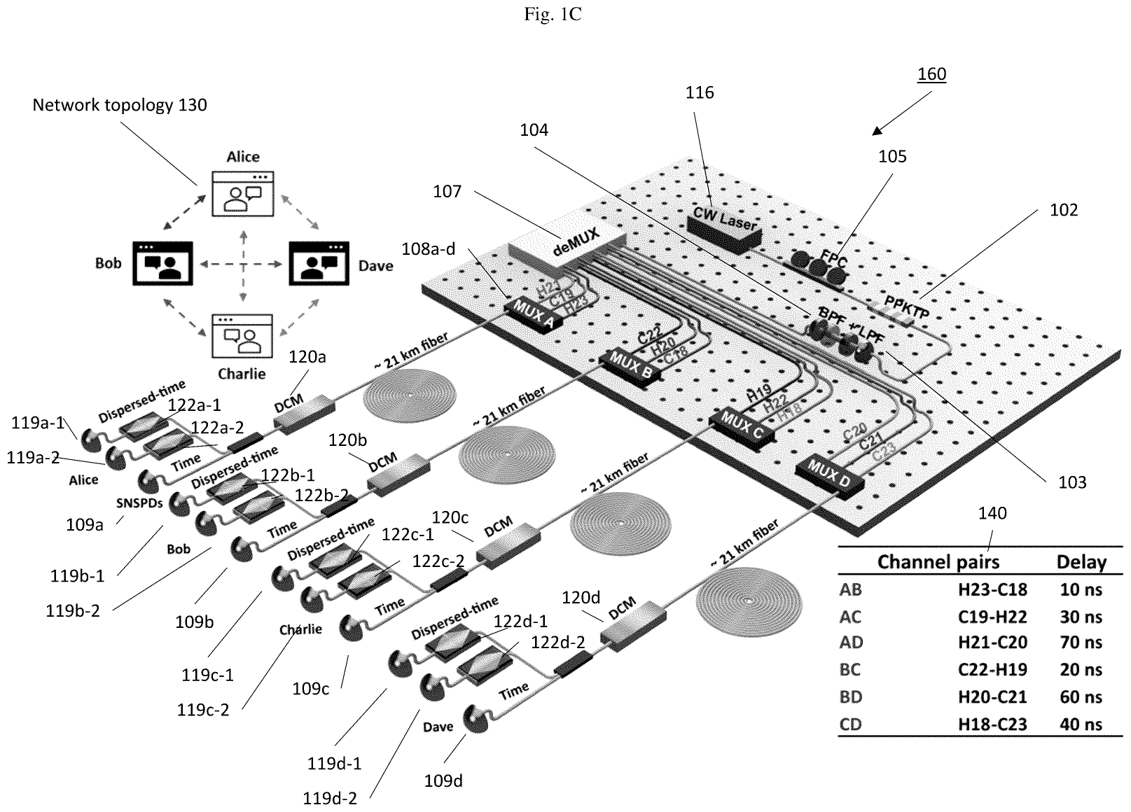

FIGS. 1A, 10B, and 11 are graphs illustrating the secure photon information efficiency by subtracting the Holevo leakage bound from the raw photon information capacity according to embodiments of the present disclosure,

FIGS. 12A-B are graphs illustrating average secure key rates that are calculated at 0 km and 21 km according to embodiments of the present disclosure.

FIG. 13A is a graph illustrating the difference distribution of the Alice and Charlie's symbols A and C, for a case with t_{bin}=100 ps and 6-bit encoding at the source distance according to embodiments of the present disclosure.

FIG. 13B is a graph illustrating the distribution of photon detection events over a fixed frame of 64 bins and t_{bin}=100 ps according to embodiments of the present disclosure.

FIGS. 14-15 are graphs illustrating the change in the ratio of global and local errors among the symbol pairs of Alice and Charlie for different t_{bin} at 6-bit encoding and for different number of encoded bits at t_{bin}=100 ps according to embodiments of the present disclosure.

FIG. 16 is a diagram illustrating an example of a Franson interferometer scheme according to embodiments of the present disclosure.

FIG. 17 is a graph illustrating an example recording coincidence counts with different optical delays between non-local interferometric paths according to embodiments of the present disclosure.

FIG. 18-19 are graphs illustrating modulation of optimization parameters and the change in raw key rates with changing bin width t_{bin} and number of encoded bits, N, for each user-user connection according to embodiments of the present disclosure,

FIG. 20-21 are graphs illustrating the corresponding quantum bit error rate (QBER) at the source distance and after 21 km for each user according to embodiments of the present disclosure.

FIG. 22-23 are graphs illustrating the change in raw key rates with changing bin width t_{bin} and number of encoded bits, N, for each user-user connection according to embodiments of the present disclosure.

FIG. 24 is a graph illustrating a change of the PIE with finite symbol block sizes due to uncertainties brought by the finite key effects according to embodiments of the present disclosure.

FIG. 25A-H are graphs illustrating optimization of the modulation parameters according to embodiments of the present disclosure,

FIG. 26 is a graph illustrates the mutual information (e.g., Shannon capacity) of each channel in terms of PIE, which is the effective number of bits obtained per photon at 0 km and 21 km distances, the key rate, and the QBER according to embodiments of the present disclosure.

FIG. 27 is a graph illustrating Quantum bit error rate for each connection at the source (blue) and after 21 km propagation (orange) according to embodiments of the present disclosure.

FIG. 28 is a graph illustrating Resultant raw key rate at the source (blue) and after 21 km propagation (orange) according to embodiments of the present disclosure.

FIG. 29 is a graph illustrating modeling of network performance and scaling according to embodiments of the present disclosure.

FIG. 30 is a graph illustrating a PIE plotted as function of the frame size and for varying bin widths according to embodiments of the present disclosure.

FIG. 31 is a graph illustrating a plot showing the PIE as a function of distance for a varied number of users according to embodiments of the present disclosure.

FIGS. 32A-B are flowcharts illustrating a method of quantum key distribution according to embodiments of the present disclosure.

FIG. 33 is a schematic of an example of a computing node according to embodiments of the present disclosure.

### DETAILED DESCRIPTION

Quantum key distribution (QKD) aims to achieve unconditionally secure communications between two parties. In alternative solutions, several network demonstrations and testbeds are developed from metropolitan-scale networks to fiber-based and satellite-relayed inter-city links. In alternative solutions, a wide range of QKD protocols are implemented over these demonstrations such as BB84, BBM92, COV, and CV-QKD, where each node is connected either by an individual channel for each connection by means of optical switching, or by the mediation of a trusted node.

However, these alternative implementations are limited in terms of scalability and distance. These limitations include network connectivity, low photon utilization, cost and equipment scaling, limitations, and inflexibility. For example, alternative implementations requiring individual channels for each connection can dramatically increase costs due to quadratic increases in the transceiver and channel needs. On the other hand, alternative trusted-node-based implementations may compromise the security of the network. A fully connected network may not be possible due to these limitations. Furthermore, the prior binary encoding protocols based on conjugate coding (e.g., BB84) have low photon utilization and have little tolerance to high quantum bit error rates (QBER), not sufficient to support high secure data rate requirements. In alternative implementations, QBER and key rates can deteriorate further at long distances due to transmission or switching losses. Therefore, a drastic improvement in key throughput and higher photon utilization rates at the physical layer is needed.

Quantum-secure communication can benefit from scalable, robust, and efficient platforms to achieve a fully connected large-scale quantum network. In alternative solutions, trusted nodes or multiple separate end-to-end quantum channels were implemented to generate quantum keys among multiple parties, with high overhead costs. Networking protocols taking advantage of wavelength-and time-multiplexing offer an effective solution where a central network provider can be used to establish a network with full connectivity. However, alternative implementations of wavelength-multiplexing have a little tolerance against bit errors, which led to low information efficiencies and low secure key rates at only ≈10-100 bits/s levels.

In some embodiments of the present disclosure, a wavelength-multiplexed quantum network is disclosed having high noise resilience, dense information efficiency, and delivering improved secure key rates at least one to two orders-of-magnitude higher than alternative solutions. In some embodiments, the wavelength-multiplexed quantum network is a four-node 1024-dimensional wavelength-multiplexed quantum network, however, other numbers of nodes and dimensions can be employed. A dense photon information efficiency of ≈2.458 per entangled photon pair can be obtained using a 6-bit encoding with sufficient resilience to tolerate a quantum-bit error rate up to 28.2%. This is because of the noise robustness of the high-dimensional entanglement and providing error correction coding (ECC) tailored for the quantum network.

In some embodiments, d-dimensional arrival-time encoding are exemplified to encode multiple bits per photon in the entangled energy-time basis with a resulting key rate of up to 26.6 kbits/s per channel at the source and 5 kbits/s after 21 km distribution, With the scalable single-detector-per-node in the network, non-local dispersion cancellation achieves a Holevo capacity bound between 0.1 and 0.35 bits/photon. Models illustrate that it is possible to achieve up to a 10-to-10 node connectivity per quantum network using a single entanglement provider per network, while still preserving a photon information efficiency>1 bit/photon at distances up to 120 km.

To overcome the limitations of alternative approaches and to achieve scalable quantum key distribution networks, some embodiments of the present disclosure provides a variety of innovations. First, some embodiments employ high-dimensional entanglement on energy-time basis to encode multiple bits of information per entangled photon pair shared between two users. High-dimensional entanglement offers higher information capacity, higher robustness against errors, and larger violation of nonlocality, which improves the protocol security further. In various embodiments, the arrival-time information detected by synchronized high-efficiency single-photon detectors is used to encode multiple bits of information. In various embodiments, the system and method of the present disclosure demonstrate key rates up to 2.7 kbits/s and information capacity per photon above 7 bits/pair. Furthermore, some embodiments of the present disclosure employ dispersion compensation modules to reduce the timing errors acquired during propagation over long distances. In some embodiments, a set of dispersion compensation modules measures a portion of incoming photons on energy basis to monitor channel security using Gaussian continuous-variable-based time-frequency covariance matrix approach to bound time and energy correlations.

To create scalable quantum networks, various embodiments use wavelength and time-multiplexing to distribute entanglement among all the users. A single broadband entanglement provider demultiplexes generated photon pairs into wavelength subspaces assigned to each user link, To reduce the number of required channels and equipment per user, the subspaces assigned to each user are given different time delays to distinguish each link at the detector, then multiplexed into a single channel. Thus, using only one channel and detector per user, keys can be created simultaneously for each link by reapplying the appropriate delay to the single photon arrival time recording.

In some embodiments, Wavelength-division multiplexing (WDM) enables the simultaneous transmission of both classical and quantum information through one channel, making it a highly efficient pathway. Moreover, WDM is compatible with existing telecommunications infrastructure and equipment, offering an effective quantum communication solution with high scalability.

WDM demultiplexes an entangled photon pair source into the N_{P}(N_{P}−1)/2 entangled frequency subspace pairs to serve N nodes via a single provider to implement the BBM92 quantum key distribution protocol, eliminating the need for trusted nodes. To reduce the equipment needs further, time-division multiplexing (TDM) can be used to deliver multiple frequency subspaces shared with other nodes over a single channel. In this way, each node requires only a single detector to generate keys simultaneously with all other nodes, ensuring full network connectivity while reducing, the costs drastically.

In alternative implementations, using encoding schemes in polarization or binary time-bin basis, these demonstrations have achieved key rates up to 300 bits/s, and a distribution distance up to 70 km. In other alternative implementations, two-layered hybrid networks are demonstrated to scale up the number of nodes in the network to up to 40 nodes (5×8). The obtained key rates and stringent QBER limits of these alternative implementations are still insufficient to support real-world applications since most of these implementations operate under photon-starved conditions. Overcoming photon-starved conditions requires improving the architecture protocol, losses, sources and photon utilization.

In some embodiments of the present disclosure, high-dimensional entanglement is used to improve the network architecture, enable dense photon utilization and, hence, the quantum communication rates. High-dimensional entanglement can be generated between photons in orbital angular momentum, path, and energy-time degree-of-freedom, and can drastically increase the mutual information capacity between the nodes. Among these degrees-of-freedom, energy-tine is rather suitable as an encoding basis to transmit quantum information over conventional long-haul fiber networks. Energy (or frequency) and time bases are mutually unbiased and inherently possess a continuous (e.g., infinite-dimensional) Hilbert space. Indeed, energy and time bases need to be discretized to encode and retrieve useful information. Such discretized energy-time entangled states can be certified by fewer measurements and also show high robustness against quantum noise by increasing the dimensionality via fine-graining in frequency-time space or including hyperentanglement (e.g., polarization) to reduce the errors. The compatibility of the energy-time basis with another degree-of-freedom for hyperentanglement, which can be inherent in a Sagnac-configured spontaneous parametric down-conversion (SPDC) source, increases the information capacity even further, or reduces the errors by using the hyperentangled basis as an ancilla.

In alternative embodiments, high-dimensional encoding on the frequency or time basis can be used QKD applications. In one alternative embodiment, an end-to-end quantum network achieved dense 7,38 bits/photon secure information capacity at 20 km by encoding symbols in the arrival-time information of photon pairs. With the aforementioned WDM techniques, some alternative demonstrations fully connect up to 8 nodes and achieved key rates up to 81 bits/s per channel at the lab scale, using a non-binary energy-time subspace mapped over a dispersive-time basis for both key rates and security. However, the high noise robustness has not yet been fully utilized in previous implementations to reach key rates that can support demanding quantum networks.

In some embodiments, a fully connected quantum network (e.g., with four nodes and using a 1024-dimensional encoding) on an arrival-time basis. The quantum network can achieve non-binary photon utilization up to 2.62 bits/photon information capacity. The quantum network is secured using nonlocal dispersion cancellation with established security proofs against Gaussian attacks, leading to a Holevo upper bound of 0.35 bits/photon. The quantum network can reach the maximum information capacity, while demonstrating resilience against quantum bit errors with tolerable QBER up to 28.2%, due to the robustness of the d-dimensional state and the embodiments of a layered low-density parity-check (LDPC) coding scheme. A reconciliation efficiency between 75% to 92% is demonstrated at 6-bit encoding. Using wavelength- and time-division multiplexing, secure key rates up to 26.6 kbits/s per connection are achieved, at least an order to two orders-of-magnitude higher than prior state-of-the-ant network demonstrations, while achieving non-binary dense photon utilization up to 2.62 (2.45 8 secured) bits/photon information capacity. The quantum network system is secured using non-local dispersion cancellation with established security proofs against Gaussian attacks, leading to a maximum Holevo upper bound of 0.35 bits/photon. Furthermore, the quantum network protocol can be theoretically modeled and analyzed to establish the bounds on the maximum information capacity and assess the scalability, Supported by noise modeling and experimental data, the quantum network has the potential for at least another order-of-magnitude improvement in the secure key rate through high-rate broadband type-0 entangled photon pair sources and available low-jitter detectors. The testbed can scale up to at least 10 nodes per network, with a single broadband source using commercial 50-GHz DWDM modules. Due to the higher information capacity, noise robustness, and inherent compatibility with existing infrastructure, the system of some embodiments of the present disclosure is a strong candidate for future practical quantum networks.

In various embodiments, a system for implementing a quantum network for quantum key distribution ensures simultaneous connection among multiple users using wavelength and time multiplexing. In some embodiments, a system and network topology illustrated in FIG. 1A-C. For this purpose, the central network provider in the high-dimensional network scheme is using a C-band non-degenerate, type-II phase-matched, periodically-poled KTiOPO4 (ppKTP) energy-time entangled biphoton source with 250 GH z linewidth. The generated signal and idler photons are centered at 1562.18 nm and 1559.34 nm with a sinc² spectral shape. The ppKTP crystal is pumped with a 780.3 nm laser with 9 mW power to generate coincident pairs with a rate of 300 kcounts/s. The non-degenerate photon pairs are demultiplexed using commercial DWDM modules with 50 GHz channel spacing. As a result, six pairs of frequency-entangled Hilbert subspaces are generated within the SPDC linewidth. The signal and idler channel pairs are named according to the ITU Dense Wavelength Division Multiplexing (DWDM) grid. For example, C21 represents the C-band Channel 21, which is 192,200 Hz ±100 Ghz. Other frequency channels can be represented in this manner. The sinc² shape of the SPDC spectrum presents itself in the difference between the peak coincidences, leading to different entanglement distribution rates per user pair. The required number of subspaces in a simultaneously connected n-user network is n*(n−1). Here, six pairs of the brightest signal channel 112 (C21-H23) and idler channel 114 (C18-H20) are selected coinciding with the spectral profile to maximize the entanglement distribution for a four-user network.

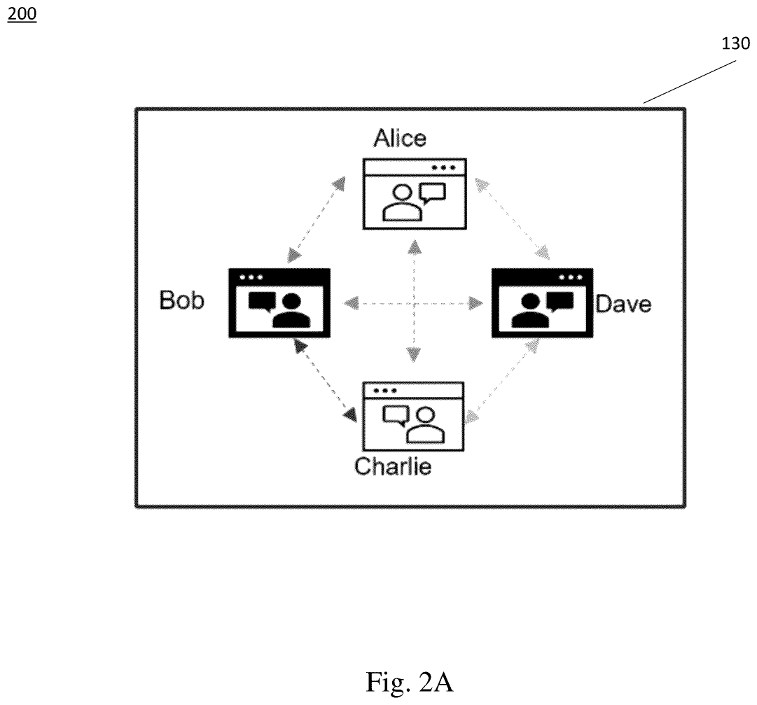

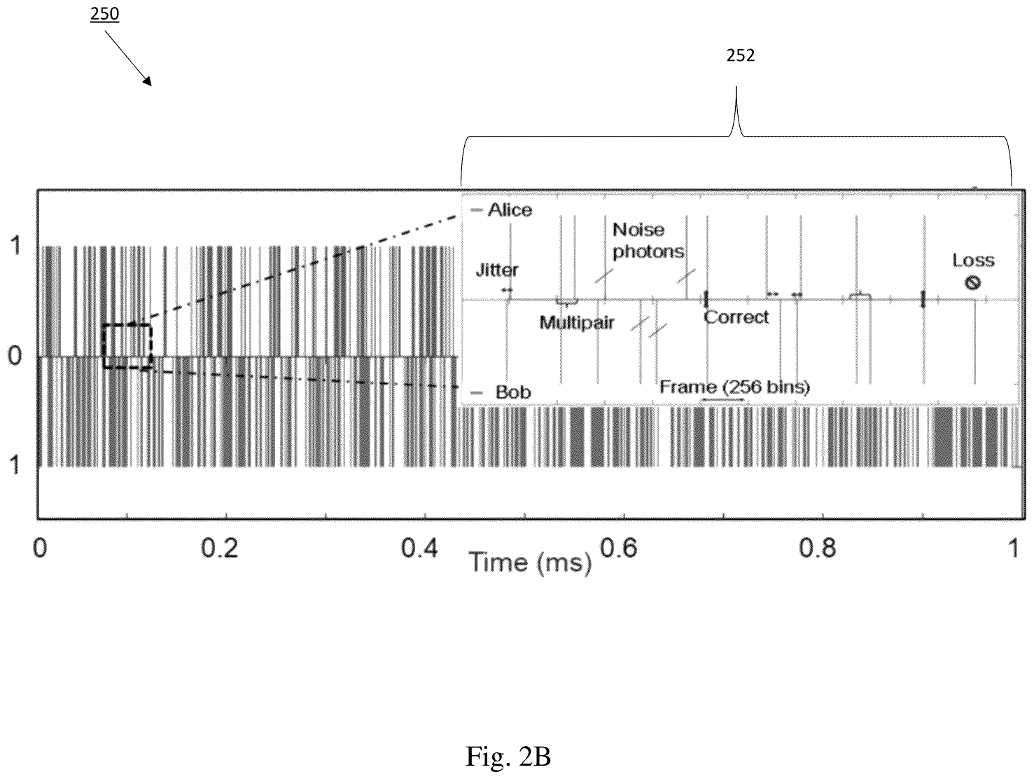

FIGS. 1A-C are diagrams 100, 150, and 160 illustrating schematic views of an system implementing an optical network topology (e.g., the optical network topology of FIG. 2) according to embodiments of the present disclosure. Referring to FIGS. 1A-C, the following abbreviations are employed: HWP 101—half-wave plate; SPDC source 102—spontaneous parametric downconversion; LPF 103—long-pass filter; BPF 104—band-pass filter: FPC 105—fiber polarization controller; PBS 106—polarizing beamsplitter; deMUX 107—demultiplexer; MUX 108—multiplexer; SNSPD 109—superconducting nanowire single photon detector; TDC 110—time-to-digital converter.

In some embodiments, a system for wavelength-multiplexed and multi-user QKD network uses high-dimensional arrival-time encoding (e.g., arrival time bin). Network topology allows bidirectional communication between all combinations of users of the network. In particular, the multi-user QKD network is shown to provide greater than 1 bit/photon efficiency.

In the example shown in FIGS. 1A-C and throughout this disclosure, a four-user network is illustrated. However, using the system and methods described herein, any n-user network can be implemented, where n is an integer greater than or equal to 2. For example, network topology 130 illustrates a four-user network with four devices respectively named Alice, Bob, Charlie, and Dave. Every device is connected by a communication channel that is illustrated by the dotted arrows. In other words, every combination of every device in the network can communicate to generate a quantum key privately. In some embodiments, there are at least n (n−1)/2 channels for the n-user network.

In some embodiments, a single photon source 116 (e.g., a laser) generates a photon. The photon is directed at a non-linear medium 102 (e.g., SPDC source, periodically-poled KTiOPO4 (ppKTP)). The non-linear medium 102 generates an entangled photon pair comprising a signal photon (IH>) and an idler photon (IV>). In some embodiments, the photon can be a polarization-entangled photon pair. In some embodiments, the photon can be an energy-time-entangled pair. A demultiplexer 107 receives the signal photon (IH>) and wavelength-demultiplexes the signal photon to a first plurality of n (n−1)/2 signals, each signal having a unique wavelength band. In some embodiments and as illustrated by FIGS. 1A-B, these signals are of the ITU bands C21, C22, C23, H21, H22, H23. The demultiplexer 107 also receives the idler photon (IV>) and wavelength-demultiplexes into a second plurality of n(n−1)/2 signals, each signal having a unique wavelength band. In some embodiments and as illustrated by FIGS. 1A-B, these signals are of the ITU bands 118, 119, H20, C18, C19, C20.

As used herein, a wavelength band can be one wavelength or a range of wavelengths having a lower and upper range. As used herein, wavelength can mean a center value of a range of wavelengths or wavelength band.

As used herein, a frequency band can be one frequency or a range of frequency having a lower and upper range. As used herein, frequency can mean a center value of a range of frequencies or frequency band.

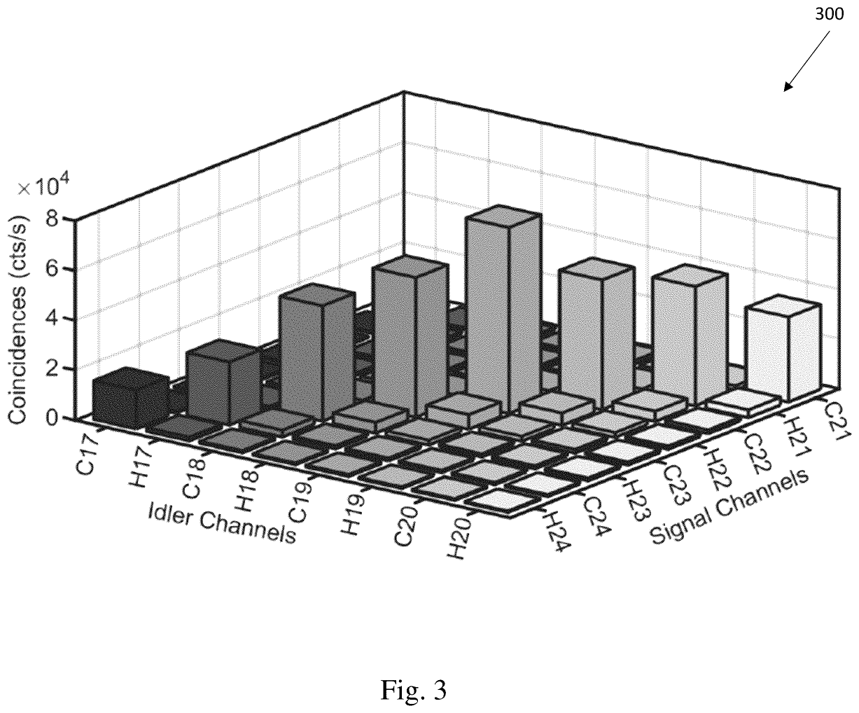

The signals of the first plurality and the signals of the second plurality are in a one-to-one correspondence based on entanglement (“entanglement relationship”), thereby forming n(n−1)/2 pairs of corresponding signals. In some embodiments, the entanglement relationships are listed by the table 140. In some embodiments, the entanglement relationships can be two entangled signals that are used to establish secure communications between two devices. In some embodiments, the two entangled signals are highly correlated signals, as shown in further detail by FIG. 3. In relation to FIGS. 1A-C, the table 140 provides pairs of devices, corresponding entangled signal pairs that are uniquely assigned to each pair of devices, and a unique delay to be introduced to that pair of signals. Each device of the pair of device is represented by a letter (e.g., A for Alice, B for Bob, C for Charlie, and D for Dave). As such, the channel pair AB represents the connection between Alice and Bob, which is provided by ITU bands H23 and C18, etc. The entangled signal pairs include one signal from the first plurality and one signal from the second plurality, thereby providing two entangled signals for each channel pair.

In some embodiments, each of the signals of the first and second plurality are received by a plurality of n (n−1) channels. Each channel can receives one of the signals. In some embodiments, each channel is a light path. In some embodiments, each channel is a fiber.

In some embodiments, a delay module (not shown) is configured to introduce the unique delay between the signals of each pair of the corresponding signals. In some embodiments, the delay module can be adding length of fiber, however, other delay modules can be employed.

In some embodiments, each device of the network topology 130 corresponds with a multiplexer 108a-d. Each multiplexer 108a-d can receive at least n−1 unique signals from the n(n−1) channels carrying the n(n−1) signals. Each multiplexer 108a-d can output a wavelength-multiplexed device signal comprising (n−1) component signals.

In some embodiments, each device of the network topology 130 corresponds with a time of arrival photon detector 109a-d. In some embodiments, the single photon detectors can be an avalanche photodiode (APD). In some embodiments, the single photon detector can be an SNSPD. Each time of arrival detector is configured to receive the device signal and record a time of arrival of each of the (n−1) component signals.

In some embodiments, a computing node performs a method of converting the times of arrival of the component signal into a quantum key. In some embodiments, the method performed by the computer includes, for each of the plurality of devices, recording the time of arrival of each of the (n−1) component signals. The method can further include, for each two devices, based on the times of arrival of each of the (n−1) component signals and the unique delay between the corresponding signals of each pair, identifying the signals of the first and the second pluralities that are in the entanglement relationship. The method can further include, for each two devices, based on the times of arrival of the component signals identified as corresponding to the signals in the entanglement relationship, generating the quantum key.

In some embodiments, the above method employs classical computing and classical networking to provide communication between the devices. In some embodiments, each two devices communicate synchronize the signals of the entanglement relationship corresponding to the pair of those two devices by sharing a less granular time of arrival. In some embodiments, a less granular time of arrival can be a less precise time of arrival. By only communicating the less granular time of arrival over a classical network, security of the quantum key generation is not compromised.

In some embodiments and as illustrated by FIG. 1C, the system further includes, for each device, a normal dispersion module 119a-1, 119b-1, 1_19e-1, and 1_19d-1, and an anomalous dispersion module 122a-2, 122b-2, 122c-2, and 122d-2. The normal dispersion module 122a-1, 122b-1, 122e-1, and 122d-1 for each device is configured to apply a first direction and first magnitude of dispersion to a portion of the device signal and output a normal dispersed signal. The anomalous dispersion module 122a-2, 122b-2, 122c-2, and 122d-2 is configured to apply a second direction and second magnitude of dispersion to the portion of the device signal. The first direction and the second direction can be opposite and the first magnitude and second magnitude can be equal. The anomalous dispersion module 122a-2, 122b-2, 122c-2, and 122d-2 can output an anomalous dispersed signal.

In some embodiments, the system further comprises a normal dispersed-time photon detector 119a-1, 119b-1, 119c-1, and 119d-1 configured to measure a normal dispersed time of arrival of each signal component of the first dispersed signal.

In some embodiments, the system further comprises an anomalous dispersed-time photon detector 119a-2, 119b-2, 119c-2, and 119d-2 configured to measure an anomalous dispersed time of arrival of each signal component of the second dispersed signal.

In some embodiments, a computing node stores the program instructions executable by the processor of the computing node further cause the processor to perform a method of detecting eavesdropping. The method can comprise for each two devices, the two devices being a first device and a second device, compare the normal dispersed time of arrival of a component signal measured by a first device to the anomalous dispersed time of arrival of a component signal measured by a second device. The component signals can correspond to the signals identified as being in the entanglement relationship. The method can further comprise calculating a measure of mutual information based the comparison. The method can further comprise providing a notification when the measure of mutual information bound is outside of a predefined range.

By way of example, to perform a security check, a device can check for a measure of mutual information (or information leakage) by using the output of that device's normal dispersed-time photon detector and the output of any other device's anomalous dispersed-time photon detector. Conversely, that same device can use the output of its anomalous dispersed-time photon detector and the output of any other device's normal dispersed-time photon detector. However, two devices cannot use output of photon detectors of the same type (e.g., normal and anomalous).

FIG. 2A is a diagram 200 of the network topology 130 according to embodiments of the present disclosure. Each user link between the devices is assigned to an entanglement relationship having the unique time delay introduced to its signals. The designated delay between its photons can make time of arrival correlations of all of the signals received at a particular sensor distinguishable.

FIG. 2B is a graph 250 illustrating recorded timestamps between devices Alice and Bob according to embodiments of the present disclosure. The arrival time information of photons can be discretized and grouped into frames according to a predetermined discretization width, and then Alice and/or Bob shifts their timestamps to eliminate the predetermined and introduced delay. Shifting the timestamps synchronizes their entangled photon pair arrivals. The inset 252 illustrates that errors can occur due to noise, loss and timing errors during post-processing.

FIG. 3 is a three-dimensional graph 300 illustrating frequency correlations of demultiplexed signals sorted by ITU bands according to embodiments of the present disclosure. As can be seen by the graph 300 the pairs of signals having an entangled relationship are those having the highest rate of coincidences. The frequency correlation matrix was measured using coincidence analysis between each ITU band. As can be seen by the graph 300 the pairs of signals having an entangled relationship are those having the highest rate of coincidences. The correlation peaks are identified, and six of the highest peaks represent the entangled relationships and are assigned to the device pairs in the network topology. The leakage of the peaks to adjacent channels is suppressed over 10 dB, The coincidence rate ranges between a minimum of 11,370 counts/s (H20-C21) at the edge of the spectrum and a maximum of 24,880 counts/s (C19-H22) at the spectral peak. Furthermore, the correlated channels are assigned for node distribution such that no node would receive adjacent channels within the ITU grid, With such an assignment, leakage is reduced further. In some embodiments, however, if two adjacent channels are well isolated from each other, those two adjacent channels can be combined. With Gaussian channels, however, there is significant crosstalk between adjacent channels,

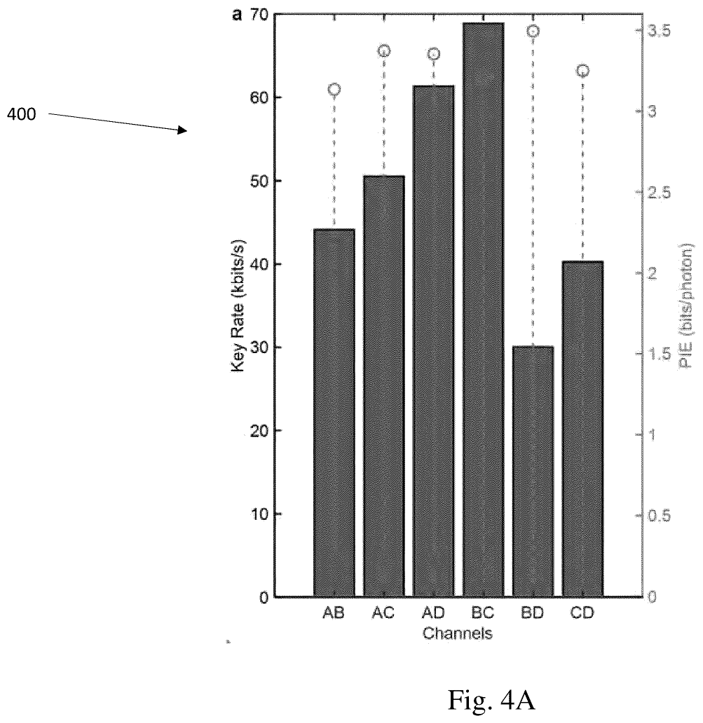

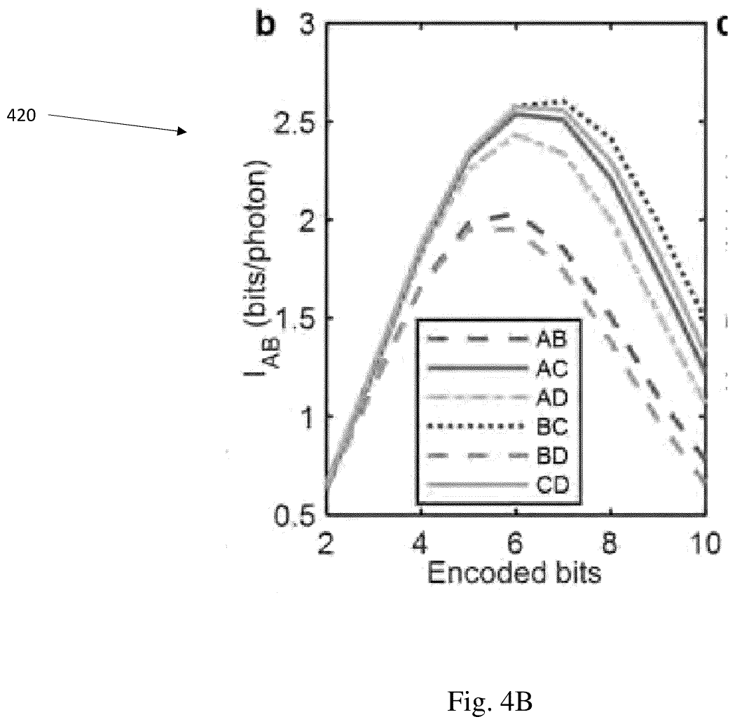

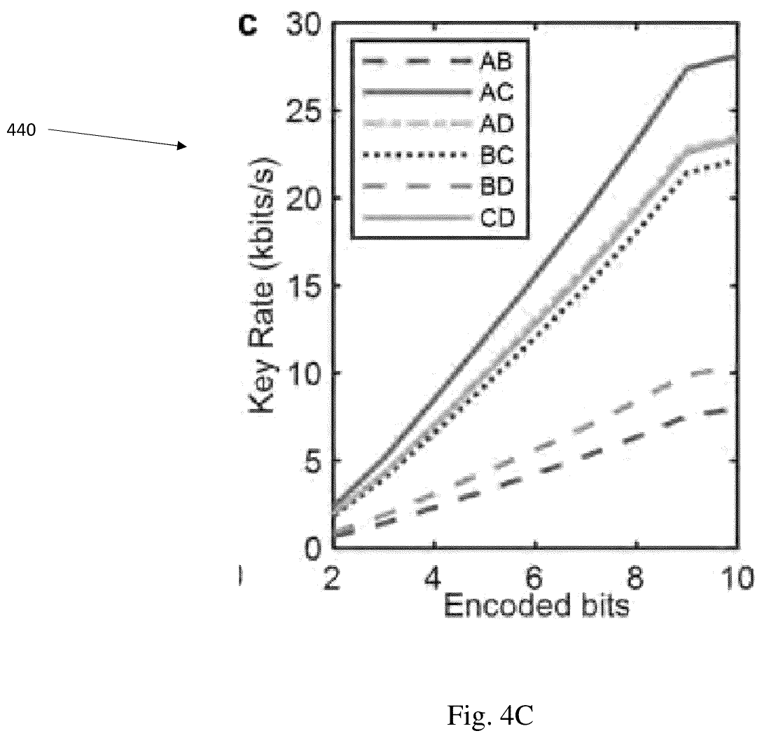

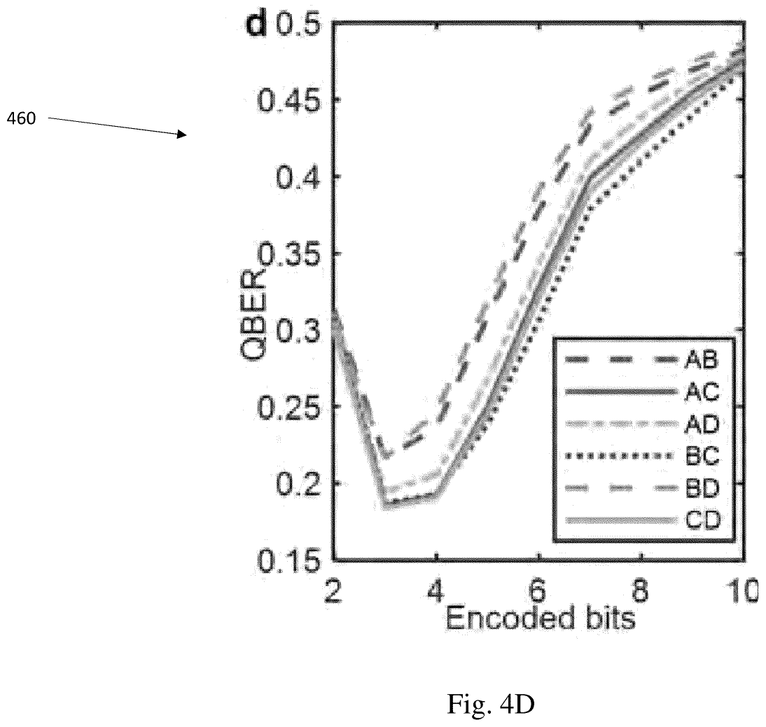

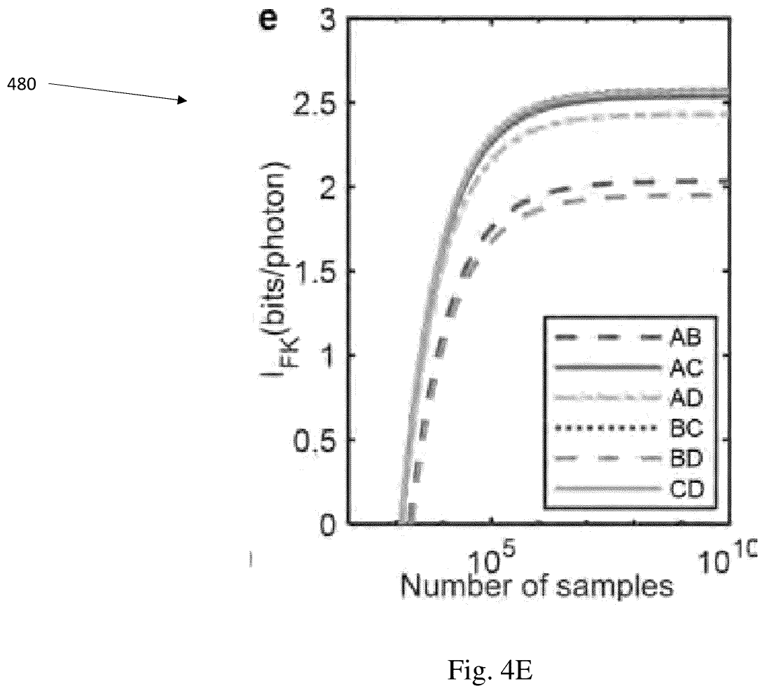

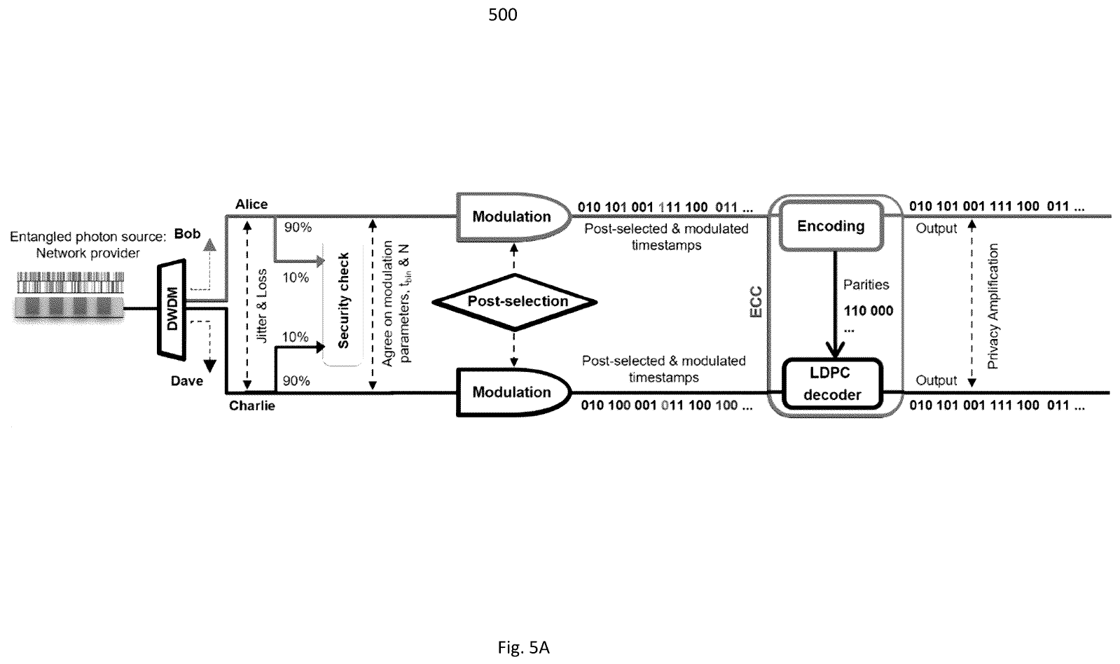

FIG. 4A is a two-dimensional graph 400 illustrating key rate and photon information efficiency (PIE) for each pair of devices according to alternative systems.

FIG. 4B is a two-dimensional graph 420 illustrating photon information efficiency for all links with different numbers of encoded bits N from 2 to 10 bits at the source distance.

FIG. 4C is a two-dimensional graph 440 illustrating a secure key rate for all links with different numbers of encoded bits N from 2 to 10 bits after at the source distance.

FIG. 4D is a two-dimensional graph 460 illustrating a change in quantum bit error rate with different numbers of encoded bits at the source distance.

FIG. 4E is a two-dimensional graph 480 illustrating finite key adjusted photon information efficiency for all links, with different numbers of sample sizes for each recording, at the source distance. For the measurements illustrated in FIGS. 4A-E, an embodiment having bin widths of 100 ps and 6-bit encoding was used.

Using wavelength multiplexing for quantum key distribution networks to serve multiple users over a single link is advantageous because it enables using a single link to communicate with multiple parties with minimum equipment. Alternative implementations employed BBM92 polarization encoding, binary time-bins, or dispersive-optics QKD protocols to connect a single user with multiple parties over a single channel. However, these alternative implementations suffered from low key rates of 5 bits to an average maximum rate of ˜100 bits under high losses of the multiplexing process.

In various embodiments of the present disclosure, using high-dimensional arrival-time encoding over energy-time entangled photons for photon-efficient, high-rate communications can overcome these limitations. High-dimensional arrival-time encoding is robust against background noise and errors and demonstrated 27 kbits/s level key rate with ˜8 bits/photon efficiency. An exemplary a four-user network that employing the high-dimensional arrival time encoding was demonstrated to exceed current implementations in performance and work under high background noise of multiplexing.

The four-user high-dimensional quantum network testbed setup is shown in FIGS. 1A-C, The type-II spontaneous parametric down-converted (SPDC) nondegenerate energy-time entangled photon pairs are generated by pumping a periodically-poled KTP waveguide (ppKTP) with a 6 mW, 780.3 nm laser. The signal and idler photons are passed through a long-pass and band-pass filter to filter out pump and background photons and split using a free-space polarizing beamsplitter. Signal and idler photons are then demultiplexed using two separate DWDM modules with 96 ITU channels, 50 GHz channel spacing, and ˜3.5 dB insertion loss. The frequency cross-correlations of demultiplexed ITU channels are measured to identify entangled channel pairs for each user and given in FIG. 3. FIG. 3 shows a correlation profile between different channels per ˜250 G1 Hz SPDC bandwidth of ppKTP waveguide with nondegenerate sinc2 profile around 1559.3 (signal) and 1561.7 nn (idler) and decreases towards the sidebands. A side peak towards the adjacent high-frequency idler channel can be observed due to adjacent channel crosstalk, which can be improved by carefully aligning the SPDC spectrum with the ITU grid. Six correlated ITU channel pairs with the highest correlation are assigned to each combination among the users Alice. Bob, Charlie, and Dave, as shown by channel pairs 140.

In alternative systems, the capacity of each channel pair if they are independently used as QKD channels without multiplexing is far less. In embodiments of the present disclosure, however, the maximum key rate per channel is 68.828 kbits/s (BC) with a photon information efficiency in encoded bits per photon of 3.2067 with 9-bit encoding. The highest photon information efficiency obtained from channel pairs is 3.4944 bits/photon with 8-bit encoding, leading to a key rate of 30 kbits/s (B)). Then, frequency channels are multiplexed using another set of 96 channel DWDM with a matching channel spacing and ˜5.6 dB insertion loss for each user to send over a single channel in a way that each user shares a correlated channel pair with the rest of the users. The multiplexed channels for each user are illustrated as color- and shape-coded and given in FIGS. 1A-C.

Before multiplexing, different lengths of fibers are added to ensure that each channel pair is distinguishable, even though a different channel clicks concurrently. Synchronizing each user according to the assigned delay makes it possible to distribute quantum keys reliably.

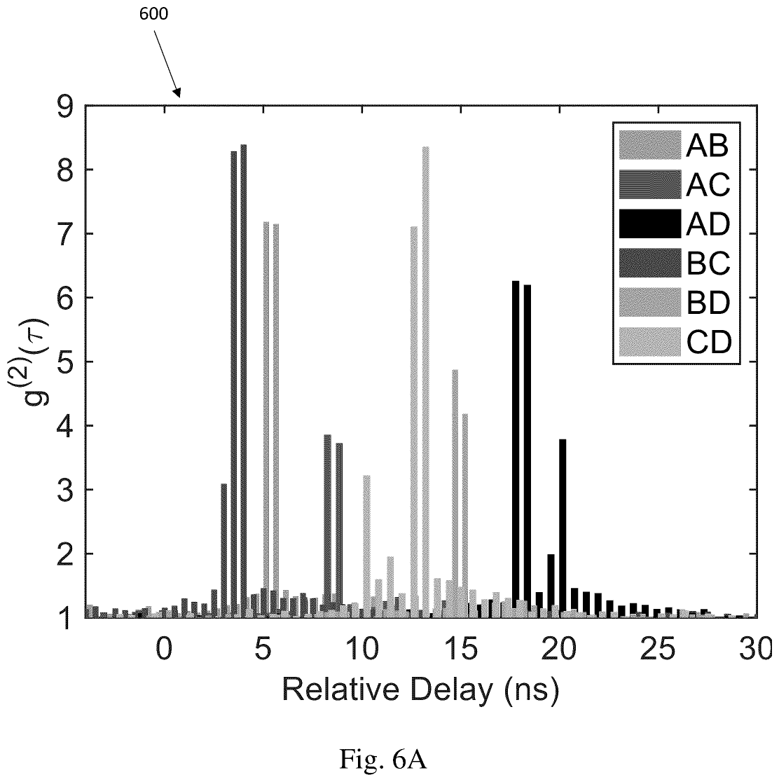

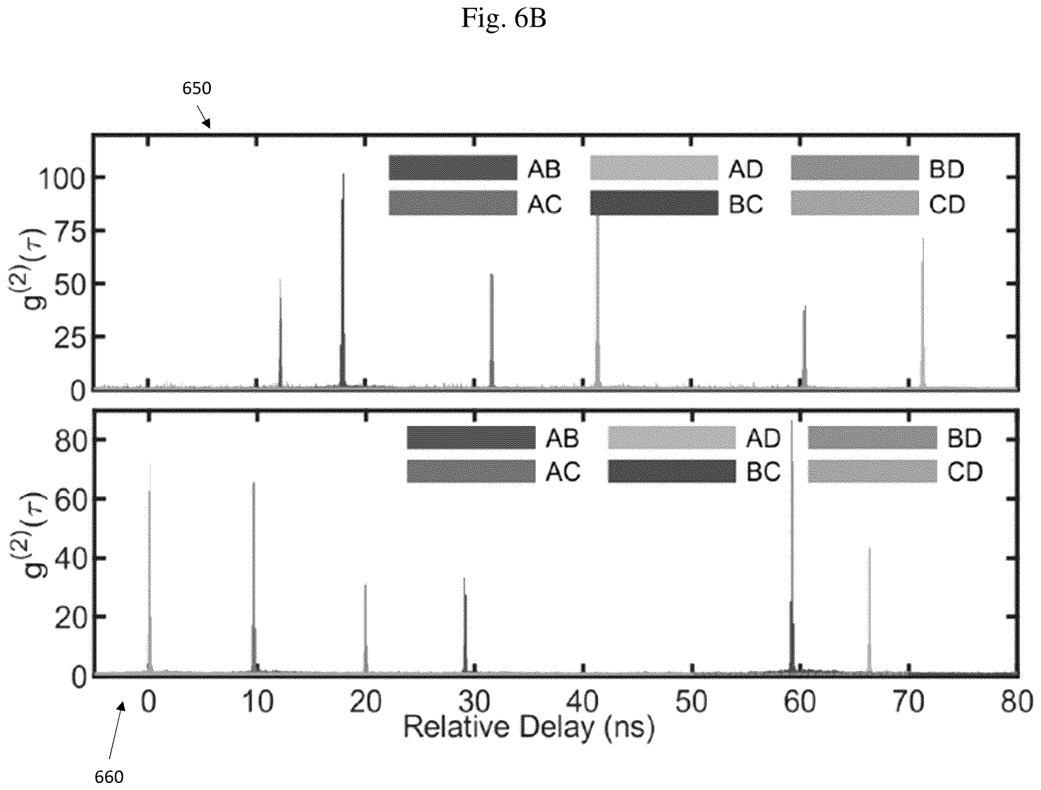

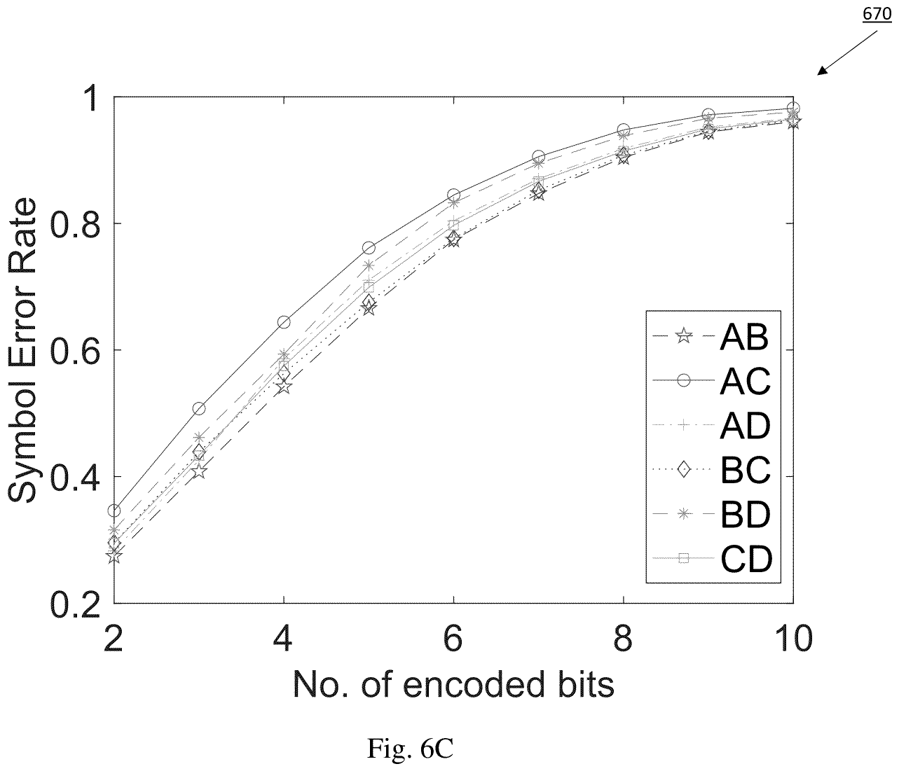

FIG. 6A is a graph 600 illustrating the temporal cross-correlation for each channel pair assigned to users. In various embodiments, each user pair is distinguishable and apart with a delay of a minimum of 2.5 ns.

It should be noted that channel pairs AD and CD show two peaks, whose weaker peak originates from the crosstalk-related correlation side peaks in FIG. 6B. The quantum key is retrieved from the photon timestamps of each detector by discretizing the time into finite bins and grouping those bins into frames according to 2N bits for N-bit encoding, Each user's discretization width and the number of encoded bits is optimized to maximize raw key rates.

FIG. 6C is a graph 670 illustrating the quantum symbol error rate for each user pair versus a different number of encoded bits. At 2-bits encoded, all the channels have a minimum symbol error rate between 27-31%, The error rate reaches up to 70% for 5-bit encoding, which provides the best key rates. The error rate approaches 100% at 10-bit encoding and above. The reason for high error rates is the system's high loss due to the mismatch in demultiplexing-remultiplexing process. This loss can be reduced, however. The errors inevitably increase at higher dimensions due to increased frame size, which leads to accidental coincidences, causing a symbol error.

The resulting maximal raw key rates and photon information efficiency is given in FIG. 4A for each user pair. In various embodiments, the disclosed system enables encoding effectively more than a single bit to each user except AC, with a range between 0,894 (AC) and a maximum of 1.216 (5-bit encoded) (BC) bits/photon over a symbol error rate of 60%, The maximum raw key rate per user pair is 1562 bits/s for AD, while the minimum key rate per user pair is 564 bits/s for AC. These rates are expected considering the individual channel capacities in FIG. 4C and the insertion losses due to multiplexer equipment.

In this work, a four-user QKD network using wavelength multiplexing with a key rate up to 1562 bits/s per channel and a photon information efficiency up to 1.216 bits/s is demonstrated. The disclosed QKD improves over alternative implementations by almost an order of magnitude. The network can be improved further by minimizing the insertion losses to gain another ˜10 dB to reach 10 kbits/s key rates per channel, demonstrate metropolitan-scale connection and ensure security using dispersive optics.

### Error Correction

In some embodiments, an efficient and fast error correction protocol can correct two types of errors inherent in the system, which are local errors originating from timing jitter and global errors originating from system noise and loss. In some embodiments, an error correction protocol based on layered low-density parity check matrices developed for arrival-time encoding can be employed. The flow of the protocol is as follows.

First, after the timestamping of arrivals of the signal, exemplary devices Alice and Bob generate A and B sequences. They first discretize their time information into bins and group into frames of q bins. Through publicly authenticated classical channels, they post-select the frames that both observed only one signal in the frame, From the post-selected frames, Alice and Bob generate the sequence of symbols according to the position of the binned photon arrival within each frame.

Then, the symbols of sequences A and B can be mapped to k bits, where k=log 2q.

In some embodiments, for information reconciliation, Alice can generate a message R, by encoding A (e.g., using Slepian-Wolf coding). A multilayer coding scheme can be used independently for each layer, where the Slepian-Wolf coding is applied to each layer using binary low-density random parity-check matrices.

In some embodiments, an LDPC decoder based on belief-propagation can be used to jointly decode B and R to recover A. The bits of message R are mapped to k check nodes, then the belief can be passed to a variable node, which changes the signs of the beliefs mapped to a second check node layer.

The independent encoding scheme is shown to be capacity-achieving and optimal under any mapping. The scheme results in a higher information capacity under a higher percentage of uniform errors, which is suitable for the present system with k>5 bits. A reconciliation efficiency at maximum PIE (6-bit) of 69% for a block size of 1000 and 92% using a block size of 10000 was reached.

The high block size requirements due to layer-by-layer encoding can increase latency. Degree distribution optimization and including an interactive communication layer improves such a latency. This resulted in 40 to 60% improvement in code rates. Therefore, a reconciliation efficiency of 75% can be obtained with a block size of 2000, reducing the latency further.

FIGS. 13A-B, 14, and 15 are graphs illustrating optimization of the modulation parameters at the source a.

FIG. 13A is a graph 1300 illustrating a probability mass function of the difference between the discretized symbols of Alice and Charlie, with a tbin=100 ps and 6-bit encoding. The inset graph 1302 illustrates a second-order correlation function with relative delay between Alice and Charlie at the source distance, with an FWHM linewidth of 180 ps.

FIG. 13B is a graph 1350 illustrating a distribution of individual timestamps over a frame with a tbin=100 ps and 6-bit encoding for Alice (red) and Charlie (black). An ideal uniform distribution is shown as blue, with a probability of 0.015625 over 64 bins.

FIG. 14 is a graph 1400 illustrating a distribution of correlated frames (black), global (blue), and local errors (red) with 6-bit encoding for Alice and Charlie for different tbin.

FIG. 15 is a graph 1500 illustrating a distribution of correlated frames (black), global (blue), and local errors (red) with a tbin 100 ps for Alice and Charlie for different numbers of encoded bits.

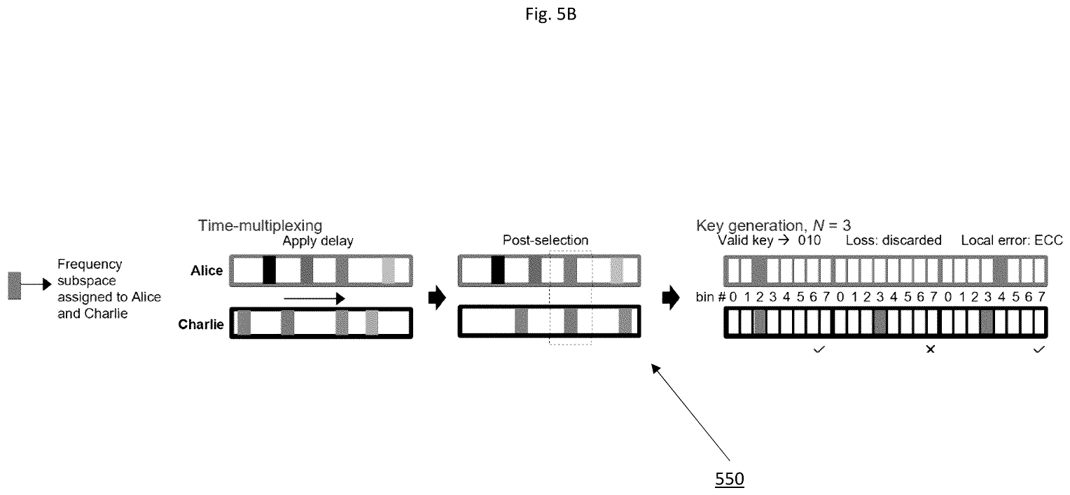

FIG. 5A is a flowchart 500 of a high-dimensional arrival-time-bin encoding protocol according to embodiments of the present disclosure. As an example, only Alice and Charlie are shown. The protocol starts with distributing multiplexed frequency bands (e.g., subspaces) to each user, which undergo timing errors and loss. 10% of the incoming photons are used to establish a Holevo bound for security monitoring. A portion of the timestamps are disclosed (e.g., the portion being intervals of time that the timestamps occur within) among users to monitor error rates and to determine the best modulation parameters (e.g., bin width thin and the number of encoded bits, N). The rest of the photons undergo discretization, modulation, and post-selection procedures, which produce raw keys. A layered LDPC error correction code is used to correct global and local errors.

Key generation protocol can be based on the 1024-dimensional arrival time-bin encoding, where the arrival timestamps of the incoming photon pairs are discretized into arrival time-bins and grouped into frames of N-bins. For two synchronized channels, a pair of SPDC-generated energy-time entangled photons are generated and detected at the same time within a photon correlation uncertainty. In this way, it is possible to encode log 2 N bits per photon pair, significantly enhancing the key rates and information efficiency per photon compared to binary protocols such as BB84. In some embodiments, a central network provider generates energy-time entangled photon pairs with uniform distribution over an absolute time frame, demultiplexing the pairs into frequency subspaces. The provider can assign each connection an entangled frequency subspace and a corresponding time delay to facilitate multiplexing. The channels are grouped according to their destination and multiplexed after the assigned delays are applied. The multiplexed photons are sent to their respective nodes over a single fiber for each node. During the propagation, the photons can experience timing errors such as detector jitter, fiber dispersion, channel losses, and background noise. At each node receiver module, a portion of the incoming photons (e.g., 10%) is diverted for security monitoring, while the rest is detected and timestamped with high temporal resolution for maximized information distribution. The protocol can employ dual-basis correlation measurements in the time- and dispersive-time (equivalent to frequency).

FIG. 5B a diagram 550 illustrating simultaneous generation of raw keys among users according to embodiments of the present disclosure. The generation of keys achieved by shifting the same timestamps according to the predetermined delay between each user and post-selecting the coincidence events. A multi-bit symbol is generated according to predetermined modulation parameters from the frames with a single photon detection for Alice and Charlie, Binary coding is used to convert the timestamp location inside the frame. Any frame pairs that possess an error are attempted to be corrected using error correction coding.

In some embodiments, simultaneous key generation can be performed using the same timestamps by shifting the frames according to the preassigned delay, FIG. 5B illustrates the simultaneous key generation from the time-multiplexed recordings of the arrival times of the signal. In some embodiments, only the shared photon pairs between two nodes are detected as coincidence events when the timestamps are shifted, while the rest of the multiplexed photons act as uniform background noise.

Before key generation, an initialization procedure is needed to agree on the modulation parameters, such as the discretization width t_{bin}, the number of encoded bits, and the time synchronization. For this purpose, each node shares a portion of their timestamps to detect coincidence events, First, using available clock synchronization techniques, two distant nodes can synchronize their time-tagging modules. Second, the second-order correlation between timestamps, g⁽²⁾ can be used to synchronize the channels between two nodes to account for propagation distances and the preassigned delay. The synchronized and shifted timestamps can post-processed to generate a key using different modulation parameters to determine the optimal parameters that can maximize the key rate and photon information efficiency. The rest of the recorded timestamps can be used to generate quantum keys. The timestamps can be discretized into bins and grouped into frames according to the optimal parameters agreed on earlier. The communicating users can reveal the frames that contain only a single detection event and discard the rest. The matching frames can be post-selected and can be used for key generation.

Within each frame, the position of the detection event can be converted to binary information according to the predetermined coding scheme and can be used for encryption. However, the recorded bitstream can contain two types of errors: global errors and local errors. Global errors can be caused by photon loss and accidental coincidences between uncorrelated photons. Local errors can be caused by timing errors due to jitter, channel dispersion, and synchronization errors. The photons that each node can detect have a uniform probability distribution over a single frame. Thus, the global errors that are caused by the concurrent detection of two independent photons follow a triangular distribution. This distribution can be approximated as a weak Gaussian distribution with a linewidthσ^{2global}≈N/2 under the central limit theorem for a large number of photons and channels. On the other hand, local errors can be highly correlated and occur due to the jitter and dispersion added to the biphoton wavepacket. Such local errors follow a joint Gaussian distribution with an FWHM linewidth closer to the convolved jitter of individual detection events, where σ^{2local}=σ^{2jitter}+σ^{2corr}+σ^{2disp}. The combined joint distribution of concurrent detection events is thus described by:

$$ℙ ( B = y \vert A = x ) = {α}_{1} {e}^{- {\vert y - x \vert}^{2} / {σ}_{local}^{2}} + {α}_{2} {e}^{- {\vert y - x \vert}^{2} / {σ}_{global}^{2}} + μ \qquad ( 1 )$$

where a1, a2, and μ are parameters normalizing the probability of local and global errors according to the symbol error rate.

An error correction scheme can be employed to correct such errors. In this scheme, binary mapping is employed to convert the bin positions in each frame to symbols. After, the non-binary symbols are separated into layers from the least-significant bit to the most-significant bit. Each layer is independently encoded by a first device (e.g., Alice) using Slepian-Wolf encoding and regular low-density parity-check (LDPC) matrices with different parameters at each layer. The propagated LDPC-encoded matrix is decoded similarly layer-by-layer by a second device (e.g., Bob). In this independently-encoded scheme, key rate extraction can be improved further by an interactive procedure where the first device (e.g., Alice) and the second device (e.g., Bob) communicate a part of their results to improve Slepian-Wolf encoding parameters under high symbol error rates. This method can be efficient in correcting and discarding such errors under high global error probability, demonstrating that quantum keys can be generated with highly noisy channels.

In example implementations, a block size of 10,000 was employed for high-fidelity key generation. The parameters were optimized in the encoding, providing the corrected Shannon information capacity and reconciliation efficiency. Finally, a privacy amplification scheme such as Toeplitz hashing can be used according to the security analysis for the final keys. This protocol enables the concurrent generation of keys with the same recorded bitstream, even under high background noise and errors up to 50%.

FIG. 6A is a graph 600 illustrating a time correlation histogram.

FIG. 6B are graphs 650 and 660 illustrating dine correlation histograms. Graph 650 illustrates a time correlation histogram at the source, and graph 660 illustrates time correlation histograms after 21 km propagation. Gaussian correlation peaks have a linewidth much smaller than the spacing between them, whose minimum is 5.73 ns (e.g., in graph 650) and 7.11 ns (in graph 660).

In some embodiments, the generated signal and idler photons are centered at 1562.18 nm and 1559.34 nm with a sinc2 spectral shape. The ppKTP waveguide is fiber-coupled and pumped with a 780.3 nm laser with 9 mW power and =1 MHz linewidth to generate coincidence pairs with a rate of 3×105 counts/s. In some embodiments, DWDM modules employ 50 GIz channel spacing to demultiplex the non-degenerate photon pair, which thereby generates six pairs of frequency-entangled Hilbert subspaces within the SPDC linewidth. The signal and idler channel pairs are named according to the 50 GHz ITU DWDM grid. The sinc2 shape of the SPDC spectrum is reflected in the difference between the peak coincidences, resulting in varying entanglement distribution rates per node pair. The required number of subspaces in an Np-node network is Np (Np−1)/2. In a four-node network, six (e.g., 4*(4-1)/2=6) subspaces are used, six of the brightest signal (C21-H23) and idler (Cl8-H20) channels are employed to maximize the entanglement distribution.

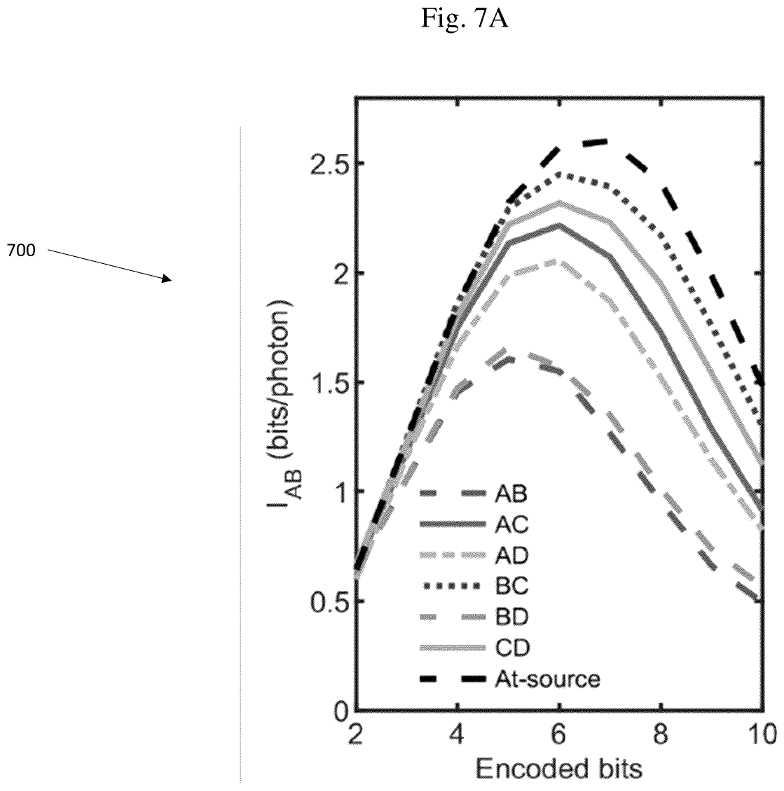

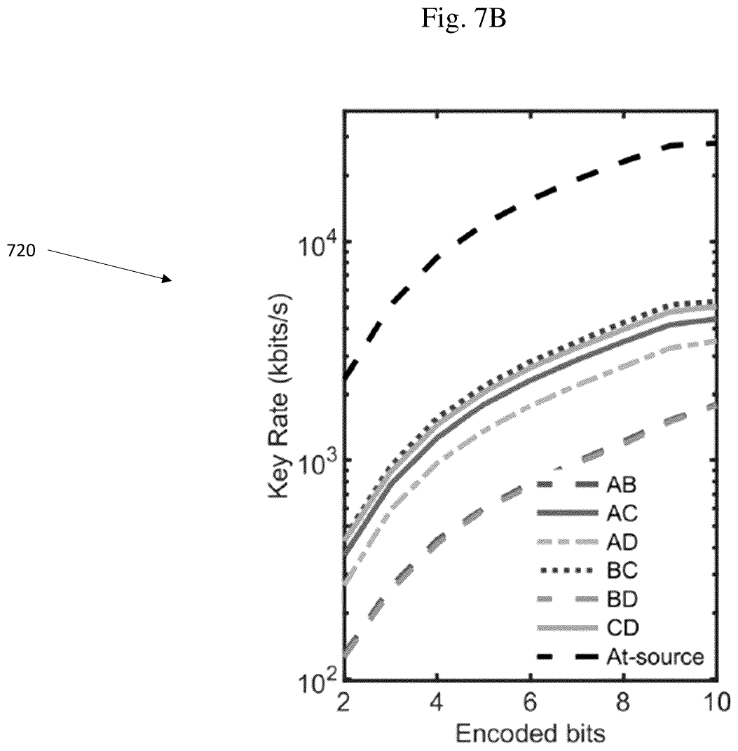

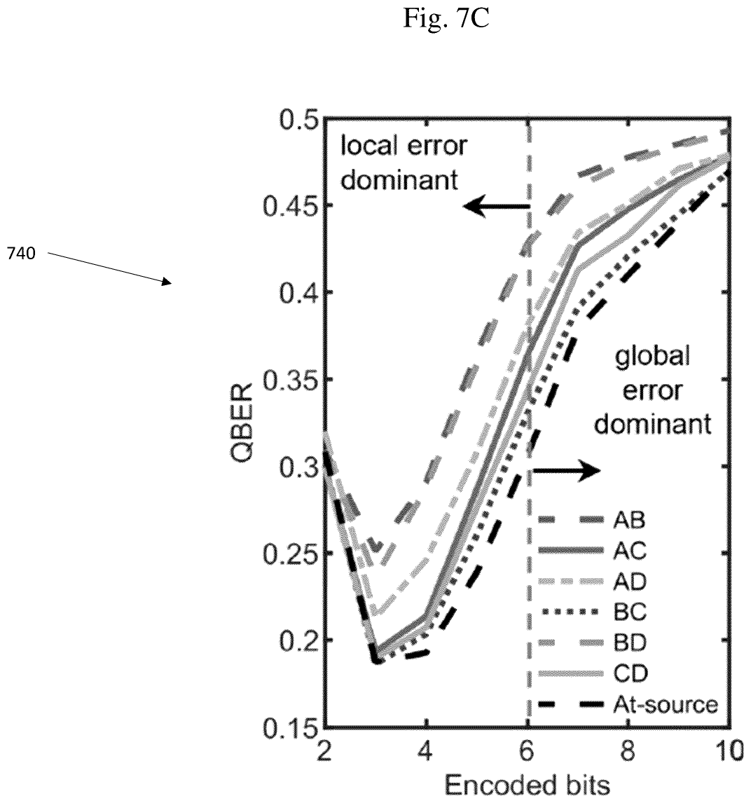

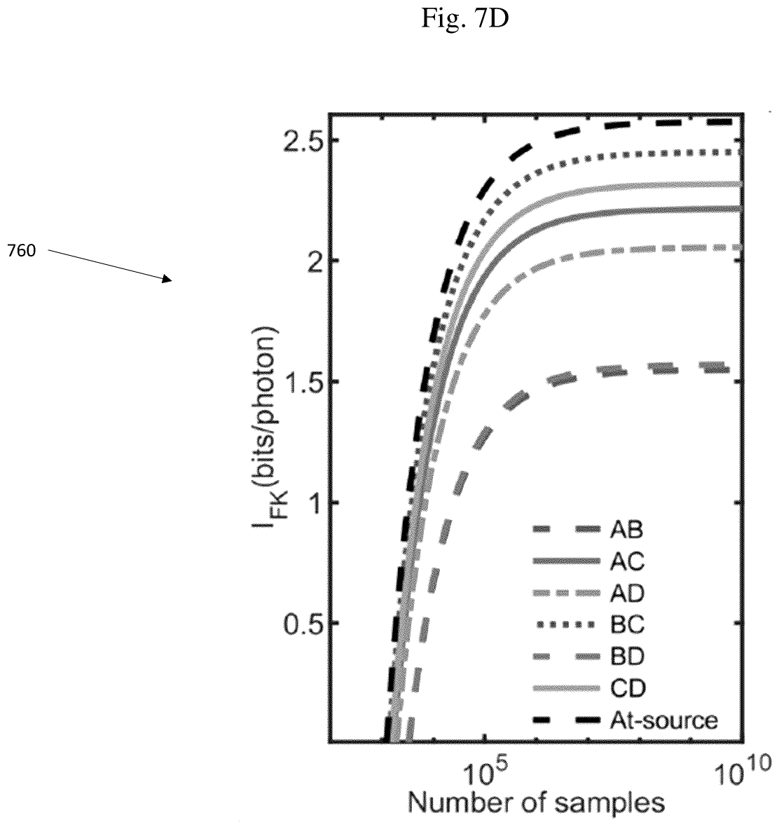

The frequency correlations between the demultiplexed channels can be measured using coincidence analysis recorded for 3 seconds and summarized in FIG. 7A. The coincidence rate of each entangled channel pair can be optimized through the alignment of the ITU grid with the SPDC spectrum. The coincidence rate ranges between a minimum of 11,370 counts/s (H20-C21) at the edge of the spectrum and a maximum of 24,880 counts/s (C19-H22) at the spectral peak. The leakage of the entangled photons to adjacent channels can be compared to the correlation peak is suppressed by over 10 dB, With this optimization in place, the highest-correlated channel pairs can be designated to represent each connection within the network topology. Furthermore, the correlated channels can be assigned for node distribution such that no node receives adjacent channels within the ITU grid. Assigning channels in such a way allows suppressing photon leakage further.

The channels destined for each node can be multiplexed by a second commercial DWDM module and sent over a single SMF-28 optical fiber to each respective node, thus drastically reducing the equipment requirements per node. In some embodiments, the total insertion loss from the ppKTP source to the multiplexer module output is 8.4 dB. For the temporal multiplexing to distinguish between node photon correlations, the predetermined delays are added using fixed-length fibers between each correlated channel pair, targeting at least a 10 ns difference. The assigned delays can be seen in temporal correlation histograms, which are given in FIG. 6B graph 650 (at the source) and FIG. 6B graph 660 (after 21 kin propagation) under an absolute reference frame, Each temporal correlation peak can be Gaussian-broadened due to the timing jitter of the detector (70 ps), with a near-uniform baseline due to accidental coincidences. Due to the equipment-induced channel delays, the minimum spacing between each temporal correlation peak can be measured as 5.73 ns at the source and 7.11 ns after 21 km propagation. In both cases, clear separation among the correlation peaks can be observed and achieved, which can minimize accidental coincidences from the background. A dispersion compensation module equivalent to the dispersion accumulated over the traversed SMF-28 fiber can preserve the timing correlations.

In some embodiments, 10% of the photons arriving at each node is routed to a security check apparatus, which comprises a normal and an anomalous dispersion compensation module with equal but opposite dispersion magnitude of ±10 ns/nm, to completely map the frequency correlations over the arrival time of the photons. The modules can employ non-local dispersion cancellation to recover the original correlation linewidth, which a metric to monitor disturbances in the channel. In some embodiments, the remaining 90% of the photons can be detected by a PhotonSpot superconducting nanowire single photon detector (SNSPD). The SNSPD can operate at 800 mK with a detection efficiency of 85 to 90%, dark count rate of ≈200 cps, a timing jitter of ≈70 ps, and a dead time of 50 ns. The dead time can act as a safeguard against multi-detection events. As a result, the dead time can limit the maximum detection rate and further reduces any errors. In some embodiments, detection events can be timestamped via Picoharp 300 and Swabian Instruments TimeTagger 20 modules, both of which can have a resolution of 1 ps. The SNSPD and the time-tagger electronics can contribute non-negligibly to the timing jitter. In some embodiments, the quantum network of the present disclosure, jitter-induced broadening of the second-order correlation is measured at ≈150 ps between a photon pair.

### Multi-Node Quantum Network—Operational Photon Information Efficiency, Multi-Party Key Rates and QBER Performances

FIG. 7A-D are graphs 700, 720, 740, and 760 illustrating the results of simultaneously recorded timestamps at the system according to embodiments of the present disclosure. The performance of the system is described below in terms of information capacity, QBER, and key throughput. The modulated timestamps, post-selection, and error correction are implemented for different discretization widths and the number of encoded bits per the protocol to investigate optimal encoding conditions. The measurements were conducted at two different propagation distances: at the source (=0 km) and after 21 km propagation, wherein the latter has resultant dispersion compensated using non-local dispersion compensation.

FIG. 7A-D illustrate the dependencies of the quantum network information capacities, resulting key rates, and error rates with the number of encoded bits and the discretization width. This maps the optimal conditions for each network channel. The experimental mutual information I_{AB} is computed from actual joint probabilities calculated over each block,

$${I}_{AB} = {\sum }_{x = 0}^{{2}^{N} - 1} {\sum }_{y = 0}^{{2}^{N} - 1} p ( A = x , B = y ) \cdot {log}_{2} \frac{p ( A = x , B = y )}{p ( A = x ) p ( B = y )} \qquad ( 2 )$$

This I_{AB} is in terms of photon information efficiency (PIE), the effective number of bits delivered per photon pair contributing to the key generation assuming near-unity error correction coding parameters (e.g., denoted as bits/photon). Different LDPC-based schemes are tested for reconciliation efficiency and latency, resulted in a reconciliation efficiency up to 92% for maximum PIE, and 75% with low-latency. In some embodiments, the discretization width i_{bin} is taken at 100 ps. Such a t_{bin} value is close to a detection jitter limit for certain equipment, and can enable dense encoding over the arrival time information.

FIG. 7A is a graph 700 illustrating the scaling of PIE with the number of encoded bits after 21 km propagation according to embodiments of the present disclosure. The PIE can maximize at 5-bit or 6-bit encoding, depending on the channel. This is due to the change in the local and global error probabilities. The number of encoded bits increases the size of the frame exponentially, i_{frame}=t_{bin}×2^{N}. The probability distribution of the local errors can be independent of the frame size and only dependent on the t_{bin}; however, the global error probability increases with increasing frame size. Thus, the increase in global errors after 6-bit encoding overtakes the information gained by encoding more bins. The peak can occur at 5-bit encoding for the side channels AB and BD since these channels have less coincidences-to-singles ratio. In some embodiments, after 21 km propagation, all channels except the highest-rate channel BC have the peak PIE at 5-bit encoding due to the reduction in the coincidences-to-singles ratio induced by the fiber loss.

FIGS. 7B and 7C are graphs 720 and 740 illustrating, respectively, scaling of the key rates and QBER with the number of encoded bits after 21 km propagation according to embodiments of the present disclosure. The peak key rates can occur at a higher-bit encoding since there is a marginal gain due to an increased number of bits per photon pair. Even though the overall photon information efficiency can be reduced due to an increase in the frames contributing to the key generation process, and hence the number of accidental coincidences, a key extraction is possible from the entangled pairs with high alphabet from 15,538 bits/s at peak PIE (6-bit encoding) up to 27,861 bits/s at (10-bit encoding) using the optimal error-correction coding. For the QBER, an increase from 12.16% to 49.65% is observed when the number of encoded bits (and frame size) is increased from 2-bit to 10-bit 1024-dimensions, yet it produces non-zero information capacity. The reduction in errors at the lower 3-bit and 4-bit encoding is a result of the fact that local errors have a narrow Gaussian probability distribution. Therefore, the least-significant-bit errors with only a 1-bin difference between two symbols can be the most likely outcome for the small frame sizes. Upon increasing the number of encoded bits, even though the number of errors is the same, the ratio of errors among all the bits reduces with a larger alphabet symbol (prior to global errors becoming the dominant factor).

FIG. 7D is a graph 760 illustrating a change in the PIE when finite-key effects taken into account. Information capacity, I_{FX}=1_{AB}·Δ_{FK}, with Δ_{FK}, can be expressed as:

$${Δ}_{FK} = 1 / n \cdot {log}_{2} ( 2 / {ε}_{EC} ) 2 / n \cdot {log}_{2} ( 1 / {ε}_{PA} ) + ( 2 {log}_{2} d + 3 ) \sqrt{{log}_{2} ( 2 / ε ) / n} \qquad ( 3 )$$

Here, εEC. εPA, and e are the failure probability of error correction, the failure probability of privacy amplification, and the smooth min-entropy, which is taken as 10-10, in accordance with the literature, while n and d are the number of samples used in key generation and the symbol dimension. ΔFK can reduce below 0.1 bits/photon for a sample size above 6× 105, which is equivalent to a recording duration of 20 seconds to 1 minute, depending on the node connection.

FIG. 26 is a graph 2600 illustrates the mutual information (e.g., Shannon capacity) of each channel in terms of PIE, which is the effective number of bits obtained per photon at 0 km and 21 km distances, the key rate, and the QBER. The graph 2600 illustrates photon information efficiency in terms of Shannon information per photon at the source (blue) and after 21 km propagation (orange).

FIG. 27 is a graph 2700 illustrating Quantum bit error rate for each connection at the source (blue) and after 21 km propagation (orange).

FIG. 28 is a graph 2800 illustrating Resultant raw key rate at the source (blue) and after 21 km propagation (orange).

In some embodiments, it is possible to effectively encode more than 2 bits per photon at the source for AC, BC, and CD connections, which are the frequency subspaces closest to the SPDC spectral center, while the frequency subspaces closer to edges provide a minimum of 1.56 bits/photon (BD). In some embodiments, at 0 km, the average PIE and the corresponding number of encoded bits for each connection (AB, AC, AD, BC, BD, CD) are 2.057 (6-bit), 2.532 (6-bit), 2.434 (6-bit), 2.603 (7-bit), 1.952 (6F-bit), and 2.562 (6-bit) respectively. In some embodiments, after 21 km propagation, the average PIE is measured for each connection (AB, AC. AD, BC, BD, CD) as 1.554 (5-bits), 2.170 (5-bits), 2.04 (6-bits), 2.394 (6-bits), 1.721(5-bits), and 2.271(6-bits) respectively. In some embodiments, after 21 km propagation, a dense photon information efficiency over 1 bit/photon is still sustained, with a minimum PIE of 1.15 bits/photon (AB) and 1,94 bits/photon (BC). The degradation of the PIE can be more pronounced for the side channel AB due to the smaller coincidences-to-singles ratio. In some embodiments, low coincidences-to-singles ratio also leads to an increased percentage of global errors, which reduces the number of bits that can be encoded for peak information capacity. At 0 km, the side channels were encoded with 5-bits, while the rest of the channels have their peak information capacity at 6-bit encoding, corresponding to a frame size of 6.4 ns. The peak dense information capacity is achieved at 5-bit encoding (e.g., 3.2 ns frame size) after 21 km propagation due to the increasing global errors with propagation losses,

FIG. 29 is a graph 2900 illustrating modeling of network performance and scaling according to embodiments of the present disclosure. FIG. 29 illustrates an achievable photon information efficiency (bits/photon) rates for different noise models. Baseline experimental parameters are TF=6.4 ns, TB=100 ps, ξ=1, σJ=32 ps, σcoh=106 ns, σcor=0.75 ps, Nambient=4200 counts/s, the initial loss is 15.1 dB and the detector efficiency is 85%. The maximum PIE curves are calculated by optimizing over all frame sizes assuming no initial noise.

FIG. 30 is a graph 3000 illustrating a PIE plotted as function of the frame size (where TF is in ns) and for varying bin widths. The two overlapping dashed curves correspond to the experimental parameters with bin widths of σJ and

$$\frac{σ J}{10}$$

(showing that a bin width smaller than σJ does not yield a higher PIE), The maximum time key curve corresponds to having no noise, σJ=0, and a bin width smaller than σcor.

FIG. 31 is a graph 3100 illustrating a plot showing the PIE as a function of distance for a varied number of users. Experimental parameters are used and curves are shown for an SPDC source bandwidth of 250 GHz and 1.25 THz. The solid lines correspond to the median PIE and the top and bottom of the dashed error bars correspond to the maximum and minimum rates, respectively.

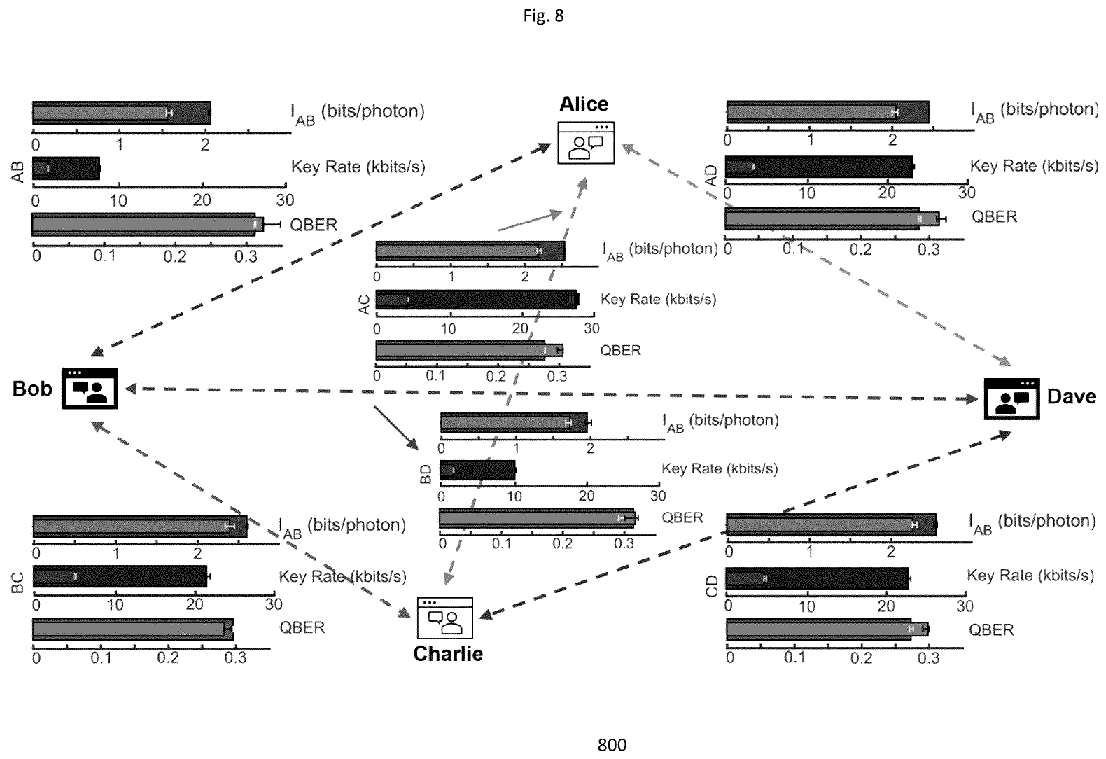

FIG. 8 is a diagram 800 illustrating the QBER for each link for the optimal modulation parameters at 0 km and 21 km distances. The data is for 100 ps discretization width and the number of encoded bits with the highest photon information efficiency. At 0 km, the average bit error rates for each connection for maximum PIE (e.g., at 6-bit encoding) ranges between 27.24% (e.g., CD) and 31.48% (e.g., BD). After 21 km propagation, the average QBER is measured between 28.20% (BC) (6-bit) and 32.42% (AB) (5-bit). The resultant raw key rates are calculated by multiplying the number of frames contributing to the key generation with the photon information efficiency. Because the number of frames scales with the encoded number of bits, the maximum key rate and PIE may not coincide during the operation. The magnitude of key rates largely follows the intensity of frequency correlations presented in FIG. 3, where the connections closest to the center of SPDC spectrum have the highest raw key rates, At 0 km, the maximum raw key rate can be obtained at AC as 27,861 bits/s, while the minimum key rate can be obtained at AB as 7,886 bits/s, a channel at the edge of SPDC spectrum. Because coincidence loss can be due to either signal or idler photon loss, where the detection probability is Pcc=Psignal x Pidler, the scaling of the key rate can be the square of the photon loss. The measured raw key rates at 21 km follow this rule. For example, AC has a raw key rate of 4,390 bits/s at 21 km, compared to 27,861 bits/s at the source. The effective propagation loss can be calculated as 0.194 dB/km, which is close to the fiber propagation loss specified as 0.18 dB/km. The system achieves remarkable results for achieving high-rate quantum networks, including a key rate and photon efficiency in excess of alternative binary encoding schemes wherein the latter efficiency is much lower than the 1-bit/photon limit. This is due to the fact that global errors are overtaking local errors as the dominant source of error at larger frame sizes, which reduces PIE significantly. Yet, the number of total frames contributing to key generation increases, which is a trade-off.

In some embodiments, for security monitoring, 10% of the photons can be split through a beamsplitter and passed through ±10 ns/nm dispersion compensation modules as stated prior. In some embodiments, a different percentage other than 10% of the photons and/or signal can be split. Then, each node connection uses these results to monitor the frequency-basis correlations to calculate the change in the time-frequency covariance matrix,

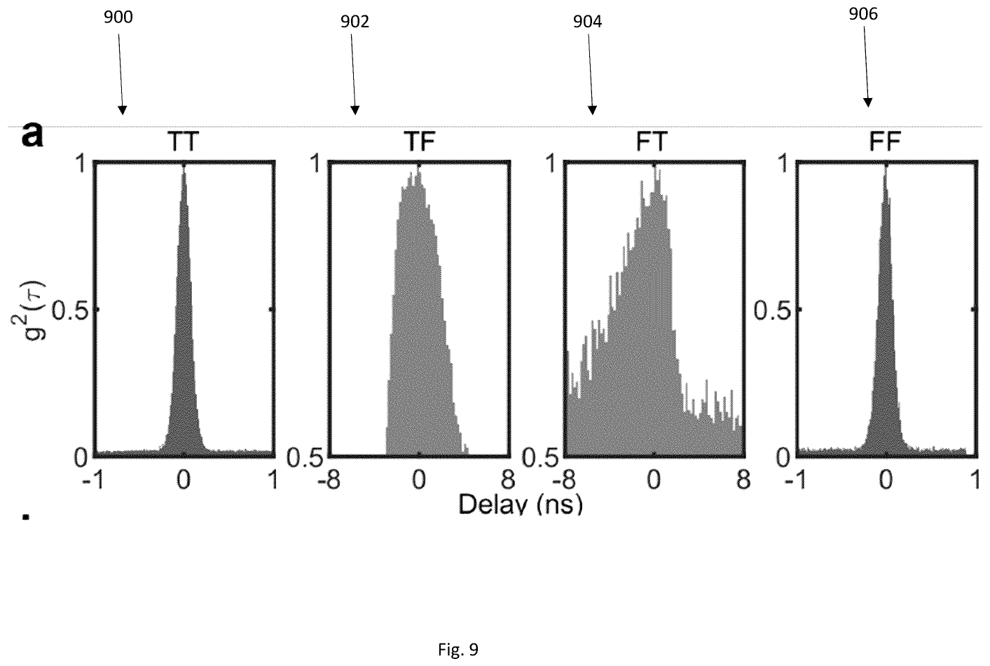

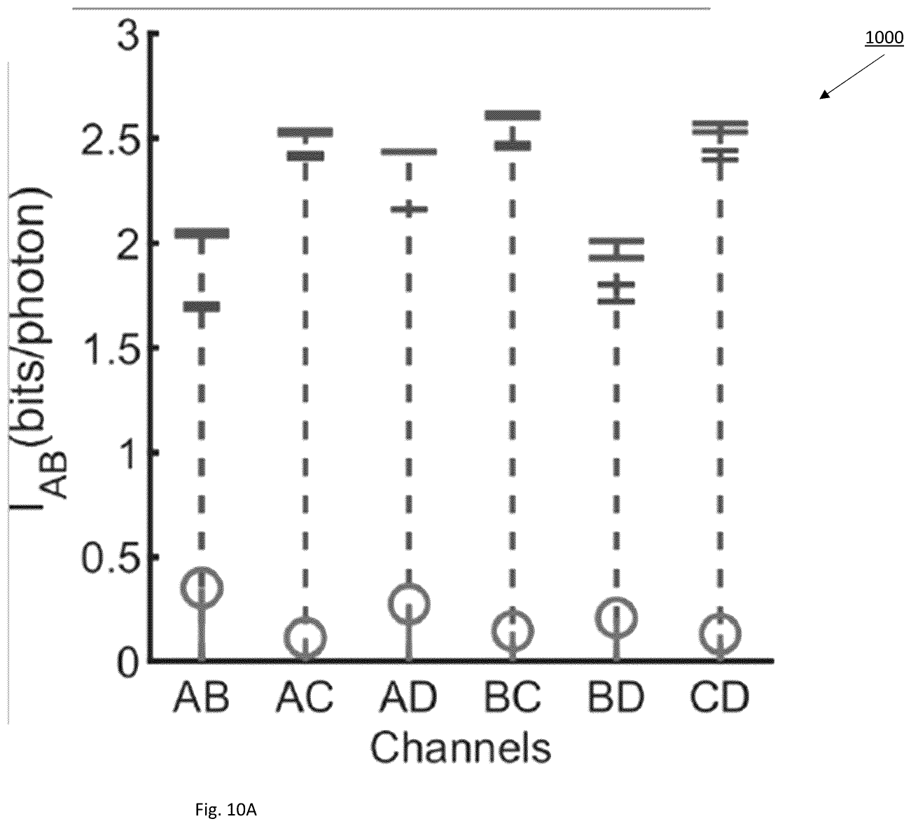

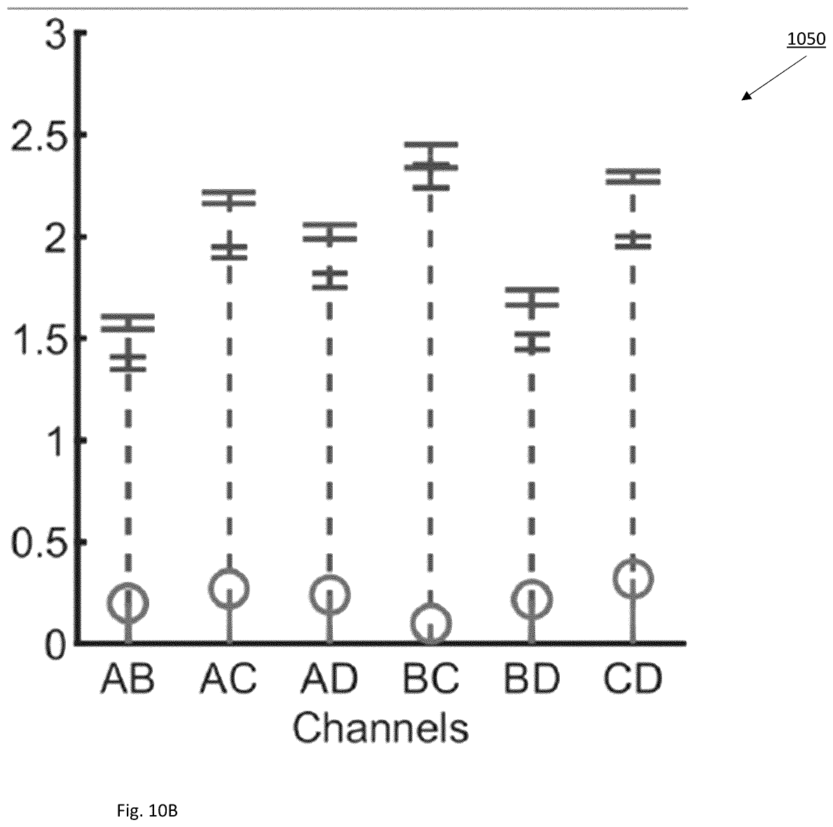

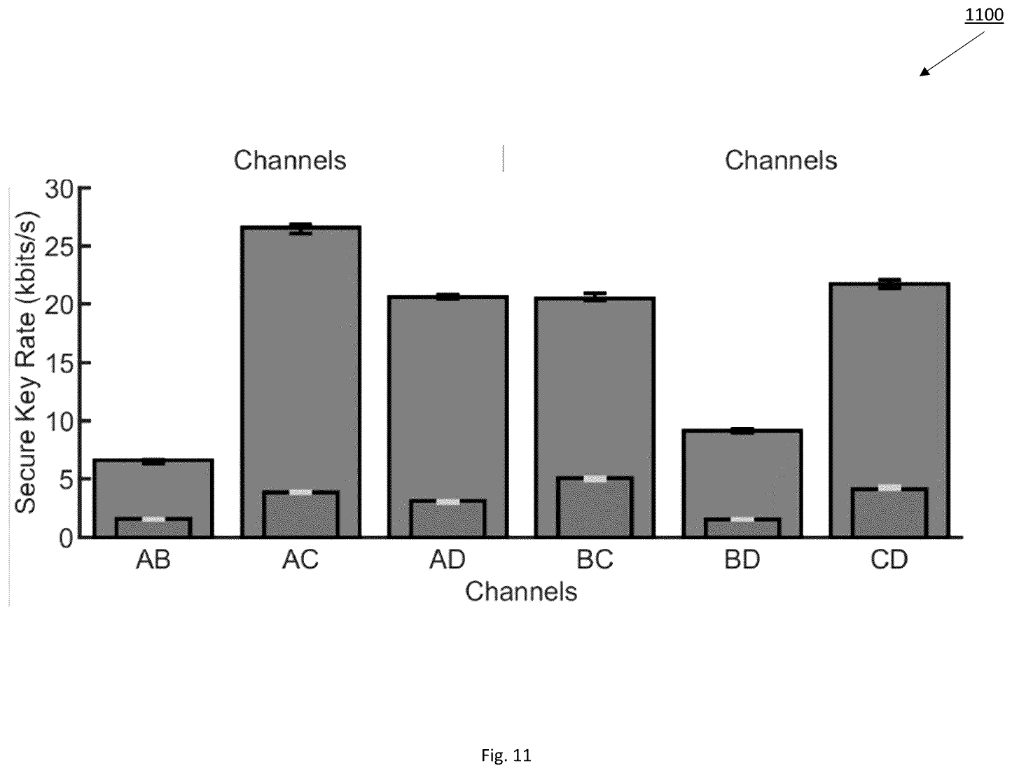

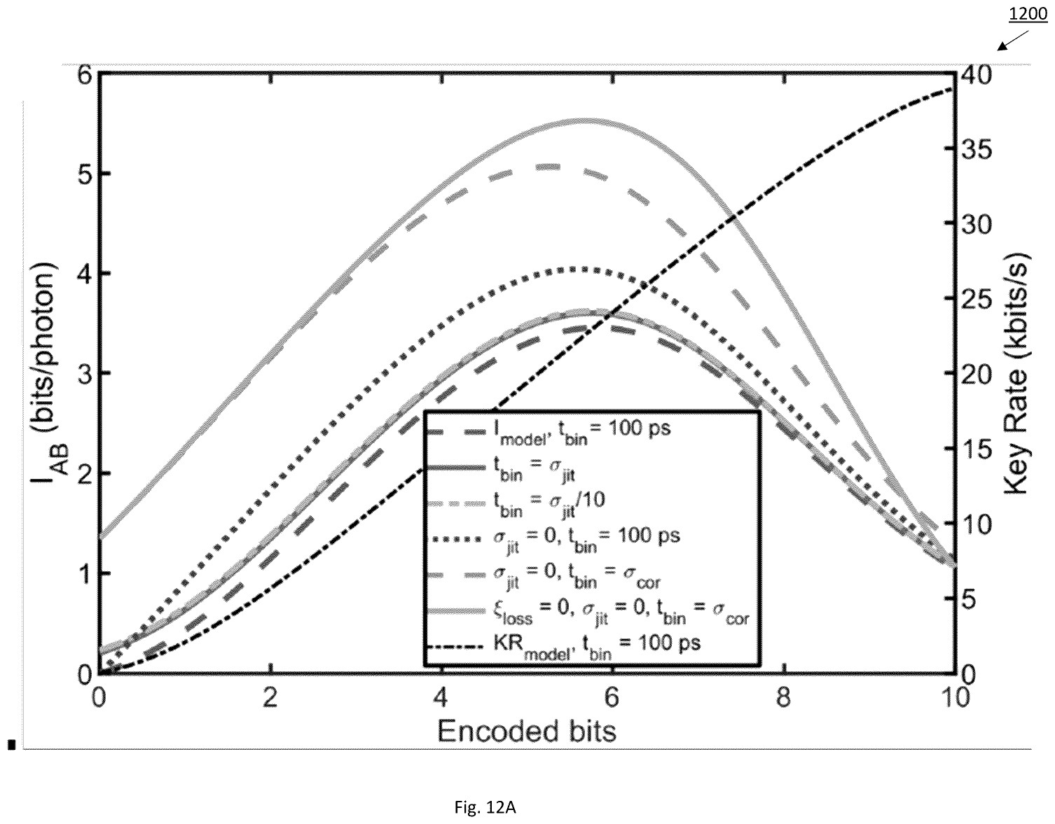

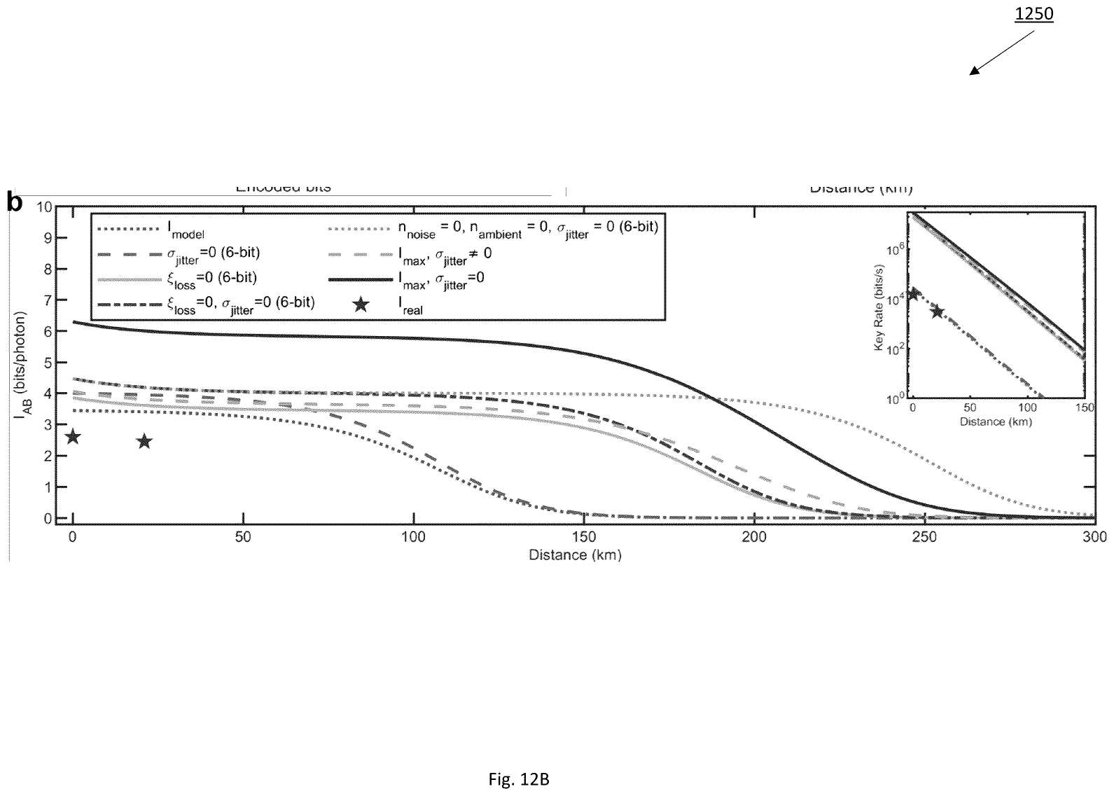

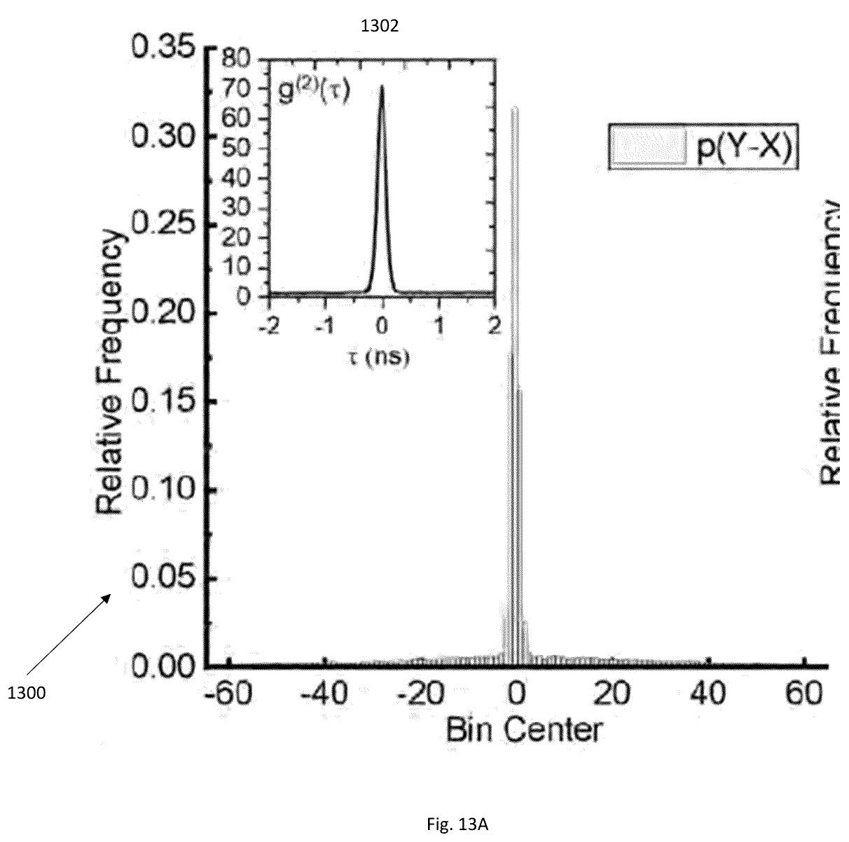

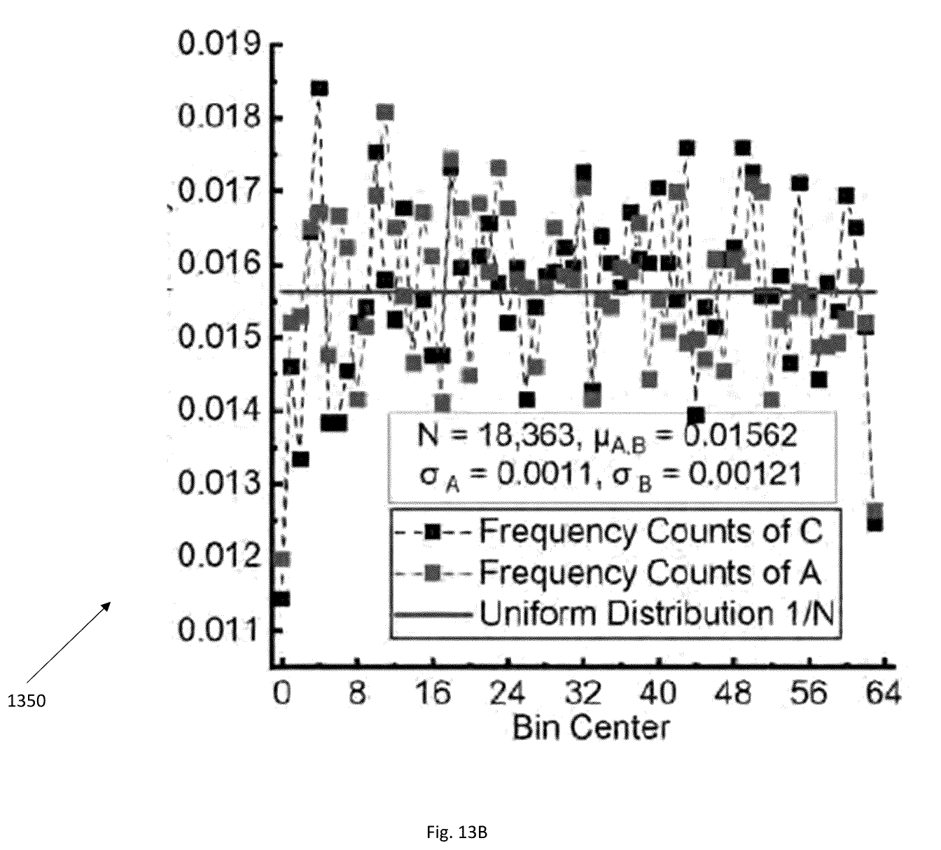

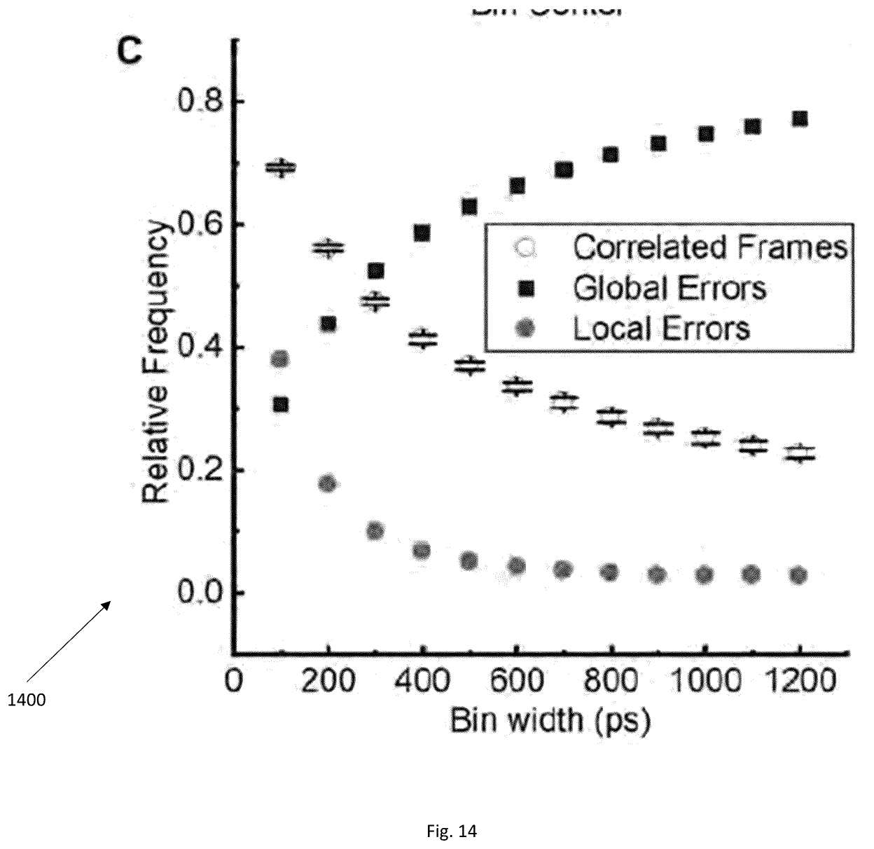

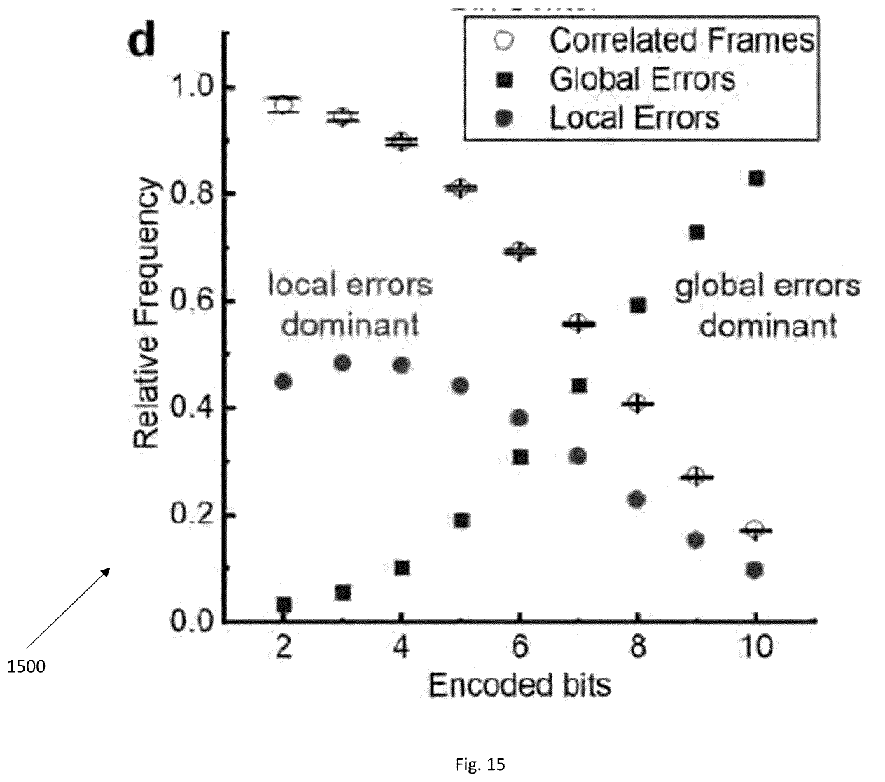

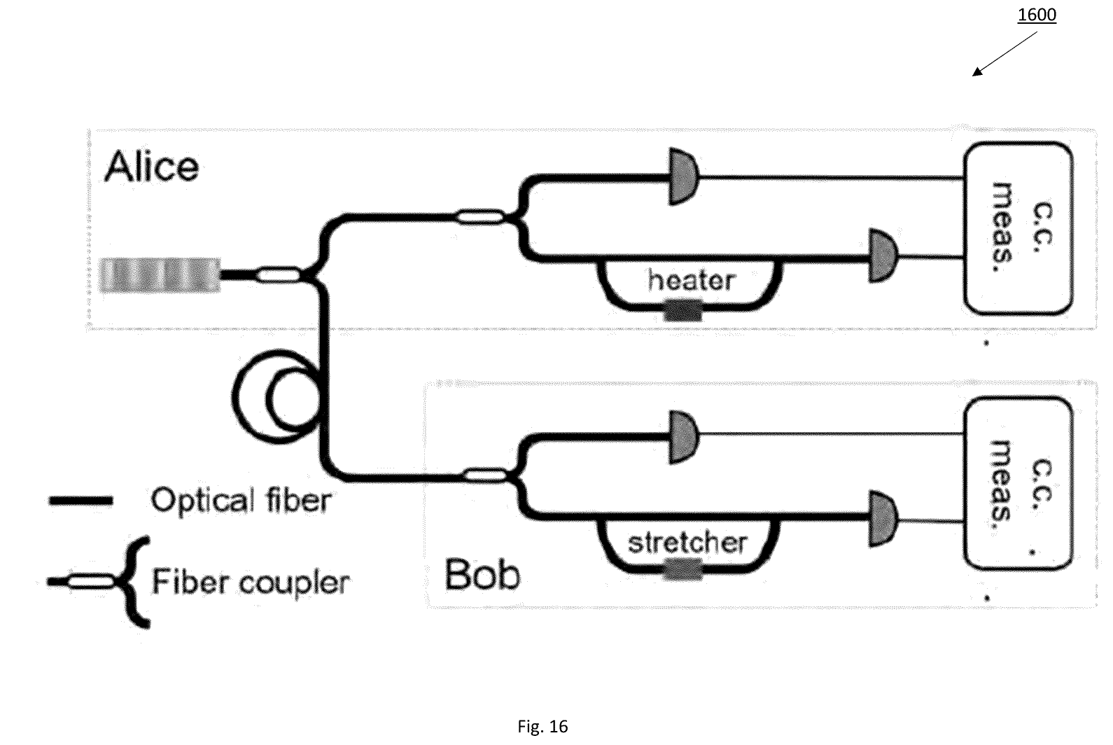

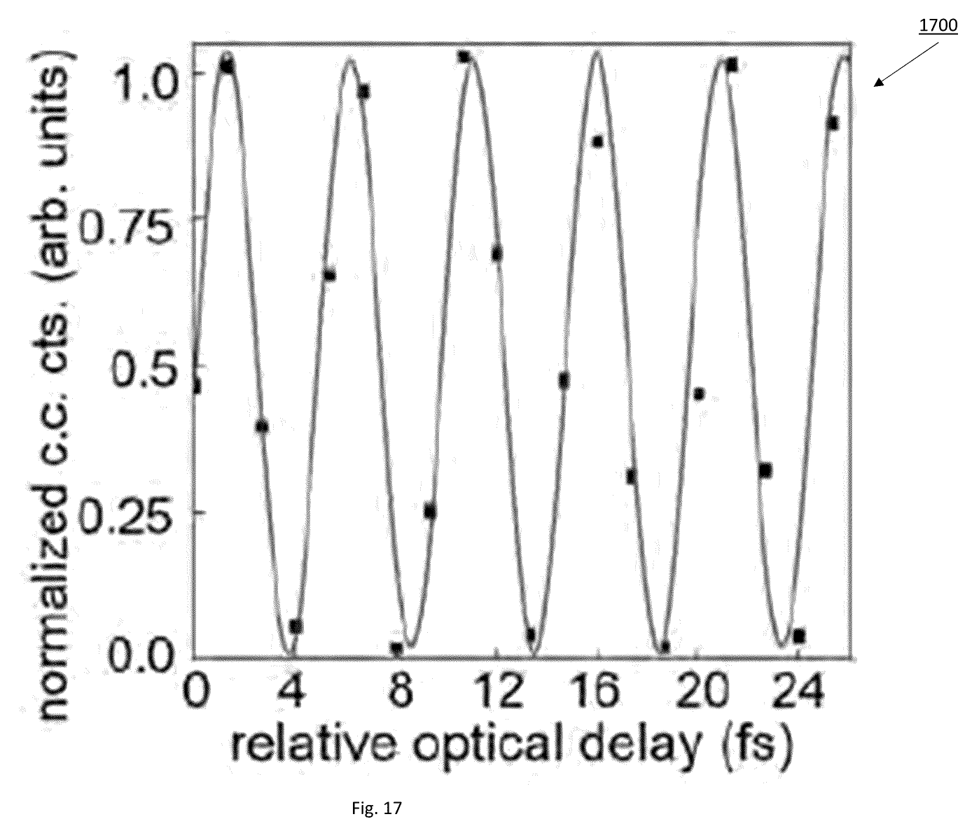

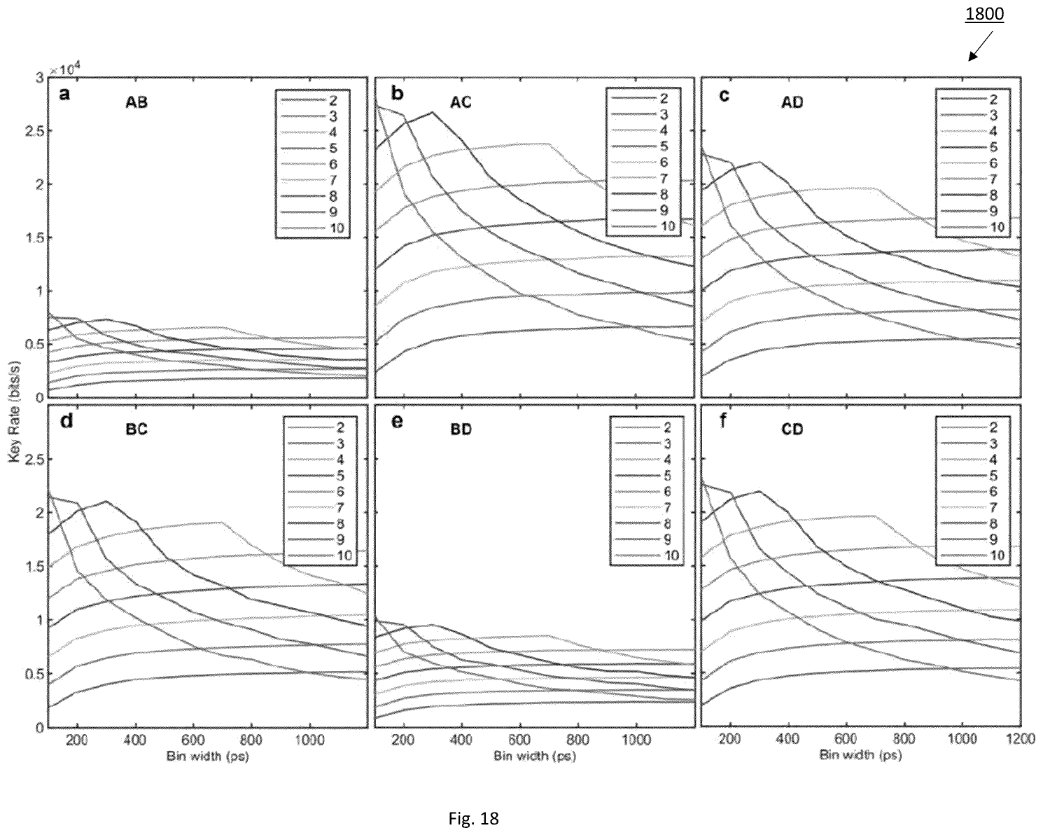

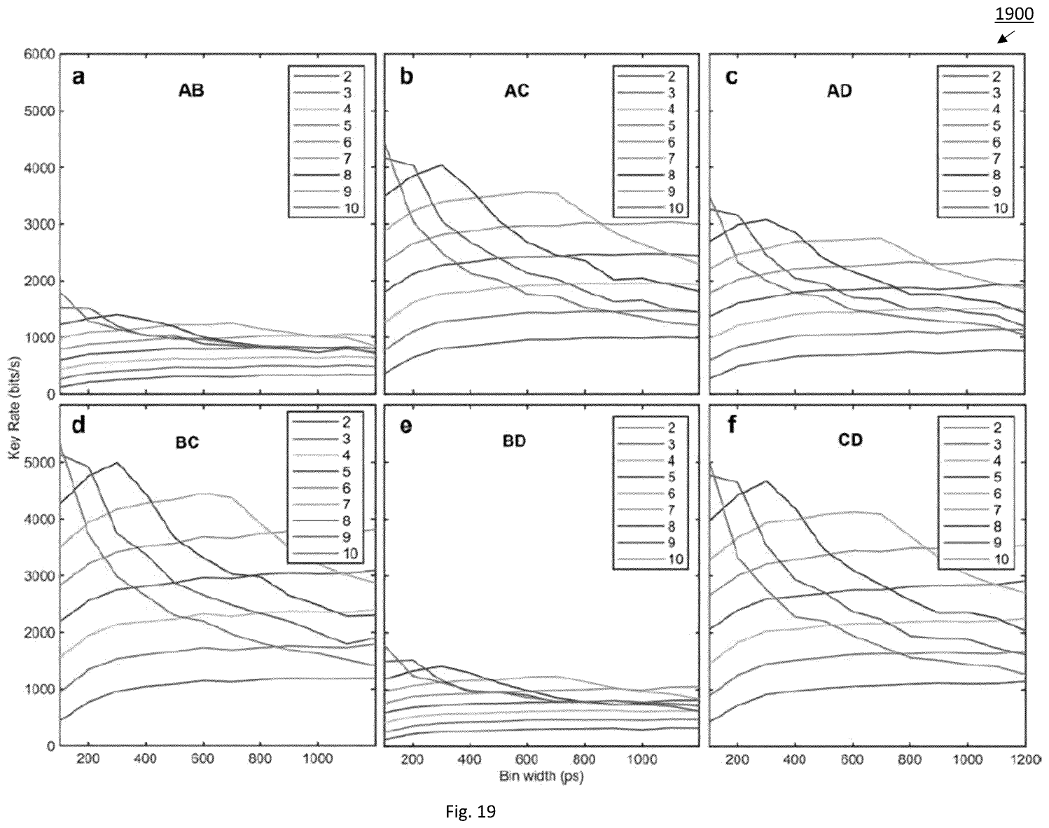

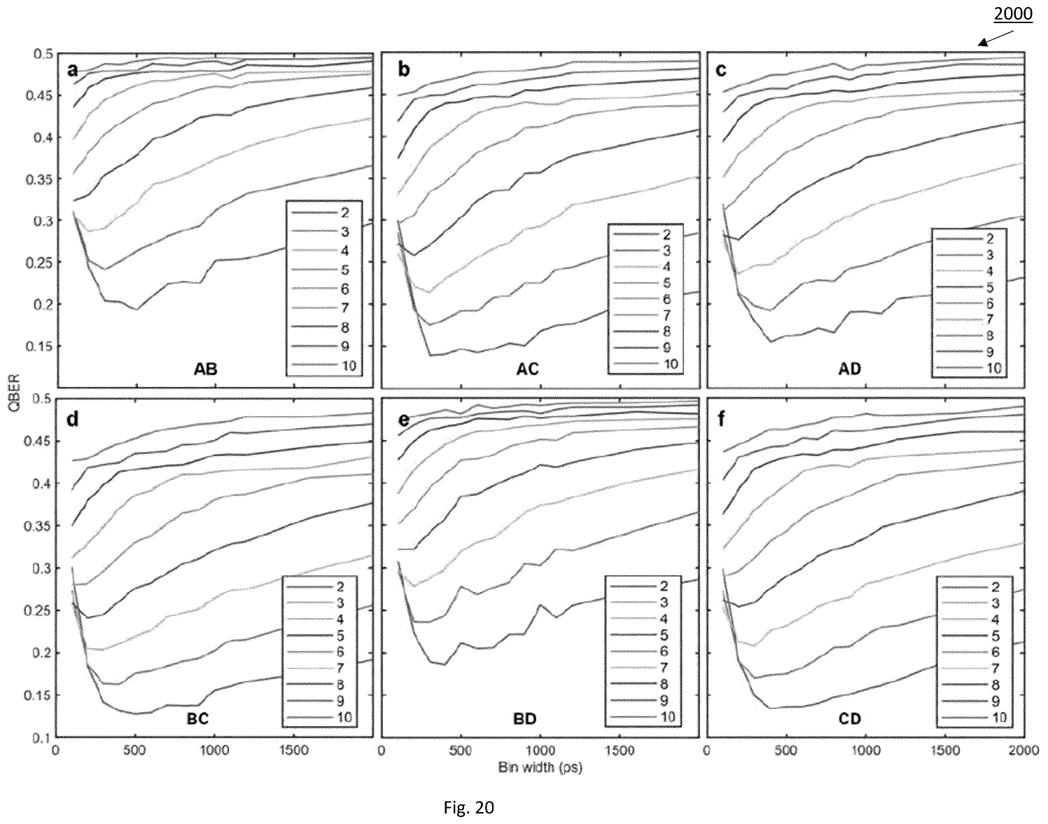

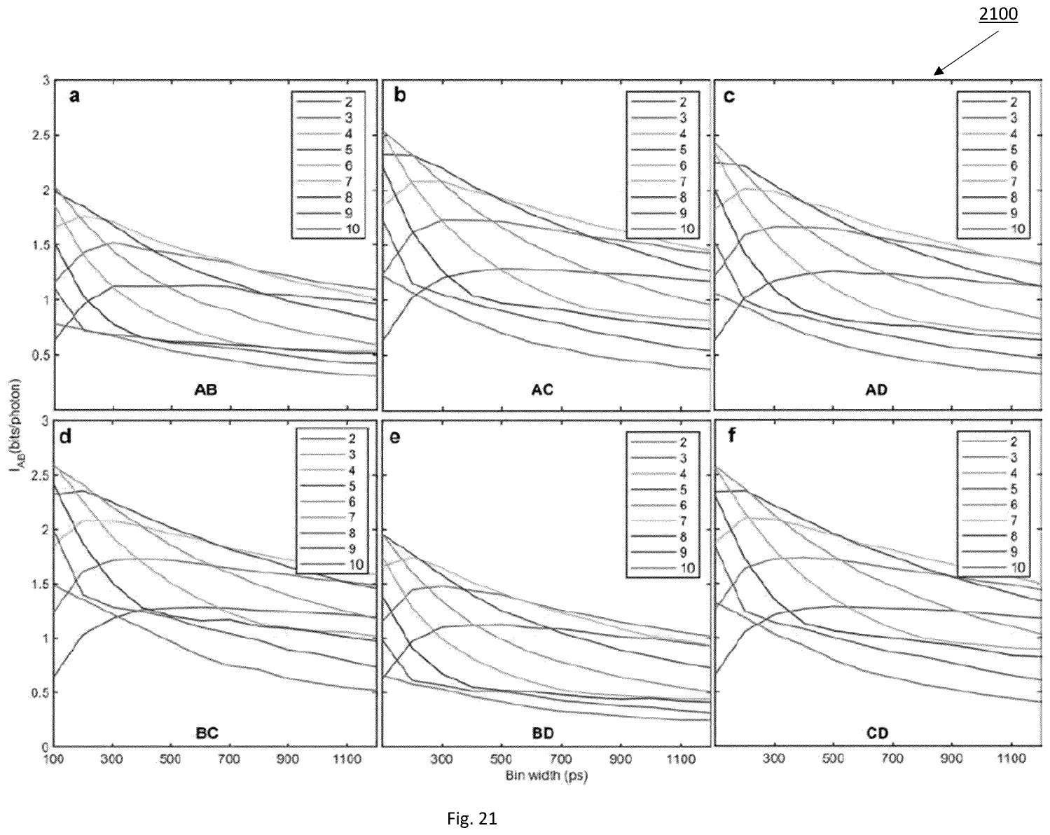

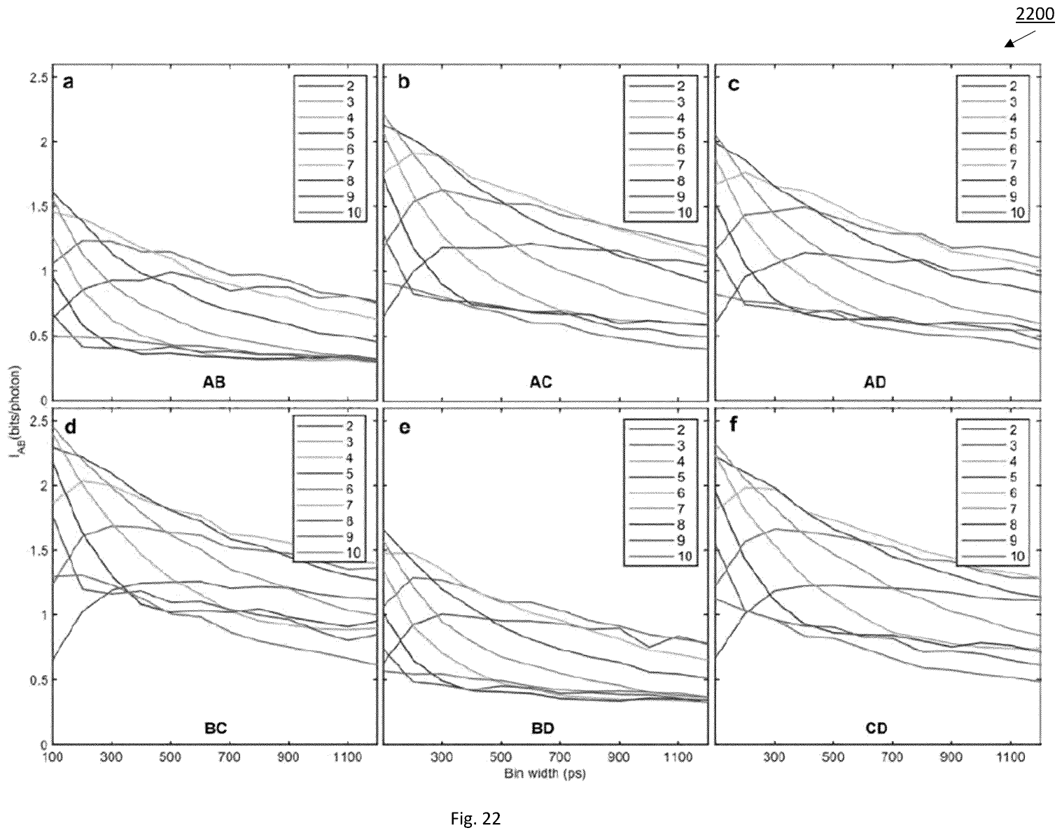

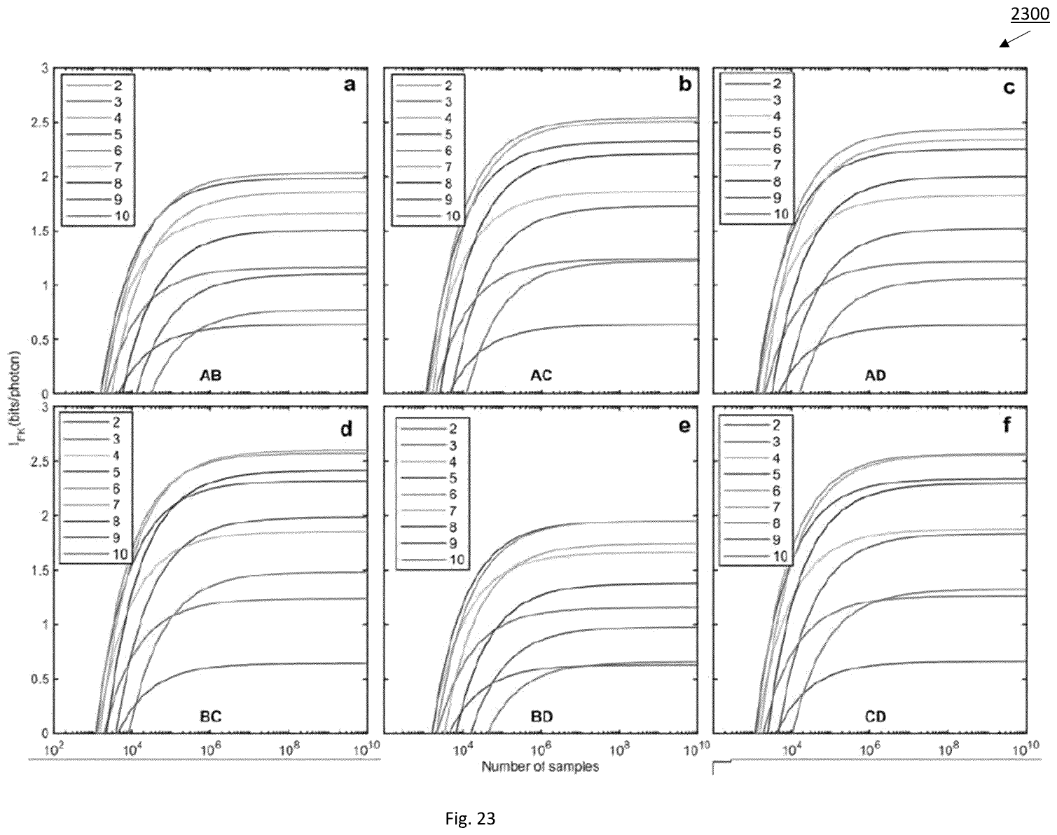

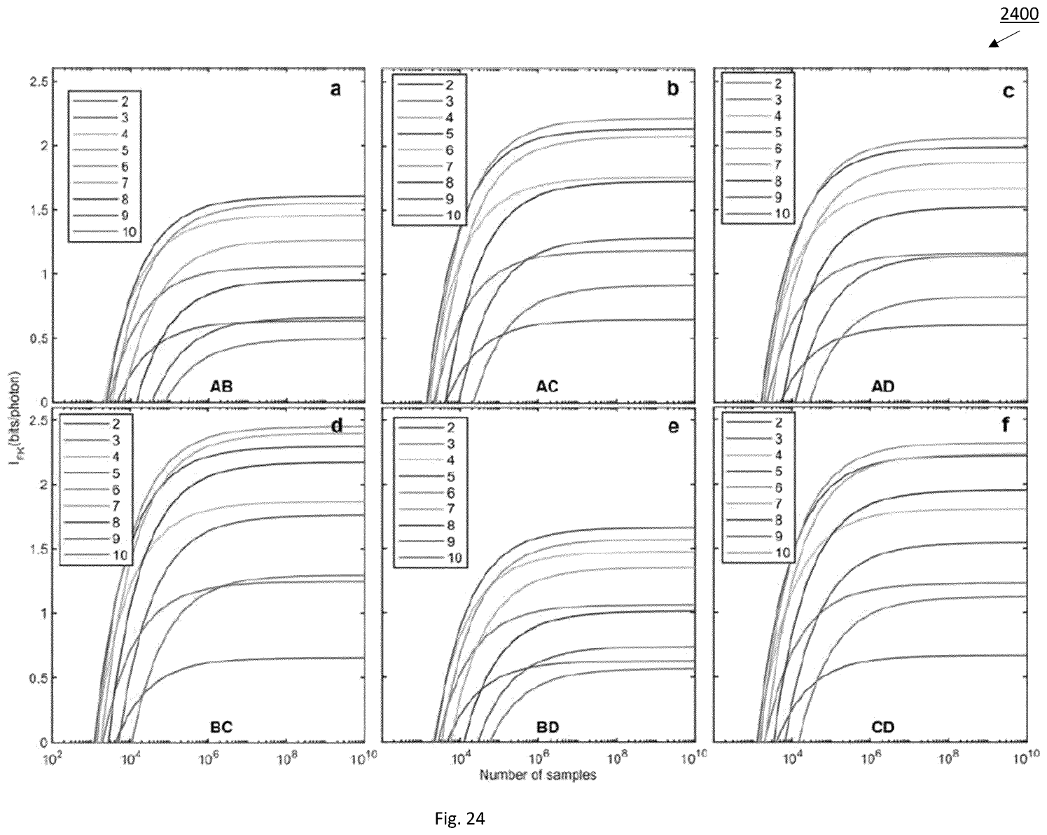

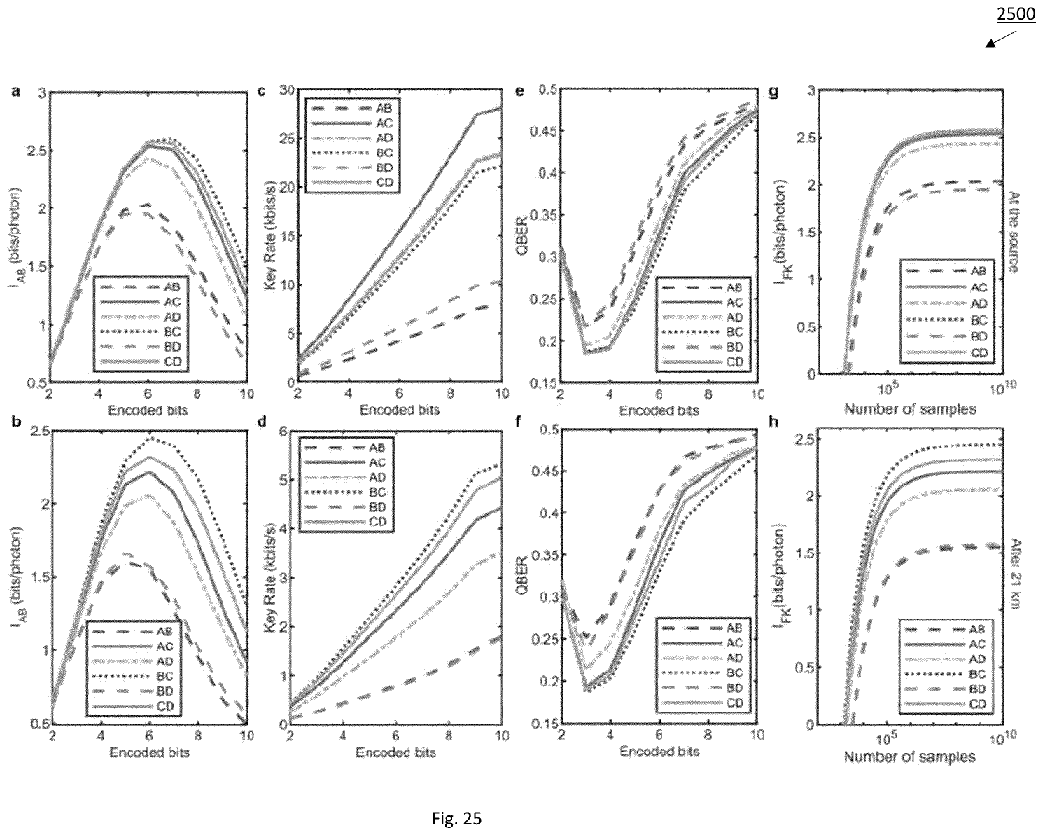

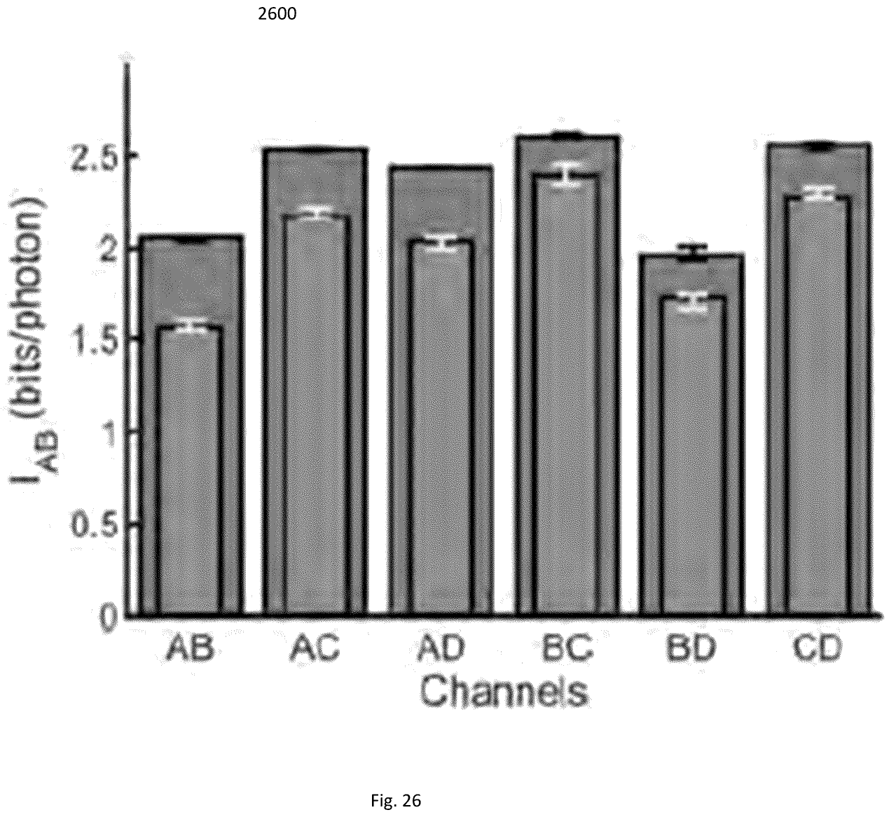

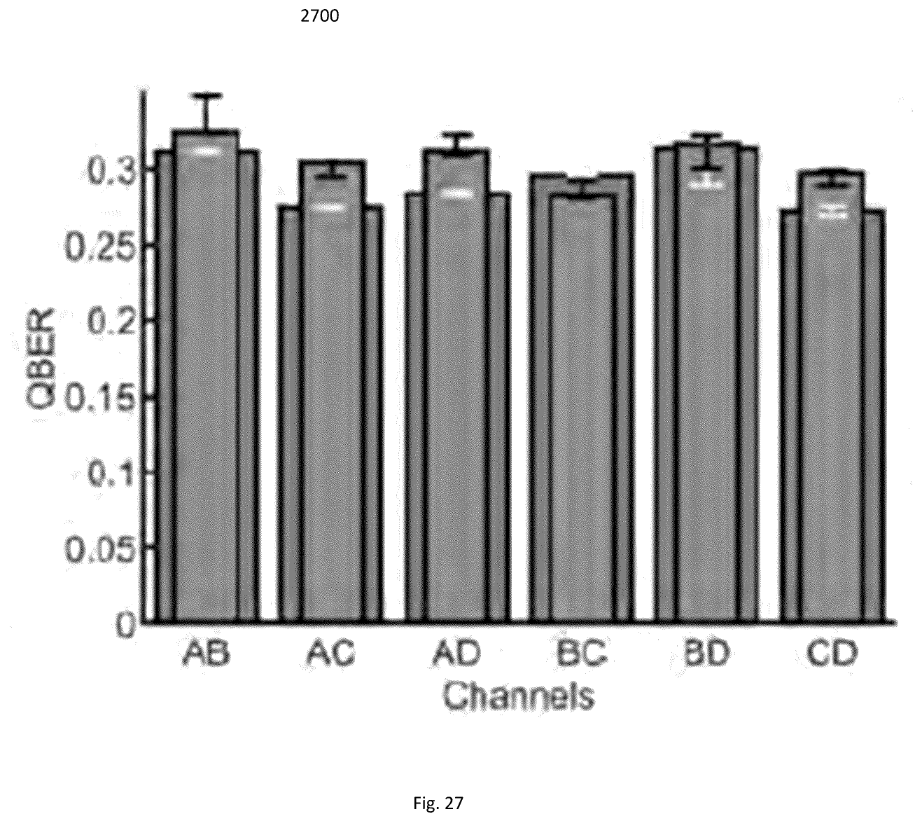

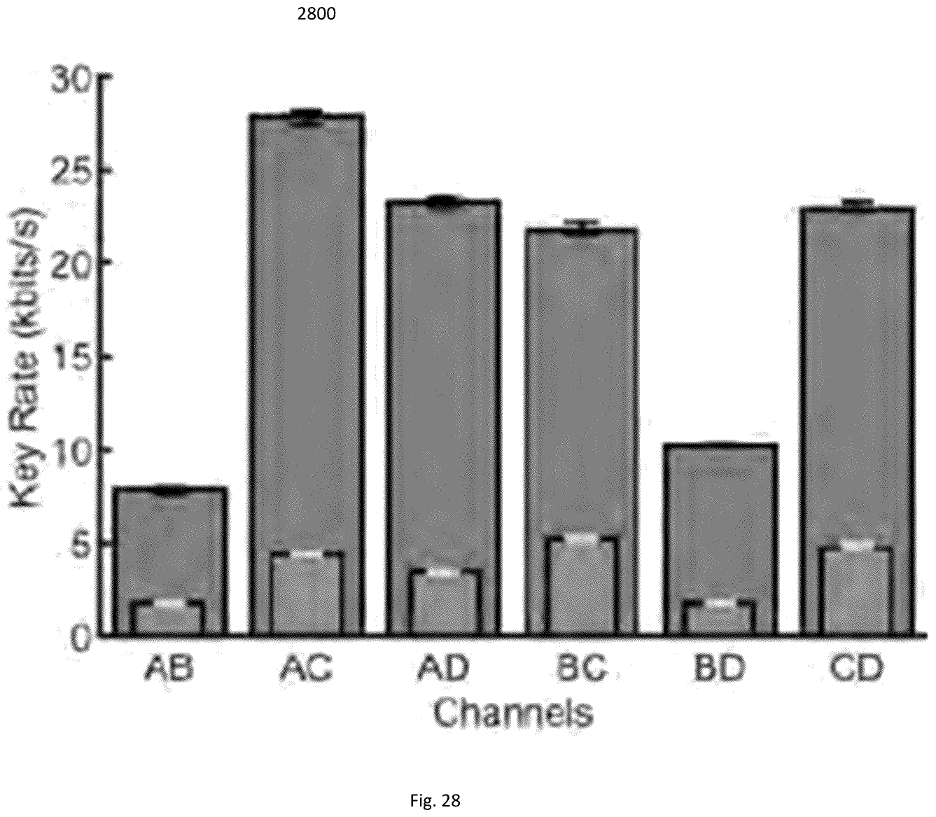

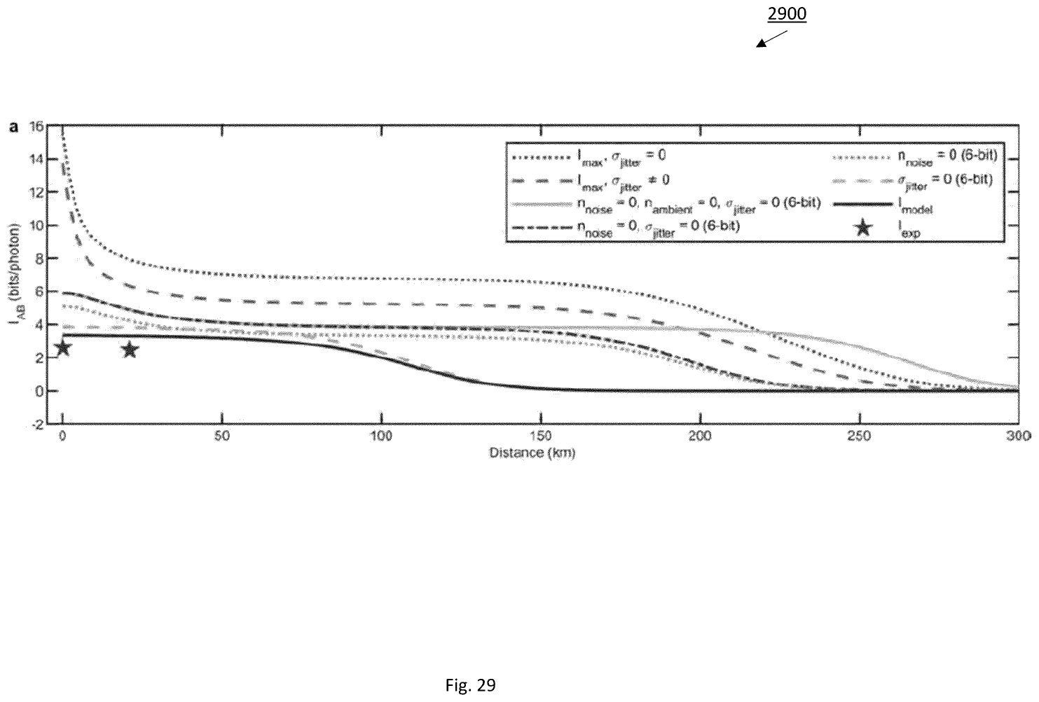

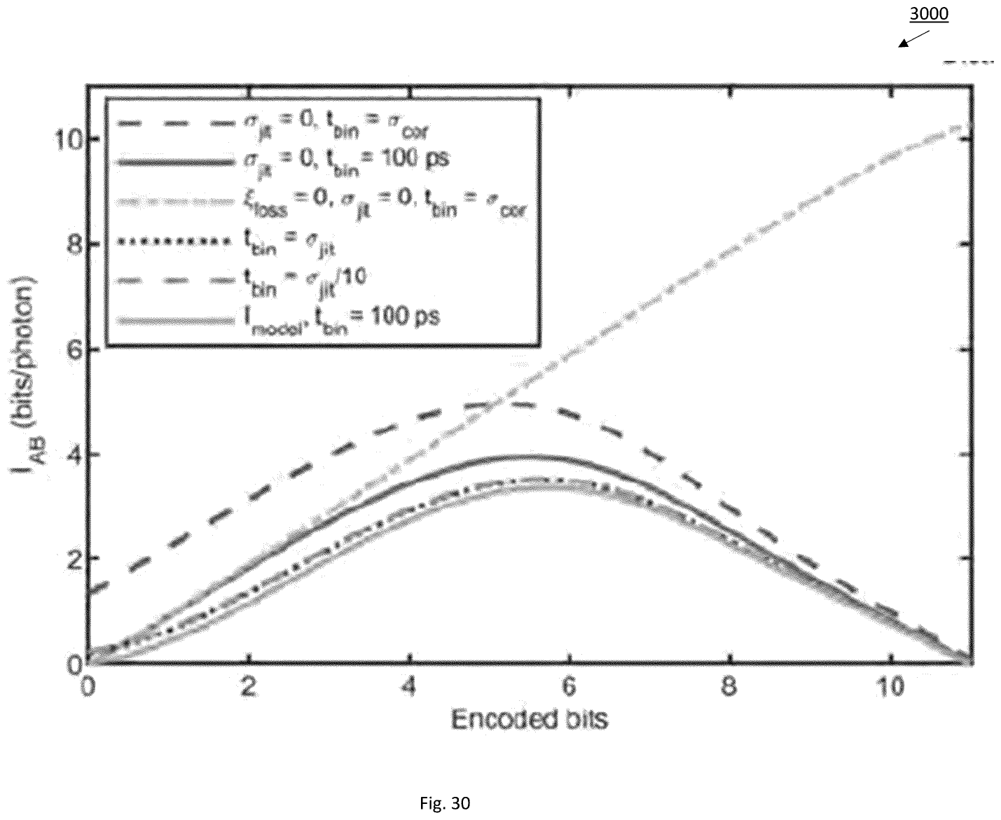

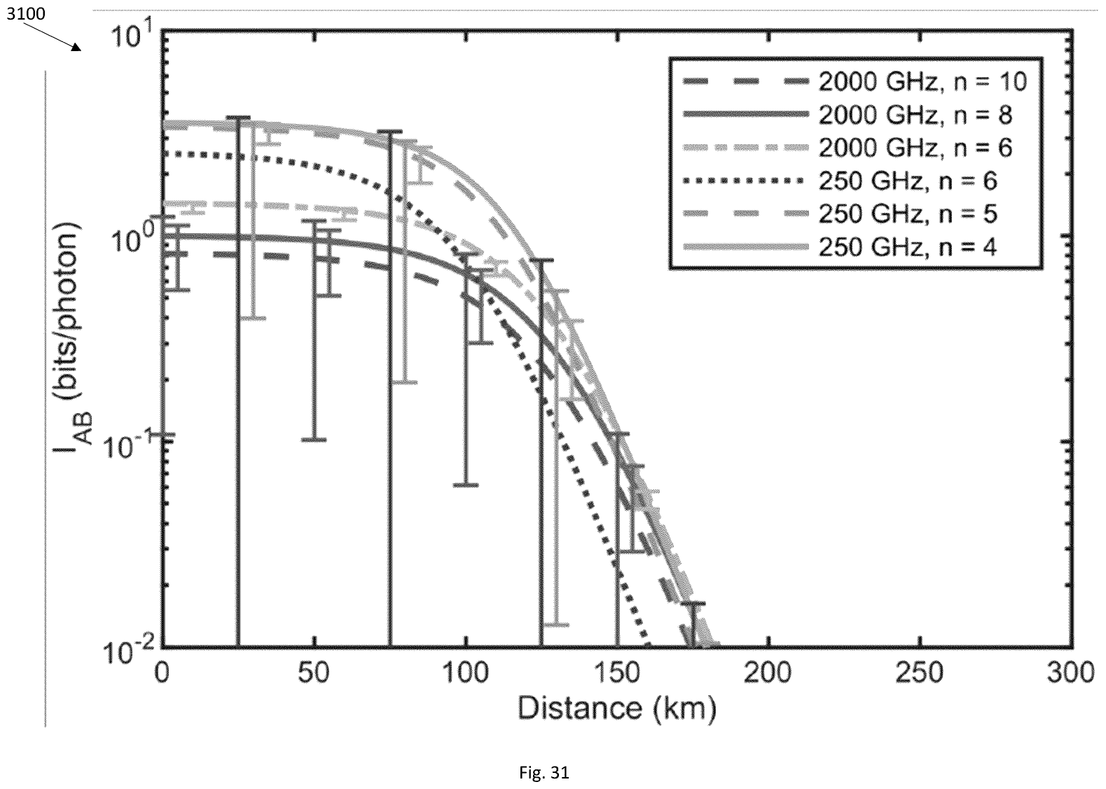

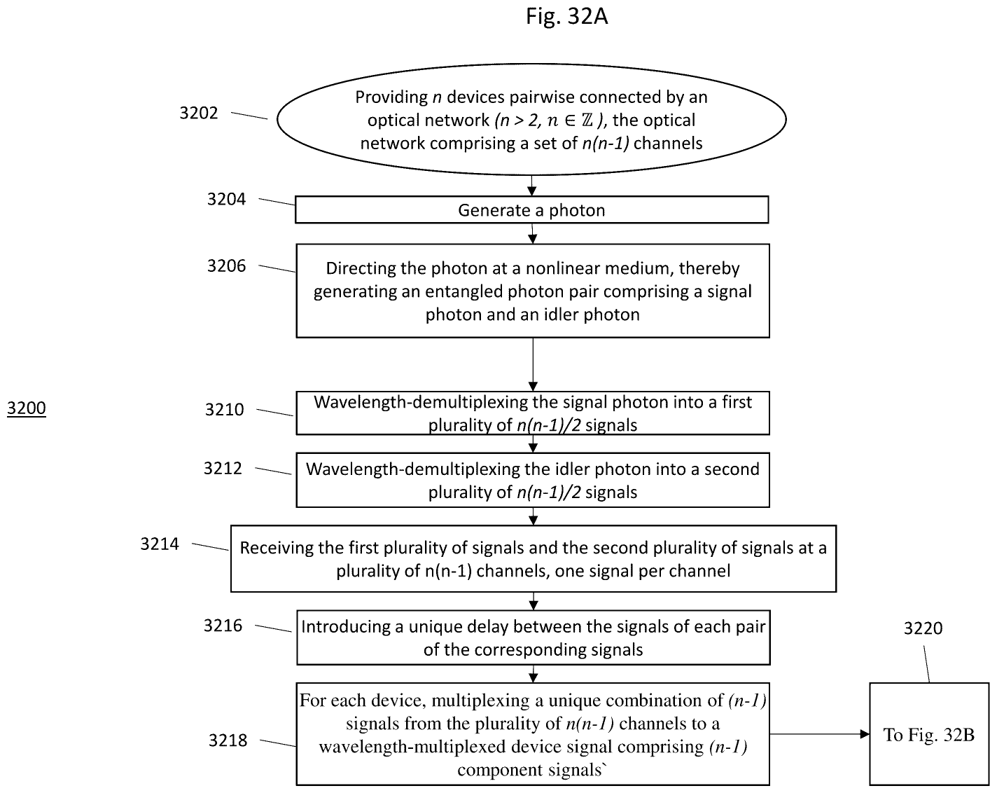

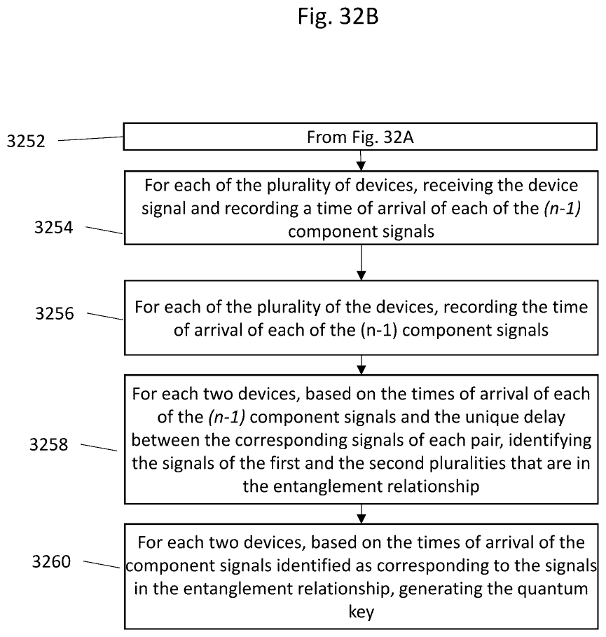

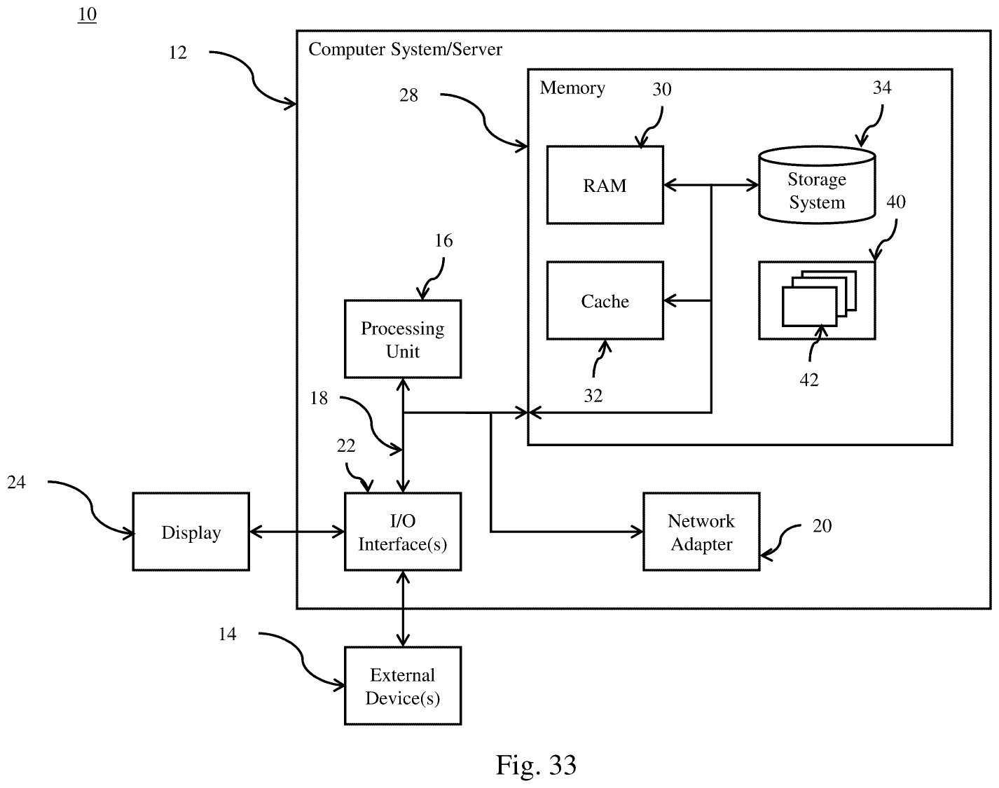

FIG. 9 are graphs 902, 904, 904, and 906 illustrating the second-order correlation measurements for Alice and Charlie in time-time (TT), time-frequency (TF), frequency-time (FT), and frequency-frequency (FF) bases. A CHSH measure is calculated from the change of variance between TT and FF bases. Computed CHSH measures are used to calculate Holevo bounds for each connection, where the minimum and maximum leaked Holevo information are calculated as 0.099 and 0.3507 bits/photon. The measurement in incompatible bases shows a broadened correlation with a FWHM linewidth of 5.13 ns due to the high applied dispersion (±10 ns/nm). Since the nodes apply equal but opposite dispersion to measure on the FF basis, the broadening is effectively canceled since, under the high dispersion limit.

σ_{corr}²,=1σ_{corr}²[σ_{corr}⁴+(D_{A}+D₈)²].

Thus, the FWHM linewidth reduces to 160 ps, the jitter-broadened correlation linewidth. Thus, the variance of the correlation can be related to the spectral linewidth only. The continuous monitoring of the correlations can provide a real-time measure of a measure of information leakage or a measure of mutual information (e.g., a Holevo leakage) from the time-frequency correlation matrix. Under high dispersion, the variance in frequency correlations, can be calculated from Comparing the FF and TT correlation linewidths with parameters: ξ₁₀₇ =σ_{ω}′/σ_{ω}−1 and ξₜ=σₜ′/σₜ−1. The parameters ξω and ξt, are then used in conjunction with the correlation parameters to calculate the time-frequency covariance matrix (TFCM), which is used to estimate Holevo leakage.

FIGS. 10A, 10B, and 11 are graphs 1000, 1050, and 1100 illustrating the secure photon information efficiency (in purple) by subtracting the Holevo leakage bound (in orange) from the raw photon information capacity (in blue). The calculated Holevo leakages are in the range of 0.099 and 0.3507 bits/photon. At 0 km, the secure PIE for each connection is over 1-bit/photon bound and changes between 1.706 bits/photon and 2.458 bits/photon, effectively distributing non-binary information using 6-bit encoding. After 21 kin, all the connections provide a PIE over 1-bit/photon bound and range between 1,356 and 2.295 bits/photon. As a result, the average secure key rates are calculated at 0 km and 21 km and shown in FIG. 12A-B.

FIGS. 12A-B are graphs 1200 and 1250 illustrating that peak secure key rate decreases from 27,861 bits/s to 26,622 bits/s for the AC connection, while the minimum secure key rate is calculated as 6,541 bits/s for the connection AB, At 21 km, the minimum key rate drops to 1,550 bits/s for AB, while the maximum key rate drops to 5,053 bits/s for BC, according to the coincidence scaling with the fiber loss. The achieved secure key rates after 21 km propagation are much larger than recently reported highest key rates using wavelength-multiplexing, prior demonstrated at 300 bits/s up to 16.6 km.

### DISCUSSION

Table 1 illustrates a comparison of embodiments of the quantum key distribution network disclosed herein with recent wavelength-multiplexing-based network implementations. Due to the dense encoding, high noise tolerance and testbed performance, a non-binary dense PIE was achieved of up to 2,603 bits/photon while withstanding a quantum bit error rate of up to 28.2%, exceeding alternative implementations based on non-binary protocols. In contrast, binary protocols cannot produce finite key rates for errors of more than 11%, Thus, a gain was obtained in secure key rates at one to two orders-of-magnitude, compared to similar works using binary protocols, which are mostly confined to laboratory length-scales. Using the dispersive basis for security measurements, a Holevo leakage was obtained of only up to 0.3507 bits/pair.

TABLE 1
Comparison of embodiments of the present disclosure with alternative implementations.

| Encoding | No of users | Number of bits | Security | Q [symbol] | P [symbol] | Key Rate |
|---|---|---|---|---|---|---|
| [symbol] | 1 | Binary | BSM | [symbol] | — | [symbol] bits/s (0 km) |
| [symbol] DO-QKD | [symbol] | 4-bit | CHSH - Dispersive | [symbol] | — | [symbol] bits/s ( [symbol] km) |
| Polarization-BBM [symbol] | [symbol] | Binary | Modified BBM-92 | — | — | [symbol] bits/s (up to [symbol] km) |
| Polarization- BBM [symbol] | [symbol] | Binary | BSM | [symbol] fidelity | — | [symbol] bits/s ( [symbol] km) |
| Binary [symbol] | [symbol] | Binary | CHSH - Polarization | [symbol] | — | [symbol] bits/s ( [symbol] km) & [symbol] bits/s ( [symbol] km) |
| Symmetric DO-QKD | [symbol] | 3-bit | CHSH - Dispersive | [symbol] | — | [symbol] bits/s- [symbol] bits/s (3 km) |
| Polarization-BBM [symbol] | [symbol] | Binary | BSM | — | — | 2-3 [symbol] /minutes (lab [symbol] ) |
| Binary [symbol] | 4 | Binary | CHSH - Polarization | [symbol] | — | [symbol] bits/s (40-70 km) |
| Binary [symbol] | 4 | Binary | CHSH - Polarization | [symbol] | — | [symbol] bits/s (0 km) |
| OAM + Polarization | 3 | 3-bit | BSM | [symbol] | Up to [symbol] | — |
| [symbol] | 4 | 2-bit-10-bit | CHSH - Dispersive | [symbol] | [symbol] | [symbol] kbits/s [symbol] (0 km) & [symbol] kbits/s (21 km) |

[symbol]

indicates data missing or illegible when filed

In some embodiments, a high-fluence type-0 broadband SPDC source can be employed and can increase the key rates more than an order-of-magnitude per node, with the number of nodes up to 10 or more for each subnet, using 90 or more of the frequency subspaces demultiplexed by commercial DWDM modules (96+channels). In some embodiments, the dimensionality and error rates can be improved using low-jitter high-efficiency SNSPDs to reduce the t_{bin} from 100 ps, and both increase the density of the keys that can be encoded over the same frame size, which would keep the global error rates lower. In some embodiments, the dispersion-based security monitoring apparatus can be replaced by non-local Franson interferometric apparatus to reduce the detector requirements even further since dispersion-based monitoring requires 3N detectors for N-nodes to capture the full TT, TF, FT, and FLF bases while non-local interferometry requires only 2N detectors for N-nodes. In some embodiments, reducing QBER can be performed employing hyperentanglement as a safeguard, by using polarization basis as an ancilla to distill the entanglement further. In some embodiments, the recently proposed adaptive wavelength distribution protocols can be employed to optimize the key rates among the nodes for effective resource management. Finally, different multiplexing schemes and network topologies can be implemented to connect different subnets together to increase the number of nodes independent from demultiplexing.

In some embodiments, a d-dimensional wavelength-multiplexed quantum networking protocol enables metropolitan-scale quantum communications, while implemented for multiple correlated nodes simultaneously. The network platform is demonstrated with commercial telecommunications equipment where each modular node only needs a single channel and detector unit to be connected on-demand, enabling effective scaling and minimized costs. The dense high-alphabet multi-bit-per-photon key generation protocol has shown robustness against noisy channels and compatible with LDPC codes tailored for quantum channels, while offering full and simultaneous connectivity among the nodes using a central entanglement provider. Furthermore, as a demonstration, the quantum key distribution implementation performance serves as a figure-of-merit for other quantum communication tasks involving high-fidelity entanglement distribution, such as superdense coding, teleportation, or connecting distributed quantum computing and quantum sensing platforms.

Initial studies using wavelength-multiplexing demonstrated fully-connected networks with up to 8 users per source, yet suffering from key rates reaching only up to 300 bits/s due to usage of binary conjugate coding protocols.

The present implementation improves the key rates orders of magnitude by employing high-dimensional entanglement, increases the number of users further with broadband entanglement sources, increases the range by dispersion compensation, and reduces the infrastructure demands to a single unit per user while still achieving full-connectivity in the network.

In some embodiments, security can be established using Franson interference to monitor the security of energy-time entangled photon pairs in the network.

FIG. 16 is a diagram 1600 illustrating an example of a Franson interferometer scheme according to embodiments of the present disclosure. The diagram 1600 illustrates key generation with simultaneous non-local interferometric monitoring, where two unbalanced Mach-Zehnder interferometers are used to monitor correlations of the photon pairs diverted by an unbalanced coupler. In such a scheme, two apparatus of unbalanced Mach-Zehnder interferometers (MZI) with a pre-determined path length difference ΔT<σ_{coh} can be used to measure interference fringes between two entangled photons sent to corresponding users. The interference fringes are generated by varying the phase of signal and idler photons by ϕ_{S} and ϕ_{I} via phase modulators (denoted as heater and stretcher). The interference visibility V is given as V(ΔT)=[P_{C}(0)−P_{C}(π)]/[P_{C}(0)+P_{C}(π)], where P_{C}(ϕ_{S}+ϕ_{I}) is the coincidence probability of Alice and Bob's photons traversing both long or short arm of MZL Similar to the proof employing dispersive-optical modules, V(ΔT) can be used to bound the variance of the difference between anti-correlated signal and idler photons in frequency basis. In some embodiments, V(ΔT) and V^{th} (ΔT) denote disturbed and undisturbed Franson visibilities, and ω_{S,1} and ω_{S0,S0} denotes the variances in frequency basis for disturbed and undisturbed cases.

$$〈 {( Δω {\hat{}}_{S} - Δω {\hat{}}_{I} )}^{2} 〉 \leq \frac{2}{Δ {T}^{2}} ( 1 - \sqrt{1 - 2 ( {V}^{th} ( Δ T ) - V ( Δ T ) + 〈 {( Δω {\hat{}}_{S 0} - Δω {\hat{}}_{I 0} )}^{2} 〉 Δ T / 2 )} ) \qquad ( 4.2 )$$

Based on the assumption that V^{th} (ΔT)−V(ΔT)<<1 and [symbol] (Δω\hat{ }_{S0}−Δω\hat{ }ₗ₀)² [symbol] ΔT²/2<<1, the change in the variance of frequency anti-correlations can be bounded by:

$$〈 {( Δω {\hat{}}_{S} - Δω {\hat{}}_{I} )}^{2} 〉 - 〈 {( Δω {\hat{}}_{S 0} - Δω {\hat{}}_{I 0} )}^{2} 〉 \leq 2 ( {V}^{th} ( Δ T ) - V ( Δ T ) ) / Δ {T}^{2} \qquad ( 4.3 )$$

In some embodiments, similar to the dispersive-optics-based proof, the excess noise factor can be: ξ_{ω}= [symbol] (Δω\hat{ }S−Δωₗ)² [symbol] / [symbol] (Δω\hat{ }_{S0}−Δω\hat{ }ₗ₀)² [symbol] to compute Holevo bounds from the [symbol] established time-frequency covariance matrix. A Holevo bound of 0.52 bits/photon is achieved before using ΔT=9.5 ns and V(ΔT)=99.6%, with the help of non-local dispersion cancellation. Thus, using Franson interference as a security monitor is possible when the dispersive-optical scheme is not practical.

FIG. 17 is a graph 1700 illustrating an example recording coincidence counts with different optical delays between non-local interferometric paths. The visibility of the oscillation provides a metric to assess possible network security.

### Optimization of Modulation Parameters

In some embodiments, reprocessing of the timestamps can be performed with different modulation parameters. During the agreement step, a portion of timestamps can be revealed to extract performance and error metrics, which can be modulated with different t_{bin} and N, to obtain the optimal key rate and information capacity. In this section, the results of an agreement step for different connections at the lab scale and after 21 km propagation are provided. The variation of figures of merit due to modulation parameters is heavily influenced by the change in local and global errors. FIG. 13A shows the difference distribution of the Alice and Charlie's symbols A and C, for a case with t_{bin}=100 ps and 6-bit encoding at the source distance. Here, the relative frequency of the errors compared to A−C=0 is heavily influenced by the modulation parameters, since the variation of the second-order correlation g⁽²⁾ is invariant of the modulation. In this work, the average jitter-broadened linewidth of g⁽²⁾ is 180 ps. Thus, different t_{bin} values may lead to different local error probabilities, which is important at the low t_{bin} limit and low frame size. The global errors are related to the accidental coincidence probability of single counts of Alice and Charlie's channels. FIG. 13B illustrates the distribution of photon detection events over a fixed frame of 64 bins and t_{bin}=100 ps. For a finite sample size of 18363, the probability of detecting a photon in a particular bin approaches uniform distribution as expected but with a variance less than a tenth of the mean. The variance is important in the finite-key limit, which influences the calculation of PIE. The accidental coincidence probability for each bin scales with the square of single photon detection probability per frame. Thus, the number of global errors would increase with the increasing frame size for the long frame limit. Here, the dead time of the detector, which is around 50 ns, offers a degree of protection for accidentals.

FIGS. 14-15 are graphs 1400 and 1500 illustrating the change in the ratio of global and local errors among the symbol pairs of Alice and Charlie for different t_{bin} at 6-bit encoding and for different number of encoded bits at t_{bin}=100 ps according to embodiments of the present disclosure. The number of local errors is dependent on the discretization of the Gaussian correlation profile as shown in FIG. 13A and reduces to 2.67% for high bin widths. On the other hand, increasing bin width also leads to a larger frame size, thus a higher probability of accidental coincidences leading to global errors. When the t_{bin} is kept at 100 ps to reduce frame size and increase the information density further, the global errors are suppressed below local errors up to 6 bits, which corresponds to a 6.4 ns frame size. The global errors become dominant above a frame size of 19.2 ns, according to FIG. 13B and FIG. 14, The initial increase in local errors from 2-bit to 3-bit is due to the fact that at 2-bit encoding, a 400 ps frame size does not cover the tails of the Gaussian correlation profile with 180 ps linewidth. The following figures are heavily influenced by the changes in the errors, which will be explained further.

FIGS. 4A-E provides a summary of network performance at the source distance, for t_{bin} 100 ps. FIG. 4A shows the key rate and mutual information obtained for each frequency channel pair assigned to users, assuming that the channels destined for each user are not multiplexed and instead sent over separate channels. In this scheme, the key rates for each connection range between 29 kbits/s (BD) and 68 kbits/s (BC) in accordance with the frequency correlations. The mutual information efficiencies in terms of PIE are between 3.1 and 3.5 bits/photon. FIGS. 4B-E illustrate the performance of each user after multiplexing at the source distance. It is shown that, due to the losses incurred by the multiplexing process, the maximal key rate drops from 68 kbits/s to 28 kbits/s, but with a drastic reduction of number of channels and detectors required per user. Furthermore, the reduction in the PIE from 3.5 to 2.6 bits/photon is due to the increase in global erasure errors present in the system. The scaling of PIE, raw key rate, and QBER follows the characteristics of channels with a different number of encoded bits. The variation of the performance metrics with different modulation parameters is given and explained in detail in the following sections.

### Raw Key Rates

FIG. 18-19 show modulation of optimization parameters and the change in raw key rates with changing bin width t_{bin} and number of encoded bits, N, for each user-user connection. The trend is similar when different connections are compared at different distances. FIG. 18 shows that the key rate approaches saturation at the source distance after t_{bin} 300 ps for a frame size up to 19.2 ns (e.g., 6-bit encoding), where the global errors become the dominant factor among the symbols for each device channel (e.g., AB, AC, AD, BC, BD, CD). The peak key rate for each connection at a given encoding level can occur at a smaller bin width, from 700 ps at 7-bit encoding to 100 ps at 10-bit encoding, which corresponds to a frame size closer to 100 ps as the upper limit. This shows that with efficient error-correction coding, extracting a higher key rate under the dominance of global errors is possible since the information delivered per correlated pair exceeds the number of accidentally coincident frames added to the key generation process.

After 21 km propagation (e.g., in FIG. 18), the trend is similar, except for the side channels AB and BD, where the key rates above 7-bit encoding show near-identical performance due to the lower amount of correlated photon counts in the system, which shifts the saturation point for global errors.

FIG. 19 are graphs illustrating the raw key rate obtained for bin widths from 100 to 2000 ps and for the number of encoded bits from 2 to 10 bits/photon for channels AB, AC, AD, BC, BD and CD after 21 km propagation.

### QBER

FIGS. 20 and 21 are graphs illustrating the corresponding quantum bit error rate (QBER) at the source distance and after 21 km for each user. The QBER is calculated from the non-binary symbols converted into binary codewords. In some embodiments, local errors and global errors contribute differently to the QBER, The local errors have a Gaussian distribution that makes the least significant bit errors more likely, while the global errors are uniform, which has a bit error profile closer to a uniform distribution. Thus, at the low frame size regime. In some embodiments, the QBER obtained for bin widths from 100 to 2000 ps and for the number of encoded bits from 2 to 10 bits/photon for channels a) AB, b) AC, c) AD, d) BC, e) BD and f) CD at the source distance.

### Photon Information Efficiency

FIG. 22-23 are graphs illustrating the change in raw key rates with changing bin width thin and number of encoded bits, N, for each user-user connection. The trend is similar when different connections are compared at different distances, FIG. 22 illustrates that the peak photon information efficiency at the source distance after t_{bin}=100 ps for a frame size up to 6.4 ns (6-bit encoding). The increase in frame size and global errors leads to a decrease in photon information efficiency. Increasing bin width for the same number of encoded bits reduces the amount of encodable information due to coarse discretization, while the general increase in frame size due to either bin width or a higher number of encoded bits sets an upper limit on the maximum PIE according to the error characteristics of the system, Compared to the key rate, PIE peaks at a lower frame size (≈6.4 ns vs 19.2 ns), due to the information gain obtained by adding an extra layer of bits.

After 21 km propagation, a similar trend is observed, except for the side channels AB and BD, where the peak PIE occurs at 5-bit encoding, where the lower coincidences-to-singles ratio leads to increased error statistics.

### Sample Size for Finite Key Effects

FIG. 24-25 are graphs illustrating a change of the PIE with finite symbol block sizes due to uncertainties brought by the finite key effects. For both at the source distance and after 21 km, it is shown that a block size of 10⁶ approaches the asymptotic values. Such a block size is attainable both at the source distance and after 21 km. For example, the AC connection can be recorded for the durations between 20 s to 2 minutes for near-asymptotic key generation performance, according to different numbers of encoded bits and frames contributing to key generation.

FIG. 25A-H are graphs illustrating optimization of the modulation parameters. FIG. 25A illustrates the photon information efficiency for all links with different numbers of encoded bits N from 2 to 10 bits at the source distance. FIG. 25B illustrates the photon information efficiency for all links with different numbers of encoded bits N from 2 to 10 bits after 21 km propagation. The bin width can be 100 ps. FIG. 25C illustrates the change in quantum bit error rate with different numbers of encoded bits at the source distance. FIG. 25D illustrates the change in quantum bit error rate with different numbers of encoded bits after 21 kin propagation. The bin width can be 100 ps. FIG. 25E illustrates the secure key rate for all links with different numbers of encoded bits N from 2 to 10 bits at the source distance. FIG. 25F illustrates the secure key rate for all links with different numbers of encoded bits N from 2 to 10 bits after 21 km propagation. The bin width can be 100 ps. FIG. 25G illustrates Finite key adjusted photon information efficiency for all links with different numbers of sample sizes for each recording at the source distance. FIG. 25H illustrates Finite key adjusted photon information efficiency for all links with different numbers of sample sizes for each recording after 21 kin propagation. The bin width can be 100 ps, and 6-bit encoding can be used.

FIGS. 32A-B are flowcharts 3200 and 3250 illustrating a method of quantum key distribution according to embodiments of the present disclosure. Referring to FIG. 31, in some embodiments, the method comprises providing a plurality of n devices pairwise connected by an optical network (3202). The variable n can be an integer greater than or equal to 2. The optical network can comprise a set of n(n−1) channels. The method can comprise generating a photon (3204). The method can comprise directing the photon at a nonlinear medium, thereby generating an entangled photon pair comprising a signal photon and an idler photon (3206). The method can include wavelength-demultiplexing the signal photon into a first plurality of n(n−1)/2 signals (3210). Each signal of the first plurality can have a unique wavelength band. The method can include wavelength-demultiplexing the idler photon into a second plurality of n(n−1)½ signals (3212), Each signal of the second plurality having a unique wavelength band. The signals of the first plurality and the signals of the second plurality can be in a one-to-one correspondence based on entanglement (“entanglement relationship”), thereby forming n(n−1)/2 pairs of corresponding signals. The method can include receiving the first plurality of signals and the second plurality of signals at a plurality of n(n−1) channels, one signal per channel (3214). The method can include introducing a unique delay between the signals of each pair of the corresponding signals (3216). The method can include, for each of the plurality of devices, multiplexing a unique combination of (n−1) signals from the plurality of n(n−1) channels to a wavelength-multiplexed device signal comprising (n−1) component signals (3218). The method can continue as illustrated by the flowchart 3250 of FIG. 32B.

FIG. 32B is a flowchart 3250 illustrating a method of quantum key distribution according to embodiments of the present disclosure. It can be recognized that the flowchart 3250 of FIG. 32B can be a logical continuation of the flowchart 3220 of FIG. 32A (3252). The method can include, for each of the plurality of devices, receiving the device signal and recording a time of arrival of each of the (n−1) component signals (3254). The method can include, for each of the plurality of the devices, recording the time of arrival of each of the (n−1) component signals (3256). The method can include, for each two devices, based on the times of arrival of each of the (n−1) component signals and the unique delay between the corresponding signals of each pair, identifying the signals of the first and the second pluralities that are in the entanglement relationship (3258). The method can include, for each two devices, based on the times of arrival of the component signals identified as corresponding to the signals in the entanglement relationship, generating the quantum key (3260).

In a 2^{nd} aspect of the 2^{nd} embodiment, the unique combination of signals for each device comprises a plurality of signals having wavelength bands that are nonadjacent.

FIG. 33 is a schematic of an example of a computing node according to embodiments of the present disclosure. Computing node 10 is only one example of a suitable computing node and is not intended to suggest any limitation as to the scope of use or functionality of embodiments described herein, Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 33, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers, A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### EMBODIMENTS

Accordingly, in a 1st example embodiment, the present invention is a system for quantum key distribution.

In a 1st aspect of the 1st example embodiment, the system comprises a plurality of n devices pairwise connected by an optical network, wherein n is an integer greater than or equal to 2, the optical network comprising a set of n(n−1) channels; a photon source configured to generate a photon; a nonlinear medium configured to receive the photon upon being illuminated by the photon source and to generate an entangled photon pair comprising a signal photon and an idler photon; a demultiplexer configured to wavelength-demultiplex the signal photon into a first plurality of n(n−1)/2 signals, each signal of the first plurality having a unique wavelength band, and wavelength-demultiplex the idler photon into a second plurality of n(n−−1)/2 signals, each signal of the second plurality having a unique wavelength band, wherein the signals of the first plurality and the signals of the second plurality are in a one-to-one correspondence based on entanglement (“entanglement relationship”), thereby forming n(n−1)/2 pairs of corresponding signals; a plurality of n(n−1) channels configured to receive the first plurality of signals and the second plurality of signals, one signal per channel; a delay module configured to introduce a unique delay between the signals of each pair of the corresponding signals; for each of the plurality of devices, a multiplexer configured to receive a unique combination of (n−1) signals from the plurality of n(n−1) channels and output a wavelength-multiplexed device signal comprising (n−1) component signals; for each of the plurality of devices, a time of arrival photon detector configured to receive the device signal and record a time of arrival of each of the (n−1) component signals; a computing node comprising a computer readable storage medium comprising program instructions embodied therewith, the program instructions executable by a processor of the computing node to cause the processor to perform a method of converting each of the times of arrival of the (n−1) component signal into a quantum key, the method comprising: for each of the plurality of the devices, recording the time of arrival of each of the (n−1) component signals; for each two devices, based on the times of arrival of each of the (n−1) component signals and the unique delay between the corresponding signals of each pair, identifying the signals of the first and the second pluralities that are in the entanglement relationship; and for each two devices, based on the times of arrival of the component signals identified as corresponding to the signals in the entanglement relationship, generating the quantum key.

As used herein, a wavelength band can be one wavelength or a range of wavelengths having a lower and upper range. As used herein, wavelength can mean a center value of a range of wavelengths or wavelength band.

As used herein, a frequency band can be one frequency or a range of frequency having a lower and upper range. As used herein, frequency can mean a center value of a range of frequencies or frequency band.

As used herein, a unique time delay can be a time delay applied to a pair of signals that is different from a time delay applied to any other pair of signals.

As used herein, a unique combination of (n−1) signals can be a set of (n−1) that is mutually exclusive from any other unique combination of (n−1) signals.

As used herein, the entanglement relationship can be a pair of signals comprising one signal of the first plurality that is paired with only one signal of the second plurality, and that one signal of the second plurality is paired with only that one signal of the first plurality.

In a 2^{nd} aspect of the 1^{st} example embodiment, the unique combination of signals for each device comprises a plurality of signals having wavelength bands that are nonadjacent. Other features and example features of the 2^{nd} aspect of the 1^{st} example embodiment are as defined above with respect to the 1^{st} aspect.

In a 3^{rd} aspect of the 1st example embodiment, the system further comprises a conversion module that is configured to convert the time of arrival of each component signal into a time bin representation. For example, the time bin representation represents the time of arrival as a time frame comprising a plurality of m bins, the time of arrival being represented by one of the m bins, and the conversion module is further configured to convert the time of arrival into one of the plurality of in bins. As another example, m is an integer greater than 2. As yet another example, the bins are indexed, and the computing node is further configured to convert an index of a bin of the frame to a binary representation having multiple bits, the index of the bin representing the time of arrival. Other features and example features of the 3^{rd} aspect of the 1st example embodiment are as defined above with respect to the 1^{st} and 2^{nd} aspect.

In a 4^{th} aspect of the 1^{st} example embodiment, at the computing node of a first device of the plurality of devices, the program instructions executable by the processor of the computing node further cause the processor to perform: receiving a parity matrix calculated from a time of arrival of the component signals identified as corresponding to the signals being in the entanglement relationship from a second device of the plurality of devices; verifying the time bin representation of the first device with the parity matrix; when the verification results in a match, recording the arrival time as the quantum key at the first device; and when the verification does not result in a match, performing error correction on the time bin representation. Other features and example features of the 4^{th} aspect of the 1^{st} example are as defined above with respect to the 1^{st} through 3^{rd} aspects.

In an 5^{th} aspect of the 1^{st} example embodiment, the time of arrival photon detector is a superconducting nanowire single photon detector (SNSPD). Other features and example features of the 5^{th} aspect of the 1^{st} example are as defined above with respect to the 1^{st} through 4^{th} aspects.

In a 6^{th} aspect of the 1^{st} example embodiment, the system further comprises, for each device: a normal dispersion module configured to apply a first direction and first magnitude of dispersion to a portion of the device signal and output a normal dispersed signal; an anomalous dispersion module configured to apply a second direction and second magnitude of dispersion to the portion of the device signal, the first direction and the second direction being opposite and the first magnitude and second magnitude being equal, and output an anomalous dispersed signal; a normal dispersed-time photon detector configured to measure a normal dispersed time of arrival of each signal component of the first dispersed signal; and an anomalous dispersed-time photon detector configured to measure an anomalous dispersed time of arrival of each signal component of the second dispersed signal; wherein, at the computing node, the program instructions executable by the processor of the computing node further cause the processor to perform a method of detecting eavesdropping, the method comprising: for each two devices, the two devices being a first device and a second device, compare the normal dispersed time of arrival of a component signal measured by a first device to the anomalous dispersed time of arrival of a component signal measured by a second device, the component signals corresponding to the signals identified as being in the entanglement relationship; calculating a measure of mutual information based the comparison; and providing a notification when the measure of mutual information bound is outside of a predefined range. Other features and example features of the 6^{th} aspect of the 1^{st} example are as defined above with respect to the 1^{st} through 5^{th} aspects.

In a 7^{th} aspect of the 1^{st} example embodiment, the nonlinear medium generates an energy-time-entangled photon pair. Other features and example features of the 7^{th} aspect of the 1^{st} example are as defined above with respect to the 1^{st} through 6^{th} aspects.

In a 2^{nd} example embodiment, the present invention is a method for quantum key distribution.

In a 1^{st} aspect of the 2^{nd} a example embodiment, the method comprises providing a plurality of n devices pairwise connected by an optical network, wherein n is an integer greater than or equal to 2, the optical network comprising a set of n(n−1) channels; generating a photon; directing the photon at a nonlinear medium, thereby generating an entangled photon pair comprising a signal photon and an idler photon; wavelength-demultiplexing the signal photon into a first plurality of n(n−1)/2 signals, each signal of the first plurality having a unique wavelength band; wavelength-demultiplexing the idler photon into a second plurality of n(n−1)/2 signals, each signal of the second plurality having a unique wavelength band, wherein the signals of the first plurality and the signals of the second plurality are in a one-to-one correspondence based on entanglement (“entanglement relationship”), thereby forming n(n−1)/2 pairs of corresponding signals; receiving the first plurality of signals and the second plurality of signals at a plurality of n(n−1) channels, one signal per channel; introducing a unique delay between the signals of each pair of the corresponding signals: for each of the plurality of devices, multiplexing a unique combination of (n−1) signals from the plurality of n(n−1) channels to a wavelength-multiplexed device signal comprising (n−1) component signals; for each of the plurality of devices, receiving the device signal and recording a time of arrival of each of the (n−1) component signals; for each of the plurality of the devices, recording the time of arrival of each of the (n−1) component signals; for each two devices, based on the times of arrival of each of the (n−1) component signals and the unique delay between the corresponding signals of each pair, identifying the signals of the first and the second pluralities that are in the entanglement relationship; and for each two devices, based on the times of arrival of the component signals identified as corresponding to the signals in the entanglement relationship, generating the quantum key.

As used herein, a unique time delay can be a time delay applied to a pair of signals that is different from a time delay applied to any other pair of signals.

As used herein, a unique combination of (n−1) signals can be a set of (n−1) that is mutually exclusive from any other unique combination of (n−1) signals.

As used herein, the entanglement relationship can be a pair of signals comprising one signal of the first plurality that is paired with only one signal of the second plurality, and that one signal of the second plurality is paired with only that one signal of the first plurality.

In a 2^{nd} aspect of the 2^{nd} embodiment, the unique combination of signals for each device comprises a plurality of signals having wavelength bands that are nonadjacent. Other features and example features of the 2^{nd} aspect of the 2^{nd} example embodiment are as described above with respect to the 1^{st} aspect.

In a 3^{rd} aspect of the 2^{nd} embodiment, the method further comprising converting the time of arrival of each component signal into a time bin representation. For example, the time bin representation represents the time of arrival as a time frame comprising a plurality of n bins, the time of arrival being represented by one of the m bins, the method further comprising converting the time of arrival into one of the plurality of in bins. As another example, m is an integer greater than 2. As yet another example, the bins are indexed, and the method further comprises converting an index of a bin of the frame to a binary representation having multiple bits, the index of the bin representing the time of arrival, Other features and example features of the 3^{rd} aspect of the 2^{nd} example embodiment are as defined above with respect to the 1^{st} through 2^{nd} aspects.

In a 4^{th} aspect of the 2^{nd} embodiment, the method further comprises receiving a parity matrix calculated from a time of arrival of the component signals identified as corresponding to the signals being in the entanglement relationship from a second device of the plurality of devices; verifying the time bin representation of the first device with the parity matrix; when the verification results in a match, recording the arrival time as the quantum key at the first device; and when the verification does not result in a match, performing error correction on the time bin representation. Other features and example features of the 4^{th} aspect of the 2^{nd} example embodiment are as defined above with respect to the 1^{st} through 3^{rd}.

In an 5^{th} aspect of the 2^{nd} embodiment, the time of arrival photon detector is a superconducting nanowire single photon detector (SNSPD). Other features and example features of the 5^{th} aspect of the 2^{nd} example embodiment are as defined above with respect to the 1^{st} through 4^{th}.

In a 6^{th} aspect of the 2^{nd} embodiment, the method further comprises, at each device, applying a first direction and first magnitude of dispersion to a portion of the device signal, thereby outputting a normal dispersed signal; applying a second direction and second magnitude of dispersion to the portion of the device signal, the first direction and the second direction being opposite and the first magnitude and second magnitude being equal, thereby outputting an anomalous dispersed signal; measuring a normal dispersed time of arrival of each signal component of the first dispersed signal; measuring an anomalous dispersed time of arrival of each signal component of the second dispersed signal; comparing, for each two devices, the two devices being a first device and a second device, the normal dispersed time of arrival of a component signal measured by a first device to the anomalous dispersed time of arrival of a component signal measured by a second device, the component signals corresponding to the signals identified as being in the entanglement relationship; calculating a measure of mutual information based the comparison; and providing a notification when the measure of mutual information bound is outside of a predefined range. Other features and example features of the 6^{th} aspect of the 2^{nd} example embodiment are as defined above with respect to the 1^{st} through 5^{th}.

In a 7^{th} aspect of the 2^{nd} embodiment, the entangled photon pair is an energy-time-entangled photon pair. Other features and example features of the 7^{th} aspect of the 2^{nd} example embodiment are as defined above with respect to the 1^{st} through 6^{th}.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for quantum key distribution, the system comprising:
a plurality of n devices pairwise connected by an optical network, wherein n is an integer greater than or equal to 2, the optical network comprising a set of n(n−1) channels;
a photon source configured to generate a photon;
a nonlinear medium configured to receive the photon upon being illuminated by the photon source and to generate an entangled photon pair comprising a signal photon and an idler photon;
a demultiplexer configured to:
wavelength-demultiplex the signal photon into a first plurality of n(n−1)/2 signals, each signal of the first plurality having a unique wavelength band, and
wavelength-demultiplex the idler photon into a second plurality of n(n−1)/2 signals, each signal of the second plurality having a unique wavelength band,
wherein the signals of the first plurality and the signals of the second plurality are in a one-to-one correspondence based on entanglement (“entanglement relationship”), thereby forming n(n−1)/2 pairs of corresponding signals;
a plurality of n(n−1) channels configured to receive the first plurality of signals and the second plurality of signals, one signal per channel;
a delay module configured to introduce a unique delay between the signals of each pair of the corresponding signals;
for each of the plurality of devices, a multiplexer configured to receive a unique combination of (n−1) signals from the plurality of n(n−1) channels and output a wavelength-multiplexed device signal comprising (n−1) component signals;
for each of the plurality of devices, a time of arrival photon detector configured to receive the device signal and record a time of arrival of each of the (n−1) component signals;
a computing node comprising a computer readable storage medium comprising program instructions embodied therewith, the program instructions executable by a processor of the computing node to cause the processor to perform a method of converting each of the times of arrival of the (n−1) component signal into a quantum key, the method comprising:
for each of the plurality of the devices, recording the time of arrival of each of the (n−1) component signals;
for each two devices, based on the times of arrival of each of the (n−1) component signals and the unique delay between the corresponding signals of each pair, identifying the signals of the first and the second pluralities that are in the entanglement relationship; and
for each two devices, based on the times of arrival of the component signals identified as corresponding to the signals in the entanglement relationship, generating the quantum key.

2. The system of claim 1, wherein the unique combination of signals for each device comprises a plurality of signals having wavelength bands that are nonadjacent.

3. The system of claim 1, further comprising a conversion module that is configured to convert the time of arrival of each component signal to a time bin representation.

4. The system of claim 3, wherein the time bin representation represents the time of arrival as a time frame comprising a plurality of m bins, the time of arrival being represented by one of the m bins, and
the conversion module is further configured to convert the time of arrival into one of the plurality of m bins.

5. The system of claim 4, wherein m is an integer greater than 2.

6. The system of claim 4, wherein the bins are indexed, and the computing node is further configured to convert an index of a bin of the frame to a binary representation having multiple bits, the index of the bin representing the time of arrival.

7. The system of claim 1, wherein, at the computing node of a first device of the plurality of devices, the program instructions executable by the processor of the computing node further cause the processor to perform:
receiving a parity matrix calculated from a time of arrival of the component signals identified as corresponding to the signals being in the entanglement relationship from a second device of the plurality of devices;
verifying the time bin representation of the first device with the parity matrix;
when the verification results in a match, recording the arrival time as the quantum key at the first device; and
when the verification does not result in a match, performing error correction on the time bin representation.

8. The system of claim 1, wherein the time of arrival photon detector is a superconducting nanowire single photon detector (SNSPD).

9. The system of claim 1, the system further comprising:
for each device:
a normal dispersion module configured to apply a first direction and first magnitude of dispersion to a portion of the device signal and output a normal dispersed signal;
an anomalous dispersion module configured to apply a second direction and second magnitude of dispersion to the portion of the device signal, the first direction and the second direction being opposite and the first magnitude and second magnitude being equal, and output an anomalous dispersed signal;
a normal dispersed-time photon detector configured to measure a normal dispersed time of arrival of each signal component of the first dispersed signal; and
an anomalous dispersed-time photon detector configured to measure an anomalous dispersed time of arrival of each signal component of the second dispersed signal;
wherein, at the computing node, the program instructions executable by the processor of the computing node further cause the processor to perform a method of detecting eavesdropping, the method comprising:
for each two devices, the two devices being a first device and a second device, compare the normal dispersed time of arrival of a component signal measured by a first device to the anomalous dispersed time of arrival of a component signal measured by a second device, the component signals corresponding to the signals identified as being in the entanglement relationship;
calculating a measure of mutual information based the comparison; and
providing a notification when the measure of mutual information bound is outside of a predefined range.

10. The system of claim 1, wherein the nonlinear medium generates an energy-time-entangled photon pair.

11. A method for quantum key distribution, the system comprising:
providing a plurality of n devices pairwise connected by an optical network, wherein n is an integer greater than or equal to 2, the optical network comprising a set of n(n−1) channels;
generating a photon;
directing the photon at a nonlinear medium, thereby generating an entangled photon pair comprising a signal photon and an idler photon;
wavelength-demultiplexing the signal photon into a first plurality of n(n−1)/2 signals, each signal of the first plurality having a unique wavelength band;
wavelength-demultiplexing the idler photon into a second plurality of n(n−1)/2 signals, each signal of the second plurality having a unique wavelength band,
wherein the signals of the first plurality and the signals of the second plurality are in a one-to-one correspondence based on entanglement (“entanglement relationship”), thereby forming n(n−1)/2 pairs of corresponding signals;
receiving the first plurality of signals and the second plurality of signals at a plurality of n(n−1) channels, one signal per channel;
introducing a unique delay between the signals of each pair of the corresponding signals;
for each of the plurality of devices, multiplexing a unique combination of (n−1) signals from the plurality of n(n−1) channels to a wavelength-multiplexed device signal comprising (n−1) component signals;
for each of the plurality of devices, receiving the device signal and recording a time of arrival of each of the (n−1) component signals;
for each of the plurality of the devices, recording the time of arrival of each of the (n−1) component signals;
for each two devices, based on the times of arrival of each of the (n−1) component signals and the unique delay between the corresponding signals of each pair, identifying the signals of the first and the second pluralities that are in the entanglement relationship; and
for each two devices, based on the times of arrival of the component signals identified as corresponding to the signals in the entanglement relationship, generating the quantum key.

12. The method of claim 11, wherein the unique combination of signals for each device comprises a plurality of signals having wavelength bands that are nonadjacent.

13. The method of claim 11, further comprising converting the time of arrival of each component signal into a time bin representation.

14. The method of claim 13, wherein the time bin representation represents the time of arrival as a time frame comprising a plurality of m bins, the time of arrival being represented by one of the m bins, the method further comprising:
converting the time of arrival into one of the plurality of m bins.

15. The method of claim 14, wherein m is an integer greater than 2.

16. The method of claim 14, wherein the bins are indexed, and the method further comprises:
converting an index of a bin of the frame to a binary representation having multiple bits, the index of the bin representing the time of arrival.

17. The method of claim 11, the method further comprising:
receiving a parity matrix calculated from a time of arrival of the component signals identified as corresponding to the signals being in the entanglement relationship from a second device of the plurality of devices;
verifying the time bin representation of the first device with the parity matrix;
when the verification results in a match, recording the arrival time as the quantum key at the first device; and
when the verification does not result in a match, performing error correction on the time bin representation.

18. The method of claim 11, wherein the time of arrival photon detector is a superconducting nanowire single photon detector (SNSPD).

19. The method of claim 11, the method further comprising:
at each device:
applying a first direction and first magnitude of dispersion to a portion of the device signal, thereby outputting a normal dispersed signal;
applying a second direction and second magnitude of dispersion to the portion of the device signal, the first direction and the second direction being opposite and the first magnitude and second magnitude being equal, thereby outputting, at the anomalous dispersion module, an anomalous dispersed signal;
measuring a normal dispersed time of arrival of each signal component of the first dispersed signal;
measuring an anomalous dispersed time of arrival of each signal component of the second dispersed signal;
comparing, for each two devices, the two devices being a first device and a second device, the normal dispersed time of arrival of a component signal measured by a first device to the anomalous dispersed time of arrival of a component signal measured by a second device, the component signals corresponding to the signals identified as being in the entanglement relationship;
calculating a measure of mutual information based the comparison; and
providing a notification when the measure of mutual information bound is outside of a predefined range.

20. The method of claim 11, wherein the entangled photon pair is an energy-time-entangled photon pair.
